(19) United States
(12) Patent Application Publication
(10) Pub. No.: US 2026/0198485 A1
(43) Pub. Date: Jul. 16, 2026

(54) Methods and systems for cryopreservation of biosystems using a cryomesh

(71) Applicant: Regents of the University of Minnesota, Minneapolis, MN (US)

(72) Inventors: Zongqi Guo, Minneapolis, MN (US); Michael L. Etheridge, Maple Grove, MN (US); Nikolas Zuchowicz, Minneapolis, MN (US); John C. Bischof, St. Paul, MN (US); Erik Finger, Wayzata, MN (US); Joseph Rao, Minneapolis, MN (US)

(21) Appl. No.: 19/137,071

(22) PCT Filed: Dec. 6, 2023
(86) PCT No.: PCT/US2023/082657

§ 371 Date: Jun. 9, 2025

Related U.S. Application Data
(60) Provisional application No. 63/431,241, filed on Dec. 8, 2022.
(60) Provisional application No. 63/528,529, filed on Jul. 24, 2023.

(51) Int. Cl. A01N 1/147

(52) U.S. Cl. CPC A01N 1/147

(57) ABSTRACT

Methods for cryopreservation of biological samples are provided. The biological samples are sub-millimeter or millimeter scale biological materials. The cryopreservation system includes the use of a conduction-dominated cryomesh (CondD-C). The methods include loading the CondD-C with biological samples and submerging the CondD-C with the samples in a manner, e.g., by vertical plunging, that removes the vapor bubbles from the cooling surfaces. Methods using the CondD-C and vertical plunging can enhance the cooling rate and warming rates and are scalable for high throughput processing of large numbers of vitrified and/or rewarmed biological samples.

This invention was made with government support under DK131209 awarded by the National Institutes of Health. The government has certain rights in the invention. This invention was made with government support under EEC-1941543 awarded by the National Science Foundation. The government has certain rights in the invention.

### BACKGROUND

Preservation of biological material is valuable in many areas including for medical and biological research. Vitrification-based cryopreservation is desired for long-term storage of biological systems for healthcare, food sustainability, and biodiversity.

### SUMMARY

In one aspect, the present description relates to a method for cryopreservation of a biological sample. The method includes transferring a biological sample onto a porous, thermally conductive surface, wherein the biological sample is loaded with a cryoprotective agent (CPA) solution. The method further includes cooling the CPA loaded biological sample by submerging the conductive surface with the biological sample into a cryogenic coolant to form a vitrified biological sample, wherein the submerging rapidly releases vapor bubbles formed due to evaporation of the cryogenic coolant. The porous, thermally conductive surface may be a cryomesh. The method may further comprise removing the excess CPA solution surrounding the CPA loaded biological sample prior to cooling. The method may include placing the biological sample into the cryogenic coolant by vertical plunging. The cryogenic coolant may be agitated to release the vapor bubbles during the submerging step. The porous surface may have a thermal conductivity of at least about 10 W/m/K. The porous, thermally conductive surface may be selected from the group consisting of copper, stainless steel, aluminum, gold, diamond, carbon fibers, and combinations thereof. The temperature of the porous surface with the biological sample may reach within about 10% of a temperature difference with the cryogenic coolant within 1 second or less, or within 0.3 seconds or less during the cooling step. The cryomesh may include filaments, wherein the diameter of the filaments is selected to allow the cryomesh to reach a temperature within about 10% of the temperature difference with the cryogenic coolant in less than 0.2 seconds or less than 0.1 second during the cooling step. The cryomesh filament diameter may be less than about 50 μm, or less than about 30 μm. The cryomesh solid fraction, may be between about 0.3 and 0.9, or between about 0.5 and about 0.66. The pore size of the cryomesh may prevent passage of the CPA loaded biological material through the cryomesh during removal of excess CPA solution and ensures surface contact with the biological sample. The cryomesh pore size may be less than about 50 μm, or less than about 30 μm or less than about 10 μm. The cooling of the CPA loaded biological material occurs sufficiently uniformly across the porous substrate. The cooling across the porous substrate has a variation of about +/−10% or about +/−5% or about +/−1%. The method may further include rewarming of the vitrified biological sample by submerging the vitrified biological sample into a rewarming fluid. The CPA loaded biological sample comprises a thickness of up to about 100 microns and the cooling occurs at a minimum cooling rate of greater than 3.1×10⁴° C./min and a minimum rewarming rate of 19.6×10⁴° C./min. The CPA loaded biological sample comprises a thickness of up to about 200 microns and the cooling occurs at a minimum cooling rate of greater than 1.8×10⁴° C./min and a minimum rewarming rate of 9.0×10⁴° C./min. The CPA loaded biological sample comprises a thickness of up to about 500 microns and the cooling occurs at a minimum cooling rate of greater than 0.74×10⁴° C./min and a minimum rewarming rate of 2.2×10⁴° C./min.

In another aspect, the present description relates to a system for cryopreservation of a biological sample. The system includes a thermally conductive porous surface that includes filaments. The filament diameter, pore size of the porous surface, thermal conductivity and thermal diffusivity of the porous surface enable the system to reach a temperature within about 10% of a temperature difference with a cryogenic coolant within 1 second or within 0.3 seconds or less when submerged in the cryogenic coolant. The porous, thermally conductive surface may be a cryomesh. The thermally conductive surface may be configured for submersion of the biological sample into the cryogenic coolant. The submersion may be by vertical plunging. The porous surface may have a thermal conductivity of between at least about 10 W/m/K. The porous, thermally conductive surface may be selected from the group consisting of copper, stainless steel, aluminum, gold, diamond and combinations thereof. The system may further include a biological sample, wherein the biological sample is loaded with a CPA solution and the CPA loaded biological sample adheres to the porous surface after removal of excess CPA solution after placement of the biological sample on the porous surface and during submersion of the biological sample into a cryogenic coolant. The temperature of the porous surface with the biological sample may reach within about 10% of the temperature difference with the cryogenic coolant in 1 second or within 0.3 seconds or less during the cooling step. The cryomesh may include filaments, wherein the diameter of the filaments is selected to allow the cryomesh to reach a temperature within about 10% of the temperature difference with the cryogenic coolant in 0.2 seconds or less than 0.1 seconds or less during the cooling step. The cryomesh filament diameter may be less than about 50 μm, or less than about 30 μm. The cryomesh may include a solid fraction, wherein the solid fraction is between about 0.3 and 0.9, or between about 0.5 and about 0.66. The cryomesh may include a pore size that prevents passage of the CPA loaded biological material through the cryomesh during removal of excess CPA solution and ensures surface contact with the biological sample. The cryomesh pore size may be less than about 50 μm, or less than about 30 μm or less than about 10 μm. The cooling of the CPA loaded biological material occurs sufficiently uniformly across the porous substrate. The cooling across the porous substrate has a variation of about +/−10% or about +/−5% or about +/−1%. The system may further be used for rewarming of vitrified biological samples by submerging the vitrified biological samples into a rewarming fluid. The CPA loaded biological sample comprises a thickness of up to about 100 microns and the cooling occurs at a minimum cooling rate of greater than 3.1×10⁴° C./min and a minimum rewarming rate of 19.6×10⁴° C./min. The CPA loaded biological sample comprises a thickness of up to about 200 microns and the cooling occurs at a minimum cooling rate of greater than 1.8×10⁴° C./min and a minimum rewarming rate of 9.0×10⁴° C./min. The CPA loaded biological sample may have a thickness of up to about 500 microns and the system may cool the biological sample at a minimum cooling rate of greater than 0.74×10⁴° C./min and a minimum rewarming rate of 2.2×10⁴° C./min.

In a further aspect, the present description relates to a method for cryopreservation of two or more biological samples. The method includes transferring biological samples onto a porous, thermally conductive surface, wherein the biological samples are loaded with a cryoprotective agent (CPA) solution. The method further includes cooling the CPA loaded biological samples by submerging the thermally conductive surface with the biological samples into a cryogenic coolant to form vitrified biological samples, wherein the submerging rapidly releases vapor bubbles formed due to evaporation of the cryogenic coolant. The biological samples are cooled at a rate to within about 10% of a temperature difference with the cryogenic fluid in 1 second or less. The placing of the biological sample into the cryogenic coolant is done by vertical plunging. The porous thermally conductive surface is at least about 2 cm×2 cm, or at least about 5 cm×4 cm, or at least about 7 cm×4.5 cm, or at least up to 15 cm×4 cm, or at least up to 10 cm×8 cm or larger. The surface holds at least about 50 biological samples. The surface holds at least about 200 biological samples. The surface holds at least about 400 biological samples. The surface holds at least about 1000 biological samples. The surface holds at least about 2500 biological samples. The surface holds at least about 5000 biological samples. The surface holds at least about 10,000 biological samples. The surface holds at least about 50,000 biological samples. The surface holds at least about 100,000 biological samples. The surface holds at least about 500,000 biological samples. The surface holds at least about 1 million biological samples. The surface holds at least about 5 million biological samples.

In the following detailed description of illustrative examples, reference is made to specific embodiments by way of drawings and illustrations. These examples are described in sufficient detail to enable those skilled in the art to practice what is described and serve to illustrate how elements of these examples may be applied to various purposes or embodiments. Other embodiments exist, and logical, mechanical, electrical, and other changes may be made.

Features or limitations of various embodiments described herein, however important to the examples in which they are incorporated, do not limit other embodiments, and any reference to the elements, operation, and application of the examples serve only to define these illustrative examples. Features or elements shown in various examples described herein can be combined in ways other than shown in the examples, and any such combinations is explicitly contemplated to be within the scope of the examples presented here. The following detailed description does not, therefore, limit the scope of what is claimed.

All patents, publications or other documents mentioned herein are incorporated by reference.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-1D are related to conduction-dominated cryomesh for cryopreservation. FIG. 1A is a schematic illustration and a photograph of droplets convectively cooled in liquid nitrogen (LN₂) show ice formation, due to the nitrogen vapor layer that forms. FIG. 1B is a schematic illustration and a photograph of the convection-dominated cryomesh showing ice formation due to slower heat transfer through the nylon mesh. FIG. 1C is a schematic and a photograph of the conduction-dominated cryomesh achieving vitrified droplets through enhanced heat transfer through the cryomesh and modified plunging techniques. CPA droplet volume is 1 μL and the scale bars are 300 μm. The black arrow shows the direction of conduction heat transfer. The temperature bar is not to scale.

FIG. 2A is a schematic diagram of a heat transfer model of a cryomesh cooling in LN₂. Heat from the biosystem transfers through the mesh and releases to the LN₂ by convection. FIG. 2B is a plot of thermal resistances of convection interface, mesh, and biosystem. The value of the Bi number (equation 24)<0.01 indicates that the cryomesh is operating in a conduction dominated mode. FIG. 2C is a plot demonstrating that reduced mesh wire diameter D increases the contact area and decreases the heat release time. The heat release time t is an inverse correlation with the cooling rate (CR), i.e., t~ΔT/CR. FIG. 2D is a plot demonstrating that the heat release time increases with increase of biosystem thickness. A conduction dominated cryomesh reduces the heat release time for a thick biosystem.

FIGS. 3A-3G show experimental validation of cooling rate varying as a function of mesh design and plunging. FIG. 3A is a schematic and FIG. 3B is a camera image of horizontal LN₂ plunge with trapped bubbles. FIG. 3C is a schematic and FIG. 3D is a camera image of vertical LN₂ plunge with release of vapor layer. FIG. 3E is a plot of the measured cooling rates for vertical and horizontal plunge varying with mesh sizes and material. The model suggests a lower effective heat transfer coefficient on the horizontal plunge due to trapped bubbles. FIG. 3F is a plot of the measured cooling rate of nylon, stainless steel, and copper compared with thermal conductivity. The higher thermal conductivity of copper produces a high cooling rate. FIG. 3G is a plot of the experimental cooling rate of different mesh wire diameters. The scale bar in B and D is 1 cm.

FIG. 4A is a schematic of the zebrafish embryo vitrification protocol. FIG. 4B are microscope images of zebrafish embryo at different stages of the protocol. The scale bar is 0.5 mm. FIG. 4C are microscope images of zebrafish embryos before and after vitrification on stainless steel with D=30 μm and Φ=0.5. Embryos showing ice formation are white in color. FIG. 4D are microscope images of zebrafish embryos before and after vitrification on nylon with D=50 μm and Φ=0. The scale bar for (FIG. 4C) and (FIG. 4D) are 2 mm. FIG. 4E is a plot of the vitrification rate and experimental cooling rate of stainless steel and nylon mesh with vertical plunge. Yellow-colored area shows conduction-dominated cryomesh cooling. Gray boxes represent standard deviation of survival rates. Blue boxes represent standard deviation of simulated cooling rate. Horizontal dash line is the estimated threshold cooling rate, which is higher than the CCR of zebrafish embryos. The conduction-dominated cryomesh has a higher vitrification rate due to a higher cooling rate.

FIG. 5A is a schematic of the vitrification protocol for coral larvae (Lobactis scutaria) with vertical plunge. FIG. 5B are microscope images of coral larvae unloaded from copper, nylon, and stainless steel meshes. Copper demonstrated toxicity to the coral larvae. FIG. 5C is microscope images of coral larvae after vitrification on stainless steel with D=50 μm and Φ=0.33. Vitrified larvae are transparent. FIG. 5D are microscope images of coral larvae after vitrification on nylon mesh with D=50 μm and Φ=0.5. Larvae have ice formation showing white color. FIG. 5E is a plot of the survival rate and simulated cooling rate of stainless steel and nylon mesh with vertical plunge. The conduction-dominated cryomesh (yellow-colored area) has a higher survival rate due to a higher cooling rate with D=30 μm and Φ=0.5 being the best. Gray boxes represent standard deviation of survival rates. Blue boxes represent standard deviation of the simulated cooling rate. Horizontal dash line is estimated as the threshold cooling rate higher than CCR. The scale bars are 100 μm.

FIG. 6A-FIG. 6D are schematics and images of general vitrification steps for the cryomesh. Example shown using 125 μm PE microspheres to model a biosystem. FIG. 6A is a schematic and an image of the biosystem loading onto the cryomesh, which is shown here through direct pipetting, but the biosystem can also be loaded in suspension. FIG. 6B is a schematic and an image of excess CPA removed by wicking with e.g., tissue paper (Kimwipe). FIG. 6C is a schematic and an image of horizontal plunging into liquid nitrogen accomplished by plunging the cryomesh with the mesh plane parallel (i.e., horizontal) to the top surface of the liquid nitrogen bath. FIG. 6D is a schematic and an image of vertical plunging into liquid nitrogen accomplished by plunging the cryomesh with the mesh plane perpendicular (i.e., vertical) to the top surface of the liquid nitrogen bath. Scale bars shown are 1 mm.

FIG. 7A is a schematic of cryomesh showing definition of cryomesh width (W), length (L), filament diameter (D), pore size (P), and solid fraction (φ). FIG. 7B is camera images of copper (2×2 cm) cryomesh. FIG. 7C is a camera image of stainless steel (2×2 cm) cryomesh. FIG. 7D is a camera image of a nylon (2×2 cm) cryomesh. FIG. 7E is a camera image of a copper (5×4 cm) cryomesh. FIG. 7F is a schematic of various circular mesh used in this study. Scale bars are 1 mm for (FIG. 7B), (FIG. 7C), and (FIG. 7D) and 2 mm for (FIG. 7E) and (FIG. 7F).

FIGS. 8A-8B are plots of modeling of cryomesh with different thermal conductivities. FIG. 8A is a plot of Biot number calculated under different heat transfer coefficients for a range of thermal conductivities, assuming a characteristic length of 33 μm for mesh D=50 μm and Φ=0.5. The blue box indicates conduction-dominated behavior, which has a Bi<0.01 and h>1250 W/m²/K. FIG. 8B is a plot of thermal resistances (K/W) of different heat transfer coefficients for a range of thermal conductivities, assuming a characteristic length of 33 μm. The x-axis is the thermal conductivity for different materials (W/m/K).

FIG. 9A is a plot of heat release time of 3 heat transfer coefficients for different materials. The heat release time is calculated as equation 5-15. FIG. 9B is a plot of the ratio of conduction heat release time (equation 13) and convection heat release time (equation 7) for different materials, which correlates to the Biot number. The mesh has D=50 μm and Φ=0.5. Biosystem thickness is assumed as 50 μm.

FIG. 10 is a plot of heat release time (equation 5) of copper and nylon mesh shown for a range of cryomesh solid fractions. The biosystem thickness is 50 μm. See FIG. 7 for the definition of cryomesh solid fraction 0. The wire diameter here D=50 μm.

FIG. 11 is a plot of theoretical cooling rate of different cryomesh materials. The cooling rate is calculated from equation 16 with 50 μm biosystem thickness, where Φ=0.5 and h=1250 W/m²/K. The colored area shows commercially-available meshes. While experimental demonstrations focused on the comparison of nylon, stainless steel, and copper materials, aluminum offers another viable option for the conductive-dominated cryomesh. We decided that nylon, stainless steel, and copper provided an adequate range of behaviors, however, aluminum is an ideal conductive cryomesh material for practical use and diamond is an ideal conductive cryomesh material to achieve the highest cooling rate.

FIG. 12 is a plot of theoretical cooling rate of different biosystem thicknesses with different solid fractions on a copper mesh with where D=50 μm and h=1250 W/m²/K. The theoretical cooling rate of different biosystem thicknesses is reported as the minimum cooling rate experienced. Data for different biosystem thicknesses correlate to blue (50 μm), red (100 μm), purple (200 μm), brown (300 μm), and black (500 μm) dots.

FIGS. 13A-13C are schematic and plots of temperature variation measured across various sizes of cryomesh during horizontal plunging of bare mesh without CPA loading. FIG. 13A is a schematic of temperatures measured at three uniformly-distributed points across the circular mesh shown as center, middle, and edge. D_{f} is the diameter of the cryomesh frame. The thermocouple tip is attached to the mesh at the relative locations shown. FIG. 13B is a plot showing cooling rate across the nylon cryomesh Φ=50 μm and Φ=0.5) at three points from center to edge. FIG. 13C is a plot showing cooling rate across the stainless steel cryomesh Φ=50 μm and Φ=0.5) at three points from center to edge. The error bar is the range of the data.

FIG. 14A is a schematic of a cooling rate measured across 2×2 cm (L×W) cryomesh during vertical plunging. L is the length and W is the width of the frame. FIG. 14B is a plot of the results shown at three uniformly-distributed points across the mesh shown at the top, middle, and bottom. Cooling rates were calculated from measured temperature variation for the bare mesh (blue) and with biosystem loading simulated as a CPA thin film (red).

FIG. 15A is a schematic of the cooling rate measured across different frame sizes of cryomesh during vertical plunging. The cooling rate is measured at five uniformly distributed points across the mesh area. L is the length and Wis the width of the frame. The arrow shows the plunge direction. The cooling rate is measured from −20° C. to −140° C. FIG. 15B is a plot of cooling rate of the different bare meshes at three uniformly distributed points across the mesh at the top, middle, and bottom. The frame size is 2×2 cm. The wire diameter is 50 μm and Φ=0.5. The vertical plunge demonstrated uniformity across the mesh area. FIG. 15C is a plot of cooling rate measured across 5×4 cm (L×W) cryomesh during vertical plunging with a 1- or 4-μL CPA droplet. The horizontal dashed line shows the average cooling rate of the measured five points. The conduction-dominated cryomesh (copper) demonstrated uniformity across the area within 6% (difference between highest and lowest value), while the convection-dominated cryomesh (nylon) demonstrated non-uniformity with variation up to 34%. FIG. 15D is a plot of cooling rate measured across different frame sizes of conduction-dominated cryomesh during vertical plunging with a 1-μL CPA droplet. The wire diameter is 50 μm and Φ=0.5. To scale up the mesh, a short frame size (W≤4 cm) is desired, as it shows a small temperature difference across the mesh (≤10%).

FIG. 16 is a plot of cooling rate of copper mesh and gold-coated copper mesh (2×2 cm). The cooling rate is measured on bare mesh without CPA loading at the center of the mesh. The mesh has a D=50 μm. See FIG. 7 for the definition of cryomesh solid fraction. Theoretical cooling rate is calculated with a convection heat transfer coefficient at 1250 W/m²/K. The gold coating has limited effect on cooling rate (<15%), which is expected to be due to the increase in thermal mass and which can be accounted for in adjusting the filament diameter appropriately.

FIG. 17A is a plot of theoretical rewarming rate for a range of heat transfer coefficients for different materials, where D=50 μm and Φ=0.5. Rewarming rate shown is for the biosystem with a 50 μm thickness. FIG. 17B is a plot of theoretical rewarming rate for a range of biosystem thicknesses for different materials, where h=5000 W/m²/K, D=50 μm, and Φ=0.5. The simulated biosystem rewarming rate is reported as the minimum cooling rate experienced by the biosystem.

FIG. 18 is a plot of zebrafish embryo vitrification rate and measured cooling rate on stainless steel, copper, and nylon mesh with Φ=0.5. Gray bars are the vitrification rate and blue bars are the measured cooling rate. The copper mesh used has a smaller area ratio (FIG. 2C) than the stainless steel mesh, which leads to a lower vitrification rate than stainless steel. This suggests that the cooling of copper mesh with D=50 μm is not as uniform as stainless steel with D=30 μm. Dots are the cooling rate of 1-μL CPA droplet. The conduction-dominated cryomesh (yellow-colored area) has a high vitrification rate due to the high cooling rate.

FIG. 19A is a 3D schematic of box storage system for cryomesh with a frame size of 2×2 cm. A box can store 10 cryomesh and be placed into a LN₂ tank. Outer box is designed to hold the mesh storage slots. FIG. 19B is a camera image of 3D printed cryomesh box with mesh loaded. A nylon mesh is bonded to the box to reduce the contamination from outside. Scale bar is 2 mm.

FIG. 20A is a schematic of the vitrification protocol for Drosophila embryos loaded with 27% EG and 9% sorbitol with vertical plunge. FIG. 20B are microscope images of Drosophila embryos during loading process. FIG. 20C are microscope images of Drosophila embryos after vitrification on stainless steel with D=50 μm and Φ=0.33. The image on the right is the zoomed-in view with a scale bar of 250 μm. FIG. 20D are microscope images of Drosophila embryos after vitrification on nylon mesh with D=50 μm and Φ=0.5. FIG. 20E are microscope images of Drosophila embryos after vitrification on nylon mesh with D=100 μm and Φ=0.33. Vitrified larvae are transparent. Larvae with ice formation are opaque and white in color. FIG. 20F is a plot of vitrification rate and cooling rate of stainless steel and nylon mesh with vertical plunge. The conduction-dominated cryomesh (colored area) has a higher vitrification rate due to a higher cooling rate. Gray boxes represent standard deviation of survival rates. Blue boxes represent standard deviation of simulated cooling rate. Horizontal dashed line is the estimated threshold cooling rate, which is higher than CCR for Drosophila embryo. The scale bars are 500 μm for C, D, and E.

FIG. 21 is a plot of experimental cooling rates of convection droplet, convection-dominated cryomesh, and conduction-dominated cryomesh. ^{‡}Note: cooling rate of the convection droplet is calculated based on experimental levitation time. The error bar shows the range of the data. CPA used to show the difference between those methods has a concentration of 14 wt % EG+14 wt % DMSO+RPMI (Roswell Park Memorial Institute 1640 Medium), which has been used previously in convective cryomesh experiments[5].

FIG. 22 is a plot describing the predictive nucleating and film pool boiling curve of nitrogen. Adapted from Brentari et. al[11].

FIG. 23A and FIG. 23B are images of cryomeshes during horizontal and vertical plunges, respectively. The mesh is nylon mesh with D=50 μm and Φ=0.5. Vapor nitrogen is trapped by mesh during horizontal plunge, while all nitrogen bubbles release from the mesh during vertical plunge.

FIG. 24 is a plot of measured cooling rates for vertical and horizontal plunge varying with mesh frame sizes. A 1-μL CPA droplet (14 wt % EG+14 wt % DMSO+RPMI) was pipetted on the nylon mesh to simulate the largest biosystem tested. For horizontal plunge (black squares), the mesh frames were a circle shape with diameters from 2 to 10 cm. The model suggests a lower effective heat transfer coefficient on the horizontal plunge due to trapped bubbles.

FIG. 25 is a plot of measured cooling rate for the vertical plunge with different cryomesh materials of nylon, stainless steel, and copper. The cryomesh had a wire diameter of 50 μm and Φ=0.5. The cryomesh frame size was 2×2 cm. CPA film was loaded on the mesh by immersing the mesh into CPA solution and removing extra CPA with a Kimwipe. The CPA film coated the mesh with a thickness of ~2 μm, and a 1- or 4-μL CPA droplet (14 wt % EG+14 wt % DMSO+RPMI) was pipetted on the mesh. The cooling rates of different biosystem sizes show a similar trend. The error bar is the range of the data.

FIG. 26 is a plot of the validation of theoretical and experimental rewarming rates on stainless steel with D=30 μm and nylon mesh with D=50 μm. The experimental data is measured based on PE (polyethylene) particles. The thickness used in the model is 50 μm to consider the rewarming from the other side, which is different from the cooling model. We assume h=5000 W/m²/K to consider the conduction and convection boundary conditions when plunging into rewarming solution.

FIG. 27 is a pot of hatch rate and cooling rate of Drosophila embryos on stainless steel and nylon mesh with the vertical plunge. Gray bars are the hatching rate and blue bars are the measured cooling rate of the Drosophila embryos. The conduction-dominated cryomesh (yellow-colored area) has a higher hatch rate due to a higher cooling rate and likely higher rewarming rate.

FIG. 28A-FIG. 28C provide a general guide to further improve the viability of some model biosystems used in this study. FIG. 28A is a plot describing the potential for improvement for coral larvae vitrification using the cryomesh. FIG. 28B is a plot describing the potential improvement of the viability of Drosophila embryo vitrification using the cryomesh. FIG. 28C is a plot describing the potential improvement of the viability of zebrafish embryo vitrification using the cryomesh. Viability of the biosystem increases with the increase in cooling rate. The colored region shows the potential improvement in the viability of different biosystems by increasing the cooling rate and optimizing CPA concentration. The dashed lines show predicted viability increasing with cooling rate for three biosystems. The yellow star shows one example of desired viability.

FIG. 29A and FIG. 29B describe the design and physical limits of cryomesh cooling which can be used as a general guide for application across appropriate ranges of biosystems thickness and CPA concentration. FIG. 29A is a plot showing that increasing biosystem thickness reduces the achievable cooling rate in the biosystem. The dashed lines show the highest cooling rate achieved by different mesh materials and different cooling methods. FIG. 29B is a plot showing the selection of cryoprotective agent (CPA) concentration (wt %) with different cooling methods. The upper boundary of the cryomesh optimal zone (red dashed line) is the lowest CPA concentration required for CondD-C. CPA toxicity is the major failure mode of cryopreservation, shown in the top, orange region, but will depend on specific biosystem susceptibility to the chosen CPA.

FIG. 30A and FIG. 30B describe the design and physical limits of cryomesh rewarming which can be used as a general guide for application across appropriate ranges of biosystems thickness and CPA concentration. FIG. 30A is plot showing that increased biosystem thickness reduces the achievable rewarming rate in the biosystem. The dashed lines show the highest rewarming rate achieved by different mesh materials and different cooling methods. FIG. 30B is a plot of the selection of cryoprotective agent (CPA) concentration (wt %) with different rewarming methods.

FIG. 31 is a general flowchart to use CondD-C for cryopreservation. The optimization of cryomesh and more rapid heating methods can be found in Table 5. For a thick biosystem (thickness>300 μm), more rapid heating is recommended to achieve a higher rewarming rate than the CWR.

FIG. 32 includes FIGS. 32A and 32B and describes further examples of copper-based conduction-dominated cryomesh. FIG. 32A is copper mesh with a frame of 2×2 cm. FIG. 32B is gold-coated copper mesh with a frame of 2×2 cm. FIG. 32C is gold-coated copper mesh with a frame of 5×4 cm. FIG. 32D is gold-coated copper mesh with a frame of 7×4.5 cm. The insets of FIG. 32B show the zoom-in view of cryomesh with a scale bar of 100 μm, where two examples of gold-coated copper are shown with wire diameter of 30 μm and a pore size of 35-38 μm (left) and wire diameter of 50 μm and a pore size of 50 μm (right). The scale bar of A, B, C, and D is 0.5 mm.

FIG. 33 includes FIGS. 33A-33C and describes a two-layer cryomesh for biosystem vitrification. FIG. 33A is schematic of the two-layer cryomesh design. FIG. 33B is an image of a two-layer cryomesh without a biosystem. The mesh cover is an electroplated nickel mesh with a thickness of 1 μm and a pore size of 5 μm. The mesh support is a gold-coated copper mesh with a wire diameter of 50 μm and a pore size of 50 μm. FIG. 33C is two-layer cryomesh vitrification with a model system. The model system is an alginate cylinder with a diameter of around 400 μm loaded with a CPA of 44% wt concentration.

FIG. 34 is a schematic of a conduction-dominated cryomesh box design.

FIG. 35 includes FIGS. 35A and 35B and shows biosystems distributed on the cryomesh as a monolayer versus a multilayer. FIG. 35A is a schematic of a single-layer biosystem. FIG. 35B is a schematic of multiple layers of biosystem on a cryomesh.

FIG. 36 includes FIGS. 36A and 36B and describes how plunging velocity was estimated. FIG. 36A is used to estimate the plunging velocity of a 2×2 cm cryomesh. FIG. 36B is used to estimate the plunging velocity of 5×4 cm cryomesh.

FIG. 37 includes FIGS. 37A-37D and provides viability and functional data for scaled batches of islets that were vitrified and rewarmed with the CondD-C. FIG. 37A includes examples of confocal microscopy images of control and vitrified and rewarmed islets showing high viability. FIG. 37B is a plot of control and vitrified and rewarmed islet viability measured after dissociation and cell counting. FIG. 37C is a plot of oxygen consumption rate measured for islets that were vitrified and rewarmed in the 100,000 IEQ batch. FIG. 37D is plots of GSIS measured for islets that were vitrified and rewarmed in the 25,000 IEQ and 50,000 IEQ batches.

### DEFINITIONS

Various terms are defined herein. The definitions provided below are inclusive and not limiting, and the terms as used herein have a scope including at least the definitions provided below.

The terms “preferred” and “preferably”, “example” and “exemplary” refer to embodiments that may afford certain benefits, under certain circumstances. However, other embodiments may also be preferred or exemplary, under the same or other circumstances. Furthermore, the recitation of one or more preferred or exemplary embodiments does not imply that other embodiments are not useful and is not intended to exclude other embodiments from the inventive scope of the present disclosure.

The singular forms of the terms “a”, “an”, and “the” as used herein include plural references unless the context clearly dictates otherwise. For example, the term “a tip” includes a plurality of tips.

Reference to “a” chemical compound refers to one or more molecules of the chemical compound, rather than being limited to a single molecule of the chemical compound. Furthermore, the one or more molecules may or may not be identical, so long as they fall under the category of the chemical compound.

The terms “at least one” and “one or more of” an element is used interchangeably and have the same meaning that includes a single element and a plurality of the elements, and may also be represented by the suffix “(s)” at the end of the element.

The terms “about” and “substantially” are used herein with respect to measurable values and ranges due to expected variations known to those skilled in the art (e.g., limitations and variability in measurements).

The terms “and/or” means one or all the listed elements or a combination of any two or more of the listed elements.

The terms “comprises,” “comprising,” and variations thereof are to be construed as open ended—i.e., additional elements or steps are optional and may or may not be present.

Unless otherwise specified, temperatures referred to herein are based on atmospheric pressure (i.e., one atmosphere).

“Cryopreservation” as used herein relates to preservation of a biological sample/specimen at cryogenic temperatures. Cryopreservation includes cooling/freezing the biological sample below subzero temperatures to suspend metabolic/chemical activity which can provide long term storage of biomaterials. Cryopreservation of a biological sample may also include warming the biological sample to superzero temperatures to recover the function/activity of the biological sample.

“Cryogenic” or “cryogenic temperature” as used herein relates to a temperature below sub-zero. Cryogenic temperatures can be in the range from −80° C. (−112° F.) to absolute zero (−273° C. or −460° F.) but includes any effects below the freezing point of the sample/specimen.

“Cryogenic coolant” or “cryogenic substance” or “cryogenic fluid” as used herein relates to a substance that is at a cryogenic temperature, e.g., liquid nitrogen, slush nitrogen. “Cryogenic coolant” or “cryogenic substance” or “cryogenic fluid” are used interchangeably herein.

“Cryoprotective solution” or “CPA cocktail” as used herein relates to a solution that includes one or more cryoprotective agents (CPA). Cryoprotective solution may be referred to as a “CPA solution” or a “CPA cocktail”. “Cryoprotective solution”, “CPA solution” and “CPA cocktail” are used interchangeably herein.

“Vitrification CPA concentration” as used herein relates to the concentration of the CPA(s) that are present in the CPA cocktail when the biological sample is cooled for vitrification. The vitrification CPA concentration can be determined to minimize injury to the biological sample during vitrification and rewarming. The vitrification CPA concentration is determined based on the CPA thermophysical behavior, expected cooling and rewarming conditions, and the CPA susceptibility of the biological sample.

“Osmotic stress” as used herein relates to shrinking and/or swelling of a biological sample when exposed to a solution, e.g., CPA cocktail. Osmotic stress can vary depending on the solution contents and can be minimized by gradually increasing or decreasing the contents of the solution gradually to allow the biological material to equilibrate to minimize the amount of shrinking and/or swelling of the biological sample.

“Cryomesh” as used herein relates to a porous surface/substrate that can retain a biological sample. The cryomesh can, for example, retain a biological sample on the filaments of the mesh while enabling the removal of at least some of the cryoprotective solution surrounding the biological sample. The cryomesh can, for example, retain the biological sample on the filaments of the mesh while enabling cooling, cryopreservation storage, and rewarming.

“Conduction-dominated cryomesh” or “CondD-cryomesh” or “CondD-C” as used herein relates to a cryomesh that includes materials with thermally conductive properties for transfer of heat between a biological sample and a cryogenic/rewarming fluid. Conduction-dominated cooling or rewarming occurs when the cooling or rewarming of the biological sample occurs predominantly through heat transferred between the biological sample and the cryomesh, versus heat transferred directly from the biological sample to the cryogenic/rewarming fluid. Conduction-dominated cryomesh will also be referred to herein as CondD-C and the two terms may be used interchangeably.

“Convection-dominated cryomesh” or “ConvD-cryomesh” or “ConvD-C” as used herein relates to a cryomesh that includes materials with conductive properties such that heat conducts through the cryomesh on the same order as the biological sample exchanges heat with the cryogenic/rewarming fluid by convection. Convection-dominated cooling or rewarming occurs when the cooling or rewarming of the biological sample occurs on the same order or predominantly through heat transferred directly between the biological sample and the cryogenic/rewarming fluid, versus heat transferred through the cryomesh. Convection-dominated cryomesh will also be referred to herein as ConvD-C.

The term “contact area” as used herein relates to contact between two elements, e.g. biospecimen and cryomesh, in a manner that allows for transfer of thermal energy from one element to the other through thermal conduction. The biospecimen and the cryomesh may or may not be in direct contact. There may be one or more intermediate layer(s) between the biospecimen and the cryomesh. The intermediate layer(s) may be, for example, a thin CPA layer, a film, a liquid coating, a powder coating, and combinations thereof. Thermal contact can occur if the proximity between the biospecimen and the conductor allows for the transfer of thermal energy commensurate with the described effects.

The term “vertical plunge” as used herein relates to a method of rapidly submersing a cryomesh in a cryogenic/rewarming fluid. The vertical plunge is conducted in such a manner that the plane of the cryomesh is perpendicular to the face of the cryogencic/rewarming fluid bath during and immediately after submersion in the cryogenic/rewarming fluid. The cryomesh remains immersed in the cryogenic/rewarming fluid until the desired cooling or rewarming temperature is achieved. The act of plunging may be conducted manually by hand or by an automated or robotic system and is conducted at a plunging rate sufficient to allow release of vapor bubbles from the cryomesh surface and uniform cooling across the cryomesh area.

The term “horizontal plunge” as used herein relates to a method of rapidly submersing a cryomesh in a cryogenic/rewarming fluid. The horizontal plunge is conducted in such a manner that the plane of the cryomesh is parallel to the face of the cryogencic/rewarming fluid bath during and immediately after submersion in the cryogenic/rewarming fluid. The cryomesh remains immersed in the cryogenic/rewarming fluid until the desired cooling or rewarming temperature is achieved.

The term “thermal diffusivity” as used herein is a material property defined in heat transfer as the material's thermal conductivity divided by its density and specific heat capacity at constant pressure.

“Vitrification” as used herein relates to a biological sample that has attained a glassy, amorphous structure when cryopreserved. Vitrified samples can be cryogenically stored at ultralow temperature (<−130° C.) in an ice-free glassy state. Vitrified samples may have less than 0.1% V/V of ice crystallization in the sample; however, vitrified samples may contain larger ice fractions if they may still produce a viable biological sample upon warming to superzero temperatures.

“Crystallized” sample as used herein relates to a biological sample that has attained some crystalline structure during cooling, storage, or rewarming and may not produce a viable biological sample upon warming to superzero temperatures. Crystallized samples may also be referred to herein as unvitrified samples, non-vitrified samples, or devitrified samples. These terms are used interchangeably herein.

“High-throughput” as used herein relates to the use of methods to rapidly process a large number of samples in a short amount of time.

“Biological specimens” or “biological samples” or “biological material” or “biomaterials” or “biosystems” are used interchangeably and as used herein relate to cells, adherent cells, droplets of cell suspension, droplets of protein suspension, germplasm, cell aggregates, cell clusters and spheroids, organoids, pancreatic islets, oocytes, embryos, larvae, tissue slices, tissue sections, biopsies and the like. The germplasm, oocytes, embryos, or larvae can be from a variety of species including, for example, coral germplasm, mammalian germplasm, invertebrate germplasm and the like. The cell aggregates, cell clusters, or tissues can include spheroids, organoids, 3-D cell clusters, stem-cell derived islets, precision cut tissue slices, tissue cores, tissue biopsies, engineered tissue constructs and the like. The cell aggregates may include a matrix material and the tissue may be engineered tissue. The biological samples can be unicellular organisms such as bacteria, protozoa and the like. The cell aggregates or islets and oocytes can be, for example, vertebrates such as fish, amphibians, mammals, humans and others and cells from invertebrates. The biological samples can be related to commercially relevant or endangered species (i.e., agriculture, aquaculture and biodiversity). Biological samples as used herein can include other components to aid in the cryopreservation process, e.g., CPA solution, buffer, or other media that are present when the biological sample is prepared, transferred and/or cryopreserved. The size of the biological sample may be characterized by the longest or shortest dimension of the biological sample or specimen.

“Organoid” as used herein relates to a 3D multicellular in vitro tissue construct that mimics its corresponding in vivo organ such that it can be used to study aspects of that organ in tissue culture or for therapeutic use.

“Cell cluster” or “spheroid” as used herein relates to a 3D multicellular in vitro aggregate of cells or tissue construct such that it can be to study aspects of biological or physiological function in tissue culture or for therapeutic use.

“Critical cooling rate” or “CCR” as used herein relates to the minimum rate of temperature change required to cool a sample to a stable vitrified state without forming ice.

“Critical warming rate” or “CWR” as referred to herein relates to the minimum rate of temperature rise needed to avoid ice crystal formation during rewarming of a vitrified sample.

The term “sub-millimeter” sample as referred to herein relates to a biological sample that is equal to or less than about a millimeter.

The term “millimeter” sample as referred to herein relates to a biological sample that is equal to or more than about a millimeter.

### DETAILED DESCRIPTION OF ILLUSTRATIVE EMBODIMENTS

The present description is directed to systems and methods for cryopreservation of biological materials. The systems and methods are directed to cooling and rewarming sub-millimeter and/or millimeter scale biological materials. The present description includes a vitrification-based cryopreservation system with a conduction-dominated cryomesh (CondD-C). The CondD-C system and methods using the CondD-C system can be designed to optimize and enhance the cooling and rewarming rates for cryopreservation of biological samples.

In some embodiments, the methods described herein can include submerging the CondD-C with the biological sample into a cryogenic coolant in a manner that rapidly releases vapor bubbles formed due to evaporation of the cryogenic coolant. The vapor bubbles may be released or dispersed by a variety of methods. In some embodiments, the CondD-C with the biological sample is vertically plunged into the cryogenic coolant, allowing the vapor bubbles to release from the cooling surface. In some embodiments, the CondD-C with the biological sample is plunged or submerged into the cryogenic coolant while mixing or agitation of the cryogenic coolant to disperse the vapor bubbles. In some embodiments, the submersion may be conducted manually by hand or by an automated or robotic system. The methods include removal of excess CPA solution surrounding the biological material prior to submerging in the cryogenic coolant. The CondD-C system can be configured to retain the biological material on the surface of the CondD-C during removal of the excess CPA solution and during submersion into the cryogenic coolant. The CondD-C system can be configured to retain the biological material on the surface of the CondD-C during storage and during rewarming. In one embodiment, the biomaterials are vitrified and rewarmed using the CondD-C system in the methods described herein.

It will be understood that the present description will be described with respect to a CondD-C system, but other porous, thermally conductive surfaces may also be used in the system, and all are within the scope of this description.

It will be understood that the present description will be described with respect to a vertical plunge method but other methods of releasing the vapor bubbles in the cryogenic coolant while submerging the biological sample may also be used in the methods and all are within the scope of this description.

In some embodiments, cryopreservation systems that include a CondD-C can achieve enhanced cooling rates. Methods that include a CondD-C with high thermal diffusivity and employing a vertical plunge method into the cryogenic coolant can achieve a high cooling rate. In one embodiment, the cooling rate may be, for example, from about 1 to about 14×10⁴° C./min. A CondD-C can be used for cryopreservation methods for scale-up of different biosystems. In some embodiments, model biosystems can be vitrified in large quantities distributed across an area of least about 10 cm by 8 cm or larger with the increased cooling rate. The biosystems can include, for example, coral larvae, Drosophila embryos, zebrafish embryos, and any submillimeter and/or millimeter biological samples and all are within the scope of this description. In some embodiments, the CondD-C described herein can achieve vitrification with a high cooling rate by removing excess CPA solution prior to cooling. The enhanced cooling rates achieved by using CondD-C can be beneficial to vitrify biosystems with different scales from micrometers to millimeters in large quantities.

In some embodiments, the present description can include an effective method for long-term biomaterial preservation that achieves high viability, recovery, function, and scalability. High-throughput cryopreservation of biological material, for example, coral larvae, can be performed using the systems and methods described herein. Well-established, reproducible cryopreservation of biological material can provide a unique opportunity to preserve and expand the use of important biological material.

Increasing CPA concentration (>4 M) can lower the required CCR and CWR to attainable levels, but can cause toxicity in cells and tissues, especially at higher temperatures (>4° C.). Without being bound by any theory, a critical balance must be found to avoid both injury from ice and from CPA toxicity, all while maintaining viability, functionality, and clinical scalability. Systems and methods for rapid cooling and rewarming allow use of minimal CPA concentrations, which can still allow vitrification without ice crystallization and minimize toxicity experienced by the biological material. Susceptibility to CPA will depend on the biosystem and appropriate CPA formulation and concentration can be determined based on methods as known to those of ordinary skill in the art.

Cryopreservation can allow viable cells and tissues to be preserved over time in the hypothermic, frozen, or vitrified (glassy) state. This disclosure describes systems, compositions and methods that may be used to cool biological samples to cryogenic temperatures with enhanced cooling rates and rewarm cryopreserved biological samples from cryogenic temperatures with enhanced warming rates. The systems, methods and compositions described herein are useful in, for example, cooling sub-millimeter- or millimeter-scale cryopreserved biological samples such as, for example, coral larvae and the like. The cryopreservation systems described herein can advantageously be used for high-throughput methods that can be adapted for scalability in processing a large number of samples for cryopreservation during cooling and rewarming.

Vitrification-based cryopreservation can achieve long term storage of living biological systems for biodiversity, healthcare and sustainable food production. Organismal (i.e., embryo/larvae) and organoid, cell cluster, and cell spheroid cryopreservation in the μm to mm scale can be achieved through convective cooling on “cryomesh” at rates of ~10⁴ C/min. The present description can include improved cooling rates by enabling conductive cooling through the cryomesh to enhance the convective cooling experienced by the biosystem (i.e., reduction of Biot~hL/k). The present description demonstrates that cryomesh conduction can improve convective cryomesh cooling rates from 2-10 fold (i.e., 0.24 to 1.2×10⁵° C./min) in a variety of biosystems. The present description can demonstrate that higher thermal conductivity (k), smaller mesh wire diameter D (i.e., lower D leads to the increased ratio of heat transfer area to mesh thermal mass) and pore size, cryomesh solid fraction, and vertical vs. horizontal plunging in LN₂ (improved convective transfer with the cryomesh) are key parameters to achieving improved vitrification through the conduction dominated cryomesh approach. In some embodiments, improvement in vitrification rates over traditional convective cryomesh can be shown in ecologically and biomedically important biosystems encompassing a range of relevant biosystem sizes, including coral larvae (100 μm), pancreatic islets (100-250 μm), Drosophila embryos (500 μm), and zebrafish embryos (800 μm). In some embodiments, at least 20 to 400 biosystems per mesh (2 cm by 2 cm mesh) were loaded on a conductive mesh design to scale mesh area to large sizes while maintaining uniformity of cooling rates (up to at least 5 cm by 4 cm or larger). In some embodiments, up to 100,000 biosystems per mesh were loaded on a conductive mesh design (up to at least 7 cm by 4.5 cm). In some embodiments, biosystem density can be further increased by depositing multiple layers of biosystem on the conductive mesh design versus a single monolayer. This can be combined with the ability to stack meshes in storage boxes. In some embodiments, improved vitrification in μm to mm biosystems can be shown and the ability to scale up for biorepositories and/or other uses.

One of the biggest sources of biological system damage during cryopreservation is ice formation which damages cells. A cryoprotectant agent (CPA) can be applied to avoid lethal ice formation by replacing intracellular water content from the biosystem and mitigating outside extracellular ice formation [12, 13]. Widely used CPAs and CPA cocktails can be toxic to cells and biosystems at higher CPA concentrations and temperatures [5]. To reduce this toxicity, CPA loading at lower temperatures and concentrations is typically desired. However, lower CPA concentrations require very high cooling and rewarming rates to avoid ice formation.

Cryopreservation in general can be achieved in the presence of controlled ice, or by vitrification which seeks to avoid ice formation entirely. Slow freezing is one of the conventional methods to cryopreserve cells after equilibrating with low CPA concentration (e.g., 1.4 M DMSO (dimethyl sulfoxide)) [14]. A cryovial is used to control a slow cooling rate (e.g., 1° C./min) which allows the growth of ice crystals outside of the cells. Cooling is conducted slowly enough that the extracellular ice increases the CPA concentration around cells, which leads to cellular dehydration, effectively increasing intracellular CPA concentration and controlling intracellular ice formation. This is the basis for many conventional cryopreservation protocols, especially those used on cell lines (i.e., 1-2 M DMSO, 1° C./min cooling-See ATCC, etc.). However, slow freezing often fails to achieve high viability for sensitive cells such as T-cells, stem cells, and hepatocytes [15-17] and is typically limited to smaller samples due to the variation in cooling rates experienced as sample size increases. Moreover, extreme osmotic stress and ice formation during the rewarming process remain essential challenges for slow freezing [18].

Vitrification or “ice-free” cryopreservation at higher CPA concentrations and higher cooling and warming rates avoids both extracellular and intracellular ice formation by directly transitioning from liquid to glass during cooling and then the reverse during warming [19, 20], showing high viability for a wide range of biosystems [5, 21-24]. Successful vitrification requires a cooling rate higher than the critical cooling rate (CCR) of the CPA used [10, 25, 26]. Low CPA concentrations require higher CCR to achieve vitrification. Microliter droplets have been used for vitrification due to their relatively smaller thermal mass vs. slow freezing in a 1 mL+ cryovial volume. However, when the cell-laden droplet is directly immersed in LN_{2 [27}], a nitrogen vapor layer forms around the droplet due to the boiling of LN₂, which is also known as the “Leidenfrost effect” [28, 29].

TABLE 1
Prior mesh-based vitrification. Mesh size is described in terms of wire
diameter and pore size, depending on what details were included.

| Mesh | Mesh size | | | Estimated CCR/ | | | |
|---|---|---|---|---|---|---|---|
| material | (μm) | | CPA | CWR* (° C./min) | Biosystem | Viability | Ref |
| Nylon | N/A** | | 15% EG + | 1.3 × 10³/3.6 × 10⁵ | human embryo | 98% | [1] |
| | | | 15% DMSO + | | | | |
| | | | 17.1% (0.5M) | | | | |
| | | | sucrose | | | | |
| | 75 | pore | 20% EG + | 4.5 × 10³/8.3 × 10⁵ | rabbit embryo | 66% | [2] |
| | | | 20% DMSO | | | | |
| | 37-77 | pore | 15% EG + | 1.3 × 10³/3.6 × 10⁵ | bovine mature | 28-39% | [3] |
| | | | 15% DMSO + | | oocytes | | |
| | | | 17.1% (0.5M) | | | | |
| | | | sucrose | | | | |
| | 150 wire + | | 39% EG + 9% | 5.5 × 10¹/1.2 × 10⁴ | Drosophila embryo | >50% | [4] |
| | 200 pore | | sorbitol | | | | |
| | 38 | pore | 22% EG + | 1.9 × 10³/2.6 × 10⁵ | islets | >87% | [5, 6] |
| | | | 22% DMSO | | | | |
| Stainless | 224 wire + | | PVS2 | 3.4/1.5 × 10² | shoot tips | 83% | [7] |
| steel | 400 pore | | | | | | |
| | 38 | pore | 75% VS55 | 1.5 × 10³/1.9 × 10⁵ | kidney slice | 91%*** | [8, 9] |
| | 38 | pore | 27% EG + 9% | 1.9 × 10³/6.8 × 10⁵ | Drosophila embryo | 60%*** | [8, 9] |

sorbitol

*Critical cooling rate (CCR) and critical rewarming rate (CWR) are estimated for the listed CPAs based on reference [10]. EG (ethylene glycol) is simulated as PG (propylene glycol), DMSO is simulated as glycerol, sorbitol and sucrose are simulated as trehalose. Note that this is not the actual cooling or rewarming rate achieved.
**Not mentioned in the reference.
***Viability rate is increased due to ultrarapid rewarming through Joule heating. Not for vitrification comparison. VS55 is the name of CPA with 24% (3.1M) DMSO (Me₂SO) + 20% (3.1M) Formamide + 17% (2.2M) PG. PVS2 is the name of CPA with 15% EG + 15% DMSO + 30% glycerol + 13.7% (0.4M) sucrose.

The low thermal conductivity and convective heat transfer coefficient reduce the droplet cooling rate (0.5×10⁴° C./min), limiting the droplet size (≤1 μL) [24, 29] at typical CPA concentrations used in cell-based cryopreservation [30]. However, by directly printing/placing droplets on a pre-cooled substrate at LN₂ temperature, a higher cooling rate can be achieved with a low CPA concentration (2.1×10⁴° C./min) [24, 31, 32]. However, this droplet-based method suffers from low throughput due to the need to process each droplet individually (e.g., in the μL min⁻¹ range) which limits the scalability for conservation, clinical and industrial use. It should also be noted that the cryotop is another method commonly used for submillimeter droplet vitrification. Rates achieved with the cryotop are typically on the order of 2.3×10⁴° C./min for a 0.1 μL droplet [33], which is much slower than evaluated for similar volumes here. This difference is due to the added thermal mass of the cryotop itself, which is a relatively large plastic substrate.

In some embodiments, an alternative to droplet vitrification is cryomesh vitrification [1, 34]. When the CPA-loaded a biosystem is loaded on the cryomesh, excess CPA is removed through mesh pores. This minimizes the total thermal mass allowing the cryomesh to achieve a high cooling rate without loss of viability [4]. In some embodiments, the present description can include design principles to choose the mesh appropriate for different biosystems varying with size from micrometer to millimeter.

In some embodiments, a conduction-dominated cryomesh can be achieved by using high-conductivity metal mesh (e.g., copper mesh), which increases the cooling rate. In some embodiments, by varying the mesh wire size and materials based on design principles, the cooling rate can be increased at least 10× over convective cryomesh designs. In some embodiments, the conduction cryomesh can be used to successfully vitrify two biosystems roughly ranging from micrometer to millimeter scale, including coral larvae and zebrafish embryos. In some embodiments, the improved vitrification in μm to mm biosystems can allow scale up of the methods to create biorepositories and/or for practical use.

In some embodiments, the present description can include a cryopreservation system. The cryopreservation system can include a porous, thermally conductive surface for the cryopreservation of a biological sample as described below. In some embodiments, the porous, thermally conductive surface can include a CondD-C. In some embodiments, the CondD-C system may include a frame to support the mesh, which can be manipulated as necessary, through a handle, forceps, and the like. Advantageously, the CondD-C system is a simple, versatile platform that can be used for high throughput cryopreservation (cooling and rewarming) of biological samples, e.g. biological samples in the sub-millimeter or millimeter range, and which can provide capability for rapidly increased cooling and rewarming rates over currently applied approaches.

A variety of CondD-C can be employed for enhancing the cooling and rewarming rates for cryopreservation of biomaterials. In some embodiments, the CondD-C can be selected, for example, based on the size of the biological sample(s) to be cryopreserved, the thermal conductivity of the cryomesh material, the biocompatibility with the biological sample(s) to be cryopreserved, practical considerations (material cost and availability) and the like.

In some embodiments, the CondD-C can include thermally conductive materials. The thermally conductive materials can include, for example, metals and/or other thermally conductive substances. CondD-C may include materials such as, for example, diamond, silver, gold, aluminum, copper, stainless steel, nitinol, silicon carbide, aluminum nitride, tungsten, graphite, zinc, carbon fiber and the like. The CondD-C can also include a combination of materials. In some embodiments, the CondD-C may be coated with a biocompatible material or to influence the surface tension which influences the biosystem adhesion and release. In one embodiment, the CondD-C can include, for example, a gold-plated mesh such as a gold-plated copper and/or aluminum mesh. Other thermally conductive materials and biocompatible materials may also be included, and all are within the scope of this description.

CondD-C having thermal conductivity and high thermal diffusivity can be used in the cryopreservation systems described herein. Thermal diffusivity is defined as the thermal conductivity divided by the material density and specific heat capacity. As the thermal conductivity of the CondD-C increases, the thermal diffusivity in the CondD-C increases. The conductivity of the materials in the CondD-C can vary. CondD-C with high thermal diffusivity or high thermal conductivity can lead to enhanced cooling and rewarming rates. Increases to thermal conductivity can increase cooling rates of the biological samples on the CondD-C. In some embodiments, the CondD-C materials can be selected based on the size of the biological sample. Without being bound by any particular theory, it is thought that larger biological samples may benefit from materials with higher conductivity and higher thermal diffusivity.

In some embodiments, the thermal conductivity of the CondD-C can be greater than about 10 W/m/K, or greater than about 25 W/m/K, or greater than about 50 W/m/K, or greater than about 100 W/m/K, or greater than about 200 W/m/K, or greater than about 500 W/m/K, or greater than about 1000 W/m/K, or greater than about 1500 W/m/K, or greater than about 2000 W/m/K.

CondD-C that can be included in the cryopreservation system can have a variety of characteristics or parameters that enhance the cooling rates and warming rates during cryopreservation of biological samples. In some embodiments, the CondD-C can include filaments that are packed or arranged to form the CondD-C with varying geometries. CondD-C can include filaments that can be arranged to generate a variety of mesh patterns, mesh density, and mesh pore sizes. The filaments can have various filament geometry, filament size/diameter and the like. CondD-C with a variety of filament arrangements and a variety of filament characteristics can be used and all are within the scope of the description herein.

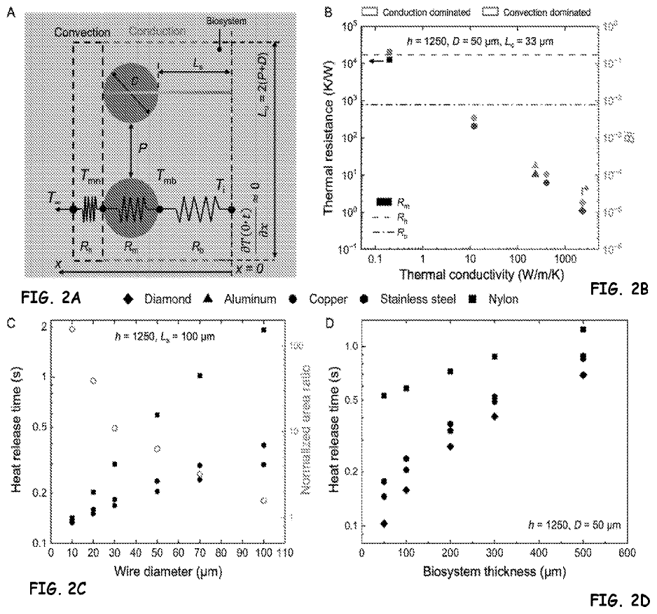

The diameter of the filaments in the CondD-C can vary and all are within the scope of this description. In some embodiments, the diameter of the filament can be selected to maximize the efficiency of the thermal heat transfer between the CondD-C and the biological sample retained on the CondD-C. In some embodiments, the diameter of the filament can be selected to maximize the CondD-C heat transfer with the cryogenic fluid and with the biological sample. In some embodiments, the diameter of the filament can be selected to enable the CondD-C to reach the temperature of the cryogenic coolant rapidly. In some embodiments, the diameter of the filament can be selected to enable the CondD-C to reach a temperature within about 20% of a temperature difference with the cryogenic coolant rapidly, for example, in less than about 0.4 seconds, or in less than about 0.2 seconds, or less than about 0.1 seconds, or less than about 0.05 seconds. FIG. 2C shows one embodiment of the times for CondD-C to reach the temperature of liquid nitrogen. “Temperature difference” as used above and herein after refers to the temperature difference between the CondD-C (or Conduction-dominated cryomesh) and the cryogenic coolant.

In some embodiments, the diameter of the filament can be selected to enable the CondD-C to reach a temperature within about 10% of the temperature difference with the cryogenic coolant rapidly, for example, in less than about 0.4 seconds, or in less than about 0.2 seconds, or less than about 0.1 seconds, or less than about 0.05 seconds.

In some embodiments, the diameter of the filament can be selected to enable the CondD-C to reach a temperature within about 5% of the temperature difference with the cryogenic coolant, for example, in less than about 0.4 seconds, or in less than about 0.2 seconds, or less than about 0.1 seconds, or less than about 0.05 seconds.

In some embodiments, the porous thermally conductive surface is at least about 2 cm×2 cm, or at least about 5 cm×4 cm, or at least about 7 cm×4.5 cm, or at least up to 15 cm×4 cm, or at least up to 10 cm×8 cm or larger. In some embodiments, the surface holds at least about 10 biological samples, at least about 50 biological samples, at least about 200 biological samples, at least about 400 biological samples, at least about 1000 biological samples, at least about 2500 biological samples, at least about 5000 biological samples, or at least about 10,000 biological samples or more. In some embodiments, the surface holds at least about 50,000 biological samples, at least about 100,000 biological samples, at least about 500,000 biological samples, at least about 1 million biological samples, or holds at least about 5 million biological samples.

The thickness of the biological sample can vary and can determine the time the biological sample takes to reach the temperature of the cryogenic coolant. In one embodiment, FIG. 2D shows the times that biological samples of varying thicknesses can reach the temperature of the liquid nitrogen.

In some embodiments, the diameter of the filament can be selected to enable the biological sample on the CondD-C to reach the temperature of the cryogenic coolant rapidly. In some embodiments, the diameter of the filament can be selected to enable the biological sample on the CondD-C to reach a temperature within about 20% of the temperature difference with the cryogenic coolant rapidly, for example, in less than about 0.8 seconds, or in less than about 0.4 seconds, or less than about 0.2 seconds, or less than about 0.1 seconds, or less than about 0.05 seconds.

In some embodiments, the diameter of the filament can be selected to enable the biological sample on the CondD-C to reach a temperature within about 10% of the temperature difference with the cryogenic coolant rapidly, for example, in less than about 0.8 seconds, or in less than about 0.4 seconds, or in less than about 0.2 seconds, or less than about 0.1 seconds, or less than about 0.05 seconds.

In some embodiments, the diameter of the filament can be selected to enable the biological sample on the CondD-C to reach a temperature within about 5% of the temperature difference with the cryogenic coolant, for example, in less than about 0.8 seconds, or in less than about 0.4 seconds, or in less than about 0.2 seconds, or less than about 0.1 seconds, or less than about 0.05 seconds.

In some embodiments, the diameter of the filaments in the CondD-C can be at least about 1 μm, or at least about 5 μm, or at least about 10 μm, or at least about 15 μm, or at least about 20 μm, or at least about 25 μm, or at least about 30 μm, or at least about 35 μm, or at least about 40 μm, or at least about 45 μm, or at least about 50 μm.

In some embodiments, the diameter of the filaments in the CondD-C can be less than about 50 μm, or less than about 40 μm, or less than about 35 μm, or less than about 30 μm, or less than about 25 μm, or less than about 20 μm, or less than about 15 μm, or less than about 10 μm, or less than about 5 μm. In some embodiments, the diameter of the filaments in the CondD-C can be between about 20 μm and about 50 μm. In some embodiments, the diameter of the filaments in the CondD-C can be between about 20 μm and about 30 μm.

In some embodiments, CondD-C can include a variety of pore sizes. The pores sizes as used herein refer to average pore sizes and can also include pore sizes larger and/or smaller than the average pore size. The average pore size of the CondD-C can vary and depend on the size of the biological sample. In some embodiments, the average pore size of the CondD-C can allow the biological sample to be retained on or within the CondD-C and not pass through the CondD-C. CondD-C can include a variety of sizes for the openings or pores between the filaments. In some embodiments, the average pore size is less than about one millimeter; or less than about 750 micrometers; or less than about 500 micrometers; or less than about 400 micrometers; or less than about 300 micrometers; or less than about 250 micrometers; or less than about 200 micrometers; or less than about 100 micrometers; or less than about 50 micrometers; or less than about 10 micrometers; or less than about 5 micrometers; or less than about 1 micrometers.

In some embodiments, the average pore size in the CondD-C can be greater than about one micrometer; or greater than about 10 micrometers; or greater than about 20 micrometers; or greater than about 30 micrometers; or greater than about 50 micrometers; or greater than about 75 micrometers; or greater than about 100 micrometers; or greater than about 250 micrometers; or greater than about 500 micrometers; or greater than about 750 micrometers; or greater than about 900 micrometers, or greater than about a millimeter.

The filament geometry of CondD-C can include, for example, cylindrical, rectangular and the like. In one embodiment, filaments with a round cross-section are used and so the representative dimension used is the diameter. However, other filament geometries could be used, and the diameter will be representative of the filament characteristic thickness independent of filament geometry. In some embodiments, mesh filament surfaces can include, for example, hydrophilic surfaces. In some embodiments, mesh filament surfaces can include, for example, hydrophobic surfaces. The surface of the filaments and the CondD-C can include coatings or surfaces that can retain the biological samples during the vertical plunge cooling method as described herein and subsequent release during plunge rewarming. In other words, there can be sufficient surface adhesion and subsequent release between the biological sample and the CondD-C to allow for cooling and/or rewarming using a vertical plunge method. Patterns for the CondD-C can include, for example, plain weave, twill weave, dutch weave, twill dutch weave, perforated plate and the like.

In some embodiments, the solid fraction of the CondD-C can be manipulated to enhance the cooling rate of the biological sample by reducing the thermal mass of the cryopreservation system. As used herein, the solid fraction (Φ) of the CondD-C can be related to the wire diameter (D), with the unit of μm, where Φ=D/(P+D) and P is the pore size of the mesh. CondD-C with a variety of solid fraction can be used in the cryopreservation methods. In some embodiments, the solid fraction can be between about 0.3 and about 0.9. In some embodiments, the solid fraction can be between about 0.5 and about 0.66. Solid fractions outside of these ranges may also be used and all are within the scope of this description.

In some embodiments, the material and geometry of the mesh can be designed for low thermal mass (mass of the mesh*heat capacity of the mesh material) and high thermal conductivity. The contact area between the biological sample and the CondD-C can be increased. Those combined conditions can lead to desired faster cooling/warming rates.

In some embodiments, the characteristics of the CondD-C, e.g. mesh pattern, mesh density, filament geometry (e.g. shape, size), material and the like, can impact the rewarming experienced by the loaded biological specimen under conductive and/or convective rewarming. The rewarming rate, for example, can be impacted through exposed surface area, biological specimen contact area, and heat transfer characteristics of CondD-C. The rewarming can also include the vertical plunging method as described herein.

In some embodiments, the size or dimensions of the CondD-C can impact the total amount or number of biological samples that can be cryopreserved. In some embodiments, the length of the CondD-C can be between about 1 cm and about 30 cm; or between about 5 cm and about 20 cm; or between about 10 cm and about 15 cm. Other lengths outside of this range are also within the scope of this description.

In some embodiments, the width of the CondD-C can be between about 1 cm and about 30 cm; or between about 5 cm and about 20 cm; or between about 10 cm and about 15 cm. Other widths outside of this range are also within the scope of this description.

The CondD-C can be in a variety of shapes and all are within the scope of this description. In some embodiments, the mesh is in the shape of a square, a rectangle, a circle, a hexagon, an octagon, and the like. A second CondD-C can also be placed on top of the biological samples, effectively creating a “sandwiched” structure, allowing conductive cooling and rewarming from both sides of the biological sample. If the CondD-C is conducting heating to/from the biosystem in multiple directions, this effectively reduces the biosystem thickness used in the analysis described herein. In some embodiments, “sandwiching” the biosystem between two ConD-C will effectively reduce the effective biosystem thickness by about half.

In some embodiments, CondD-C can be incorporated into an automated (e.g. rapid sequential or parallel processing of multiple CondD-C) or “assembly-line” type approach (e.g. a continuous length or coiled cryomesh). In some embodiments, the scalability of the cryopreserved samples can be increased by increasing the width and/or the length of the cryomesh. In some embodiments, the scalability of the cryopreserved samples can be increased by stacking a number of cryomesh to accomplish a high-throughput approach. Each layer of CondD-C can be separated sufficiently within the cryomesh stack to achieve the desired cooling and rewarming rates in excess of the CCRs and CWRs of the biological samples, respectively. In some embodiments, the cryomesh in a stack may be cooled and rewarmed individually, to achieve the desired cooling and rewarming rates. Other methods of increasing scalability by increasing the amount of CondD-C available to hold the biomaterials may be used and are within the scope of this description.

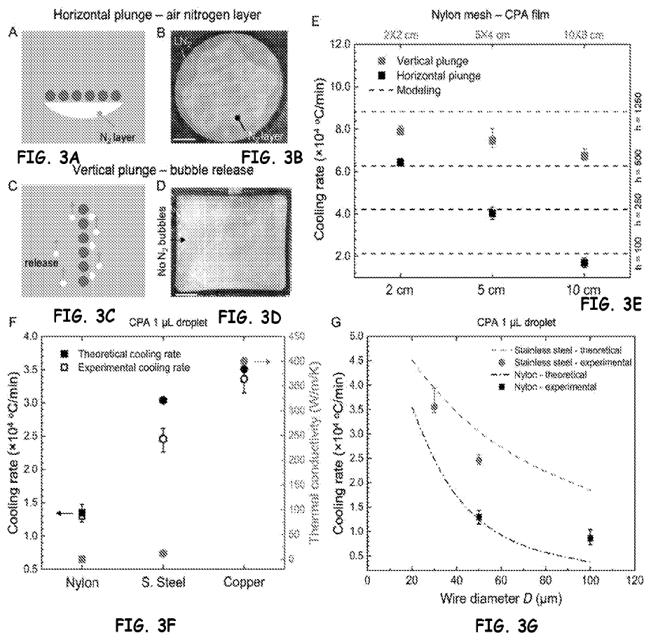

In some embodiments, scaling up for cooling larger numbers of biological samples can include cooling larger mesh areas. Cooling larger mesh areas can be achieved by the vertical plunge method and a CondD-C designed to achieve rapid and uniform cooling rates across the CondD-C area. See, for example, FIG. 3E, Figure S8 and Figure S9. In some embodiments, uniform cooling rates can vary by about +/−30% or less across larger mesh areas, or by about +/−20% or less, or by about +/−10%, or by about +/−5%, or by about +/−1%, or less across larger mesh areas. In some embodiments, comparable uniformity in rewarming rates will be expected across the CondD-C area during plunge rewarming.

A variety of biological samples can be cryopreserved according to the systems and methods described herein. In some embodiments, the biological samples can be cells, adherent cells, droplets of cell suspensions, droplets of protein suspension, germplasm, cell aggregates, cell clusters, cell spheroids, organoids, islets, oocytes, embryos, larvae, tissue slices, tissue sections, biopsies and the like. The germplasm, oocytes, and embryos can be from a variety of species including, for example, coral germplasm, mammalian germplasm, invertebrate germplasm and the like. The cell aggregates, cell clusters, and tissues can include spheroids, organoids, 3-D cell clusters, stem-cell derived islets, precision cut tissue slices, tissue cores, tissue biopsies, engineered tissue constructs and the like. The cell aggregates or clusters may include a matrix material and the tissue may be engineered tissue The biological samples can be unicellular organisms such as bacteria, protozoa and the like. The cell aggregates or islets and oocytes can be, for example, vertebrates such as fish, amphibians, mammals, humans and others and cells from invertebrates. The biological samples can be related to commercially relevant or endangered species (i.e., agriculture, aquaculture and biodiversity). In some embodiments, the biological samples can be, for example, coral larvae, Drosophila embryos, and zebrafish embryos.

In some embodiments, CPA solutions can be used in a method for loading the biological sample prior to cooling for cryopreservation. Loading of CPA solutions into the biological samples can be performed by a variety of methods including perfusing, suspending, injecting, equilibrating and the like. All methods of loading a CPA solution into biological material are within the scope of this description.

Also as used herein, “minimal damage” refers to an amount of damage to the biomaterial experienced during cooling or rewarming and is insubstantial enough so that the biomaterial retains its desired biological functionality when rewarmed. Thus, minimal devitrification can allow for some degree of damage and the permissible amount may vary depending upon the intended use of the biomaterial after rewarming. In this context, “damage” is a collective term that generically refers to damage to biomaterial that can commonly result in failed cryopreservation. Such damage includes, for example, devitrification and/or cracking. In embodiments in which the biomaterial includes, for example, cells or tissues for therapeutic treatments, the rewarmed cells or tissues having “minimal damage” may sustain some damage but remain useful for therapeutic treatment to a recipient. As another example, in embodiments in which the biomaterial includes, for example, reproductive materials (e.g., ova, sperm, semen), the specimen having “minimal damage” may include an acceptable percentage of non-viable cells while retaining a useful percentage of viable cells.

In some embodiments, the present description can include a method for cryopreservation of biological samples. In some embodiments, the biological samples are, for example, coral larvae, Drosophila embryos, and zebrafish embryos. The method can include obtaining the biological material to be cryopreserved. In one embodiment, the biological material can be isolated and cultured from tissues and placed in a desired and/or a suitable media or buffer. The biologic material can be cells or cell clusters suspended in a solution. The biological material may be in, for example, a buffer for maintaining the biological material prior to cryopreservation. The biological material may be at a stage, e.g., a fully differentiated state, desired for cryopreservation. In one embodiment, the biological material may be stem cell derived material that is fully differentiated.

The biological sample can include a variably sized biomaterial specimen. The biological material can be any sub-millimeter- or millimeter scale biomaterial. In some embodiments, the term sub-millimeter- or millimeter scale sample can have a largest linear dimension of less than about ten millimeters (mm); or less than about five mm; or less than about one mm; or less than about 0.9 mm; or less than about 0.7 mm; or less than about 0.5 mm; or less than about 0.3 mm; or less than about 0.1 mm; or less than about 50 micrometers; or less than about 10 micrometer; or less than about 1 micrometer.

In some embodiments, the term sub-millimeter- or millimeter scale sample can have a smallest linear dimension of greater than about one micrometer; or greater than about 10 micrometer; or greater than about 0.1 mm; or greater than about 0.3 mm; or greater than about 0.5 mm; or greater than about 0.7 mm; or greater than about 0.9 mm; or greater than about one mm; or greater than about five mm; or greater than about ten mm.

In one embodiment, the biological material can be between about 50 micrometers and about one millimeter. Biological materials outside of this range are also within the scope of this description.

The methods described herein can include loading the biological material with a CPA solution. The CPA solution can include one or more cryoprotective agents. The composition, systems and methods described herein can involve the use of other one or more suitable cryoprotective agents and all are within the scope of this description. Exemplary suitable cryoprotective agents include, but are not limited to, combinations of alcohols, sugars, polymers, and ice blocking molecules that alter the phase diagram of water and allow a glass to be formed more easily (and/or at higher temperatures) while also reducing or controlling the likelihood of ice nucleation and growth during cooling or thawing. In some embodiments, cryopreservative agents may not be used alone, but in combination with other CPA and/or suitable agents that promote cryopreservation. In the case of vitrification solutions, exemplary cryopreservative cocktails are reviewed in Fahy et al., He, Xiaoming, et al., Risco, Ramon, et al. and Choi, Jung Kyu, et al. and all incorporated herein by reference. (Fahy et al., Cryobiology 48 (1): 22-35, 2004; He, Xiaoming, et al. “Vitrification by ultra-fast cooling at a low concentration of cryoprotectants in a quartz micro-capillary: a study using murine embryonic stem cells.” Cryobiology 56.3 (2008): 223-232; Risco, Ramon, et al. “Thermal performance of quartz capillaries for vitrification.” Cryobiology 55.3 (2007): 222-229; Choi, Jung Kyu, Haishui Huang, and Xiaoming He. “Improved low-CPA vitrification of mouse oocytes using quartz microcapillary.” Cryobiology 70.3 (2015): 269-272.) Additional exemplary cryopreservative solutions can include one or more of the following: dimethyl sulfoxide, glycerol, propylene glycol, ethylene glycol, sucrose, trehalose, raffinose, polyvinylpyrrolidone, and/or other polymers (e.g., ice blockers and/or anti-freeze proteins).

The cryoprotective agents may be penetrating cryoprotective agents such as, for example, EG, DMSO, PG, methanol, glycerol, formamide, and the like. Non-penetrating cryoprotective agents may also be used during vitrification and/or rewarming. Non-penetrating cryoprotective agents can be, for example, sucrose, trehalose, lactose, sorbitol, Ficoll, polyethylene glycol (PEG), polyvinyl pyrrolidone (PVP), polyvinyl alcohol, polyglycerol, and the like.

The cryoprotective agent(s) may be present in the CPA cocktail at various concentrations. In some embodiments, the CPAs may be present, for example, at a molarity of no more than 9 M, no more than 8 M, no more than 7 M, no more than 6 M, no more than 5 M, for example, no more than 4 M, for example, no more than 3 M, for example, no more than 2 M, for example, no more than 1 M, for example, no more than 900 mM, for example, no more than 800 mM, for example, no more than 700 mM, for example, no more than 600 mM, for example, no more than 500 mM, or for example, no more than 250 mM.

In some embodiments, the vitrification CPA concentration, may be, for example, at a weight percent of no more than about 60% by weight, no more than about 50% by weight, or no more than 45% weight, or no more than 40% weight, or no more than 30% by weight, or no more than 20% by weight, or no more than 10% by weight.

In some embodiments, the method can include loading the biological material with the CPAs by gradually increasing the concentration of the CPAs in the CPA cocktail. In some embodiments, the gradual increase may be achieved in a multi-step process. In some embodiments, the gradual increase may be achieved by continuous addition of the CPAs.

In some embodiments, two CPAs may be used at about a 1:1 ratio, or about 1:2 ratio, or about 1:5 ratio, or about 1:10 ratio or about 2:1 ratio, or about 5:1 ratio, or about 10:1 ratio in the CPA cocktail. Other ratios and combinations of CPAs used in the CPA cocktail are also in the scope of this description.

In some embodiments, unloading of the CPAs from the rewarmed biological material can be performed by gradually decreasing the CPA concentration after rewarming of the vitrified biological material. In some embodiments, the unloading may be performed in multi-steps. In some embodiments, the unloading may be performed by gradually flowing in or pumping in a diluent or buffer to slowly reduce the concentration of the CPAs in the CPA cocktail.

The present description can further include methods for cooling biological samples that use the cryopreservation system described herein. The method can generate high cooling and/or rewarming rates. The method can include the use of a CondD-C for vitrification and rewarming of the biological specimen. The method can include transferring the biological samples that have been loaded with a CPA cocktail onto the CondD-C. The biological samples with the CPA cocktail can be transferred onto the CondD-C in a variety of methods. In some embodiments, a volume of CPA cocktail with the biological specimen may be placed on the CondD-C. The placement of the biological samples and the CPA cocktail onto the mesh can result in some or most of the CPA cocktail being removed from around the biological samples by drainage of excess CPA cocktail through the openings/pores in the CondD-C. In some embodiments, a wicking material and/or an external vacuum can be used to remove or wick away the CPA cocktail around the biological sample. Advantageously, wicking the CPA cocktail around the biological sample can minimize the thermal mass of the biological sample being cryopreserved and enabling increases in the cooling rates achieved.

In some embodiments, the wicking can remove some of the CPA cocktail around the biological sample; or greater than about 90% of the CPA cocktail; or greater than about 80% of the CPA cocktail; or greater than about 50% of the CPA cocktail around biological sample.

In some embodiments, the wicking material may be fibrous. In some embodiments, the wicking material may be placed on, placed below and/or be resting on/around the mesh to advantageously wick any moisture that may be present in the sample.

In some embodiments, the method can include vitrification-based cooling of the biological samples by a conduction dominant heat transfer method. The CondD-C with the biological samples can be submerged into a cryogenic coolant to rapidly cool the biomaterial sample. In some embodiments, the methods described herein include submerging the CondD-C with the retained biological samples in a manner that rapidly releases vapor bubbles formed from the evaporation of the cryogenic fluid. In some embodiments, the submersion of the biological samples on the CondD-C reduces and/or eliminates wrapping of the evaporating coolant bubbles around the biological samples. The vapor bubbles may be released or dispersed by a variety of methods. In some embodiments, the CondD-C with the biological samples is vertically plunged into the cryogenic coolant with the natural buoyancy of the vapor releasing them from the surface. In some embodiments, the CondD-C with the biological samples is plunged or submerged into the cryogenic fluid while mixing or agitation of the cryogenic fluid in order to disperse the vapor bubbles. Without being bound by any particular theory, it is thought that vertical plunging and/or agitation prevents the bubbles from wrapping around the biological samples and disperses the vapor bubbles rapidly to promote efficient heat transfer between the CondD-C and the cryogenic fluid.

In some embodiments, the speed of vertical plunging may impact the release of vapor bubbles formed during cooling or uniformity of cooling across the CondD-C area. The vertical plunging speed may be greater than about 25 cm/s, or greater than about 50 cm/s, or greater than about 100 cm/s, or greater than about 200 cm/s, or greater than about 500 cm/s, or greater than 1 m/s.

In some embodiments, the biological samples retained on the CondD-C can remain attached to the CondD-C during the submersion of the biological sample into the cryogenic fluid. In some embodiments, the biological sample can remain adhered to the surface of the CondD-C due to the surface tension adhesion with the residual CPA after loading and during cooling. Once vitrified, the residual CPA can secure the biological sample on the mesh during handling and storage. In some embodiments, the biological sample can be released from the mesh during plunging into the rewarming solution or during CPA unloading steps. In some embodiments the biological sample may remain adhered to the cryomesh surface during rewarming and be washed off during at a subsequent processing step.

The thickness of the biological samples cooled in the methods described herein can vary. Biological samples with a larger thickness can be cooled with greater cooling rates to avoid devitrification or biomaterial damage during the cooling with the CondD-C system and methods. In some embodiments, the thickness of the biological sample can be less than about 1 mm, or less than about 500 microns, or less than about 400 microns, or less than about 300 microns, or less than about 200 microns, or less than about 100 microns, or less than about 50 microns.

In some embodiments, the thickness of the biological sample can be greater than about 10 microns, or greater than about 50 microns, or greater than about 100 microns, or greater than about 200 microns, or greater than about 300 microns, or greater than about 400 microns, or greater than about 500 microns. Thicknesses of the biological samples outside of this range are also within the scope of this description.

In some embodiments, the biological sample can have a thickness of about 50 microns or less and a cooling rate of at least about 1×10⁴° C./min, or at least about 4×10⁴° C./min. In one embodiment, the biological sample can have a thickness of about 50 microns or less and a cooling rate of at least about 4.2×10⁴° C./min. In one embodiment, the sample can be a CPA thin film with a cooling rate of at least about 7.8×10⁴° C./min.

In some embodiments, the biological sample can have a thickness of about 100 microns or less and a cooling rate of at least about 1×10⁴° C./min, or at least about 3×10⁴° C./min. In one embodiment, the biological sample can have a thickness of about 100 microns or less and a cooling rate of at least about 3.0×10⁴° C./min.

In some embodiments, the biological sample can have a thickness of about 200 microns or less and a cooling rate of at least about 1×10⁴° C./min, or at least about 1.5×10⁴° C./min. In one embodiment, the biological sample can have a thickness of about 200 microns or less and a cooling rate of at least about 1.8×10⁴° C./min.

In some embodiments, the biological sample can have a thickness of about 300 microns or less and a cooling rate of at least about 0.5×10⁴° C./min, or at least about 1×10⁴° C./min. In one embodiment, the biological sample can have a thickness of about 300 microns or less and a cooling rate of at least about 1.2×10⁴° C./min.

In some embodiments, the biological sample can have a thickness of about 500 microns or less and a cooling rate of at least about 0.1×10⁴° C./min, or at least about 0.5×10⁴° C./min. In one embodiment, the biological sample can have a thickness of about 500 microns or less and a cooling rate of at least about 0.74×10⁴° C./min. The cryogenic coolant can be liquid nitrogen, slush nitrogen and the like. Other cryogenic coolants may be used and all are within the scope of this description. After vitrification on the Cond-C the biomaterial can be stored in the cryogenic coolant until future use or transferred to another means of maintaining them at cryogenic storage temperatures.

The cooling of the biological material can advantageously occur uniformly across the CondD-C. In some embodiments, the cooling of the biological material can occur with a variation of temperature across the cryomesh of less than about 20%, or with a variation of less than about 10%.

In some embodiments, the use of CondD-C in the cryopreservation methods can increase the cooling and/or increase the throughput over prior art methods. In some embodiments, the cooling rates can be greater than about 5,000° C./min; or greater than about 10,000° C./min; or greater than about 25,000° C./min; or greater than about 30,000° C./min; or greater than about greater than about 40,000° C./min; or greater than about 50,000° C./min; or greater than about 60,000° C./min; or greater than about 100,000° C./min; or greater than about 500,000° C./min.

In some embodiments, the biological material is cooled to within about 20% of the temperature difference with the cryogenic coolant rapidly. In some embodiments, the biological material is cooled to within about 20% of the temperature difference with the cryogenic coolant within about 0.8 seconds or less, or within about 0.4 seconds or less, or within about 0.3 seconds or less, or within about 0.2 seconds or less, or within about 0.1 second or less.

In some embodiments, the biological material is cooled to within about 10% of the temperature difference with the cryogenic coolant rapidly. In some embodiments, the biological material is cooled to within about 10% of the temperature difference with the cryogenic coolant within about 1.0 second or less, or within about 0.8 seconds or less, or within about 0.4 seconds or less, or within about 0.3 seconds or less, or within about 0.2 seconds or less, or within about 0.1 second or less.

In some embodiments, the method can further include rewarming the cryopreserved biological samples. A variety of rewarming methods can be used to rewarm the cryopreserved biological samples and all are within the scope of this description. In some embodiments, vertical plunge as described herein may also be used for rewarming in a rewarming fluid. In some embodiment, rewarming may be conducted using a conductive or joule heating method.

In some embodiments, the use of CondD-C in the cryopreservation methods can increase the warming rates and/or increase the throughput over prior art methods. In some embodiments, the warming rates can be greater than about 5,000° C./min; or greater than about 10,000° C./min; or greater than about 25,000° C./min; or greater than about 30,000° C./min; or greater than about greater than about 40,000° C./min; or greater than about 50,000° C./min; or greater than about 60,000° C./min; or greater than about 100,000° C./min; or greater than about 500,000° C./min; or greater than about 700,000° C./min; or greater than about 1,000,000° C./min.

In some embodiments, the biological sample can have a thickness of about 50 microns or less and a warming rate of at least about 10×10⁴° C./min, or at least about 30×10⁴° C./min. In one embodiment, the biological sample can have a thickness of about 50 microns or less and a warming rate of at least about 32.3×10⁴° C./min. In one embodiment, the sample can be a CPA thin film with a warming rate of at least about 51.4×10⁴° C./min.

In some embodiments, the biological sample can have a thickness of about 100 microns or less and a warming rate of at least about 5×10⁴° C./min, or at least about 15×10⁴° C./min. In one embodiment, the biological sample can have a thickness of about 100 microns or less and a warming rate of at least about 19.6×10⁴° C./min.

In some embodiments, the biological sample can have a thickness of about 200 microns or less and a warming rate of at least about 2×10⁴° C./min, or at least about 8×10⁴° C./min. In one embodiment, the biological sample can have a thickness of about 200 microns or less and a warming rate of at least about 9.8×10⁴° C./min.

In some embodiments, the biological sample can have a thickness of about 300 microns or less and a warming rate of at least about 1.5×10⁴° C./min, or at least about 4×10⁴° C./min. In one embodiment, the biological sample can have a thickness of about 300 microns or less and a warming rate of at least about 5.3×10⁴° C./min.

In some embodiments, the biological sample can have a thickness of about 500 microns or less and a warming rate of at least about 1×10⁴° C./min, or at least about 2×10⁴° C./min. In one embodiment, the biological sample can have a thickness of about 500 microns or less and a warming rate of at least about 2.3×10⁴° C./min.

In some embodiments, the biological sample can have a thickness of about 50 microns or less and be loaded with CPA concentrations down to 16% wt for successful vitrification and CPA concentrations down to 30% wt for successful rewarming.

In some embodiments, the biological sample can have a thickness of about 100 microns or less and be loaded with CPA concentrations down to 18% wt for successful vitrification and CPA concentrations down to 32% wt for successful rewarming.

In some embodiments, the biological sample can have a thickness of about 200 microns or less and be loaded with CPA concentrations down to 20% wt for successful vitrification and CPA concentrations down to 34% wt for successful rewarming.

In some embodiments, the biological sample can have a thickness of about 300 microns or less and be loaded with CPA concentrations down to 21% wt for successful vitrification and CPA concentrations down to 35% wt for successful rewarming.

In some embodiments, the biological sample can have a thickness of about 500 microns or less and be loaded with CPA concentrations down to 23% wt for successful vitrification and CPA concentrations down to 37% wt for successful rewarming.

### EXAMPLES

### Materials and Methods

### Physical Fabrication of Cryomesh

Cryomesh was fabricated based on a 3D-printed frame with different sizes of mesh. Before fabrication, the mesh was cut to size, cleaned with the acid dip solution (Rio Grande), and cleaned with deionized (DI) water. The PLA frame was designed with Autodesk Fusion 360 and 3D printed by LulzBot TAZ 6 3D printer. Then, the mesh was ironed with the frame at a temperature of ~250° C. by a digital soldering station with a controlled temperature (Radioshack). The temperature of the iron is within the range of the glass transition temperature of PLA. With applied pressure, the softened PLA frame can firmly bond with the mesh. Then the cryomesh is further cleaned with 75% ethanol and DI water, successively. Copper mesh and stainless-steel mesh are purchased from TWP Inc. Nylon mesh is purchased from McMaster.

### Cooling Rate Measurement

To measure the cooling rates of the cryomesh method, a bare wire type T thermocouple (unsheathed fine gauge thermocouples, wire diameter is 50 μm, OMEGA) and an oscilloscope (DS1M12) were used. Cooling and warming rates were calculated to represent rates during cooling and warming in the temperature zone from −140° C. to −20° C. using Microsoft Excel.

### Cryopreservation Protocol of Zebrafish Embryo

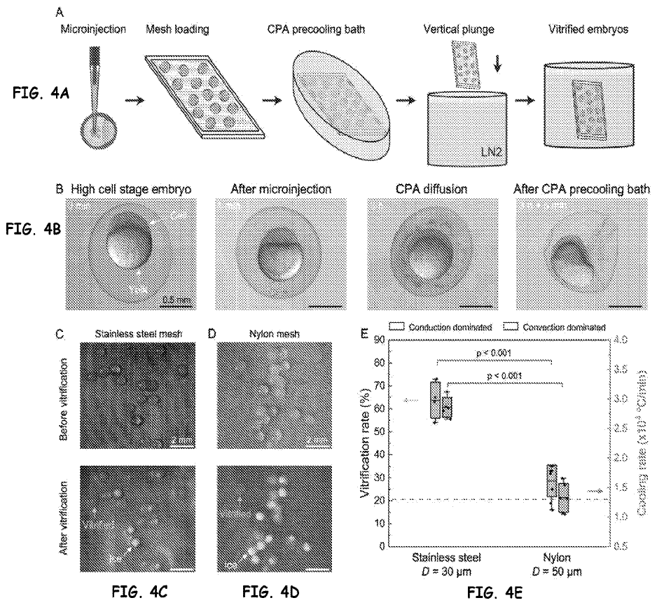

Wild-type zebrafish (Danio rerio) embryos were obtained from the University of Minnesota Zebrafish Core Facility. All animal care and welfare met NIH animal care standards. Full details of the approved protocols are listed with the Zebrafish Core IACUC (protocol #1506-32642A). Previous protocols were used to establish cryopreservation procedures for zebrafish embryos which were modified for use with the cryomesh [35-37]. Zebrafish embryos were microinjected with 10 nl of CPA (80% of PG and 20% MeOH) at the high cell stage (3.3 h after fertilization). Each experiment included a microinjection using an automated platform. The embryos were cultured in an incubator at 28° C. for 2 to 4 hours after microinjection. The zebrafish embryos were then transferred to the cryomesh with care. Almost all of the embryos remained adhered to the cryomesh. The excess media was then wicked away with a Kimwipe. Wicking should take no more than 20 seconds. The cryomesh was then immersed in a precooling bath for 5 minutes. A precooling bath of 2.7 M PG, 1.2 M MeOH, and 0.5 M Trehalose (Tre) was used. Following the precooling bath, a paper towel was used to wick out as much of the precooling bath solution as possible without injuring the embryos. Because high temperatures can reduce survival, the wicking process was completed in less than 20 seconds. The cryomesh was then vertically plunged in LN₂ with the CPA loaded and dehydrated zebrafish embryos attached. The vitrified embryos are cryopreserved at this stage and can be stored in liquid nitrogen for future use. To assess the vitrification rate, the cryomesh and zebrafish embryos were examined under the microscope while cryogenic temperatures were maintained in LN₂ vapor. The photos were captured using an overhead microscopic camera thereby allowing an estimation of vitrification rate (FIGS. 4C and 4D). For each individual test, 20 zebrafish embryos are loaded on a single mesh. The maximum number of zebrafish embryos tested is 45 with a vitrification rate of 54%. At least 4 individual tests were performed on around 500 zebrafish embryos in total.

### Cryopreservation Protocol for Drosophila Embryos

A Drosophila melanogaster stock derived from the w1118 strain called M2 was used in this study [4,8]. The protocol follows previously reported protocols [4,8]. The Drosophila embryos were collected on a grape juice plate for one hour. The plate was incubated in a 20° C. incubator until the youngest embryos reached 22 hours old. The embryos were dechorionated with 50% bleach (1:1 mixture of DI water and Clorox disinfecting bleach) for 3 min and rinsed with water. Before CPA loading, the embryos were permeabilized with isopropanol (ACS reagent≥99.5%, Sigma), 1:4 v/v of D-limonene (food grade, Blubonic Industries) and heptane (HPLC, Sigma), and heptane, successively. There were two CPA loading steps. The first CPA loading step involved incubation in 13 wt % EG prepared with cryobuffer [4] at room temperature for 25 mins. The embryos were transferred to the dehydration CPA (27 wt % EG+9 wt % sorbitol in cryobuffer) on ice for 9 mins. For all the above steps, the embryos were kept in a nylon mesh basket that was transferred between solutions so that the embryos were suspended in these solutions. Then, the CPA-loaded dehydrated embryos were transferred to different cryomeshes (either nylon or stainless steel), and extra CPA was removed with a Kimwipe for further vitrification. The remaining CPA between embryos and cryomesh kept the embryos attached to the cryomesh in liquid nitrogen. We used a microscope (Amscope) and a CMOS C-mount camera (MU1000) to visualize the vitrification of embryos on cryomesh set in liquid nitrogen.

### Cryopreservation Protocol of Coral Larvae

### Production of Coral Larvae

Twenty individuals of the Hawaiian coral L. scutaria, obtained in accordance with Hawaii Department of Land & Natural Resources Special Activity Permit 2023-31, were placed in separate bowls at 16:00 local time one and two days after the full moon in August and September 2022, covering the known times of spawning for that species in Hawaii [23]. Two days after the full moon, between 17:00 and 18:30, the corals spawned by releasing brief puffs of eggs or sperm. Eggs from females were captured on release with a transfer pipette directly from the mouths of the corals and transferred to clean bowls with 0.5-μm-filtered seawater. Sperm was collected from male bowls with a transfer pipette and was pooled into a new bowl. Pooled sperm was added into the egg bowls for a final egg:sperm ratio of approximately 1:10,000 and left to fertilize for 1 hour. The fertilized embryos were gently rinsed to remove as much sperm as possible and were left to develop in a 26° C. environment. Daily cleaning with filtered seawater maintained the larvae in good health.

### Mesh Vitrification of Coral Larvae

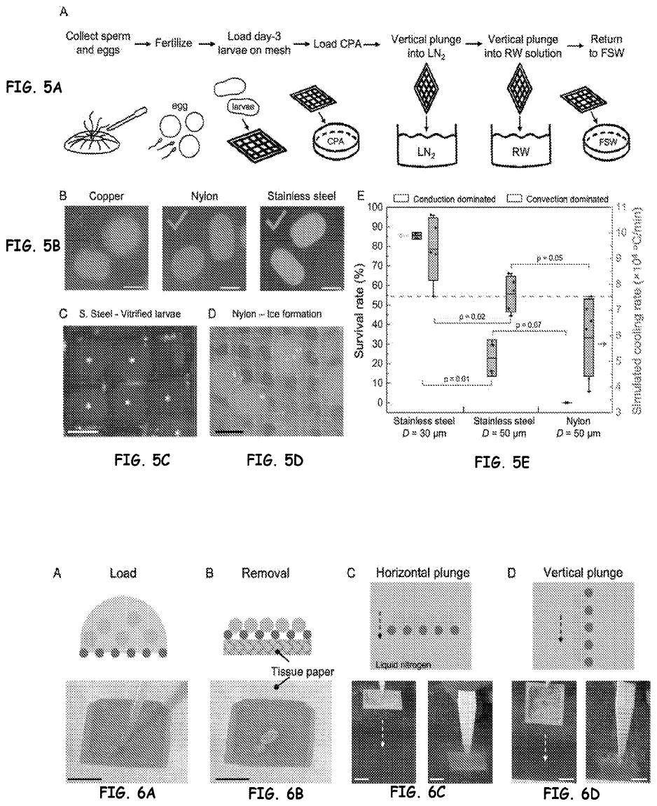

One of the CondD-Cs tested was a copper mesh. We noted that copper shows toxicity in marine organisms by affecting their metabolic processes [38]. Thus, before vitrification, we tested the toxicity of the mesh to coral larvae (FIG. 5B). We used an Olympus SZX10 stereo microscope and Science Supply S01-0801A camera to visualize the coral larvae morphology, which can be used to determine toxicity (i.e., swimming or not) [23]. For this investigation, the coral larvae were placed on the copper mesh for less than 2 min, directly immersed in seawater, and then removed for assessment. After exposure to the copper mesh, the outer edge of the larvae appeared dissolved, with a poorly defined border (FIG. 4B). The larvae showed no survival following exposure to the copper mesh. The nylon and stainless steel mesh did not demonstrate any toxicity under similar conditions.

Mesh cooling and warming were used to cryopreserve and return larvae of the Hawaiian solitary mushroom coral Lobactis scutaria to physiological conditions. The vitrification solution was that used successfully in a previous study that cryopreserved larvae of the same species by vitrification and laser warming (Daly et al., 2018): 10% v/v propylene glycol+5% v/v dimethyl sulfoxide+1 M trehalose prepared in phosphate buffered saline (vitrification solution, VS); 0.5 M trehalose prepared in filtered seawater (rehydration solution, RH). Preliminary trials were performed with nylon mesh with D=50 μm Φ=0.5, stainless steel mesh with D=50 μm Φ=0.33, and stainless steel mesh with D=30 μm Φ=0.5 (2 technical replicates of each mesh type) on larvae between 3 and 4 days of development. Larvae were moved on CondD-C into VS for a 2-minute exposure, followed immediately by wicking Oof excess VS and vertical plunging into liquid nitrogen. Larvae were rewarmed by vertical plunging into RW, left in RW for two minutes, returned to filtered seawater to recover, and evaluated by eye for percent survival at 2 h post-thaw. For the preliminary mesh trials, 50-200 larvae were placed on each mesh while the mesh was immersed in 0.22-μm-filtered seawater (FSW). The water level was such that the swimming larvae could not leave the mesh frame. The mesh was removed from the seawater and gently dabbed from underneath with a Kimwipe and a Q-tip cotton swab to remove residual FSW. The mesh was immediately transferred into a 35-mL dish containing vitrification solution (VS: 10% v/v PG, 5% v/v DMSO, and 1 M trehalose in phosphate-buffered saline) and left for 2 min. The mesh was removed from VS, dabbed again with a Kimwipe and a Q-tip cotton swab, and immediately plunged vertically into liquid nitrogen.

### Warming of Coral Larvae and Survival Assessments

Cooled forceps were used to retrieve the mesh from the liquid nitrogen bath. The mesh was briefly (<1 s) shaken to remove residual liquid nitrogen and immediately plunged into a rehydration solution of 0.5 M trehalose in FSW and left for 2 minutes. The mesh was removed from the rehydration solution, dabbed from underneath with a Kimwipe and a Q-tip cotton swab, and transferred to FSW for larval recovery. Percent survival was assessed by eye at 2 h post-thaw. Survival was calculated as the number of larvae that demonstrated active swimming divided by the total number of larvae present in the field of view.

Cryoprotective Agents Used for Biosystems Vitrified in this Study

Critical cooling rate (CCR) and critical rewarming rate (CWR) are calculated based on reference [10].

TABLE 2
Cryoprotective agents used for model organismal
biosystems vitrified in this study.

| | | Critical | Critical |
|---|---|---|---|
| | | cooling | rewarming |
| | | rate | rate |
| | | (CCR) | (CWR) |
| Biosystem | CPA | (° C./min) | (° C./min) |
| Coral | 10% PG + 5% DMSO + 34% | 1.3 × 10³ | 3.5 × 10⁵ |
| larvae | (1M) trehalose | | |
| Drosophila | 27% EG + 9% sorbitol | 1.9 × 10³ | 6.8 × 10⁵ |
| embryo | | | |
| Zebrafish | Yolk: 14% (1.8M) PG + 1.1% | 3.9 × 10⁵ | 2.9 × 10⁸ |
| | (0.7M) MeOH | | |
| embryo | Outside: 21% (2.7M) PG + 4% | 2.0 × 10³ | 6.9 × 10⁵ |
| | (1.2M) | | |
| | MeOH + 17.1% (0.5M) | | |
| | Trehalose | | |

### Statistics

Experimental data were presented with mean values unless specified. For plots with two dependent variables, one-way ANOVA (analysis of variance) and the Tukey test were used for statistical analysis using OriginLab. P-values<0.05 were considered statistically significant.

Comparison of representative methods for cryopreservation of submillimeter biosystems

TABLE 3
Comparison of representative methods for cryopreservation of submillimeter biosystems.

| | | Cooling | | | | |
|---|---|---|---|---|---|---|
| | | rate | | | | |
| Methods | Biosystem type | (° C./min) | CPA | Throughput | | Ref |
| Slow | Stem cell | 1 | 10% DMSO | 1 | mL solution | [16] |
| freezing | T-cell | 1-10 | CryoStor10 | 1 | mL solution | [17] |
| | Oocytes/embryos | 0.3-50 | 1.5M | 0.5 | mL solution | [14] |
| Cryotop | Human embryos | 2.3 × 10⁴ | VT601 | 0.1 | μL droplet | [33] |
| Straw | Sperm | 180 | R18S3 | 10 | μL/straw | [39] |
| Droplet | Fibroblast/myoblast | 2.2 × 10⁶ | CPA free | 4.8 | μL/min | [31] |
| | cells | | | | | |
| vitrification | Fibroblast cells | 1.1 ×10³ | 1.4M DMSO | N/A | | [32] |
| | Blood stem cells | 1.75 × 10⁴ | 2 MPG + 1M | 0.6 | mL/min | [24] |
| | | | trehalose | | | |

| | | | | | |
|---|---|---|---|---|---|
| Cryomesh | Islets | 5.4 × 10⁴ | 22% EG + 22% | 4250/cm² | [5] |
| | | | DMSO | | |
| | Drosophila embryo | 5 × 10⁴ | 39% EG + 9% | 400/cm² | [4] |
| | | | sorbitol | | |

### Droplet Cooling Rates

We quantified the cooling rates of direct-printing of droplets in LN2, convection-dominated cryomesh (ConvD-C), and conduction-dominated cryomesh (CondD-C). A 1-μL CPA droplet was pipetted on the mesh and plunged into LN2. The CPA concentration used was 14 wt % EG+14 wt % DMSO+RPMI (Roswell Park Memorial Institute 1640 Medium). CondD-C shows the highest cooling rate at 2.4×10⁴° C./min, which is 144% higher than the convection-dominated cryomesh. The convection droplet shows the lowest cooling rate, which is 13% of the conduction-dominated cryomesh. Note, the cooling rate of the convection droplet is calculated based on the levitation time of the CPA droplet (the time the vapor barrier kept the droplet suspended in LN2), as the cooling rate cannot be directly measured by thermocouples for this case. With the convective mesh and vertical plunge, the heat transfer behavior of the biosystem on the cryomesh is similar to the pure conduction heat transfer of a droplet printed directly on a pre-cooled plate.

### Transient Heat Conduction During Cooling

During cryomesh cooling in the LN₂, there are two processes of heat release. 1) Convection heat transfer, which releases the heat of the mesh to liquid nitrogen. 2) Conduction heat transfer inside the mesh and biosystem. We further studied the heat release of conduction-dominated cryomesh in liquid nitrogen with a 1D transient heat transfer model (analytical representation of FIG. 2A). Thus, the traditional governing heat transfer equation is

$$\frac{\partial T}{\partial t} = α \frac{{\partial }^{2} T}{\partial {x}^{2}} \qquad ( 1 )$$

with boundary condition

$$\frac{\partial T ( 0 , t )}{\partial t} = 0 \qquad ( 2 )$$

$$- k \frac{\partial T ( {L}_{s} , t )}{\partial x} = h [ T ( {L}_{s} , t ) - {T}_{∞} ] \qquad ( 3 )$$

and initial condition

$$T ( x , 0 ) = {T}_{i} = 0 \sim 20 ° C . , {T}_{∞} = 196 ° C . \qquad ( 4 )$$

where, T is the temperature, t is the time, a is the thermal diffusivity, k is the thermal conductivity, Lₛ=D+t_{b}, which is the total thickness of the mesh and biosystem, and h is the convection heat transfer coefficient. Note we assume the convection heat transfer is low on the other side of the biosystem, and is initially neglected in this analysis (but factored into the analysis in Equations (18) and (19)). Based on the transient heat transfer equation (1), we further simplified the heat transfer model to calculate the heat release time. The heat release time is defined here as the time for the whole system (mesh with biosystem) to cool down to the desired temperature (e.g., LN₂ temperature). We divided the total heat release time (tₜₒₜₐₗ) into three parts:

$${t}_{total} = {t}_{c} + {t}_{m} + {t}_{b} \qquad ( 5 )$$

where t_{c} is the heat release time from mesh to LN₂ through convection heat transfer, tₘ is the heat release time for conduction through the mesh, and to is the heat release time for conduction through the biosystem. We calculated the heat release times similar to calculating a time constant (τ) [40], which is

$$τ = \frac{ρ {C}_{p} V}{h A} \qquad ( 6 )$$

where ρ is the density, cₚ is specific heat, and V is the body volume. Then, we assumed that all heat from the system (mesh with biosystem) is released from the mesh to LN₂ through convection heat transfer. We calculated t_{c} as

$${t}_{c} = \frac{{Q}_{m} + {Q}_{b}}{h {A}_{m}} \qquad ( 7 )$$

where h is the convection heat transfer coefficient with a range from 250-2500 W/m²/K [41]. The heat of mesh Qₘ is

$${Q}_{m} = {ρ}_{m} {C}_{p , m} {V}_{m} \qquad ( 8 )$$

$${V}_{m} = 4 {π ( \frac{D}{2} )}^{2} {L}_{u} \qquad ( 9 )$$

where D is the mesh wire diameter and Lᵤ is the unit length (FIG. 2A). The heat of biosystem Q_{b} is

$${Q}_{b} = {ρ}_{b} {C}_{p , b} {V}_{b} \qquad ( 10 )$$

$${V}_{b} = {L}_{s} \cdot {L}_{u}^{2} \qquad ( 11 )$$

where Lₛ is the thickness of biosystem (FIG. 2A). Aₘ is the contact area between mesh and liquid nitrogen calculated as

$${A}_{m} = ( 4 π D {L}_{u} - 4 π {D}^{2} ) / 2 \qquad ( 12 )$$

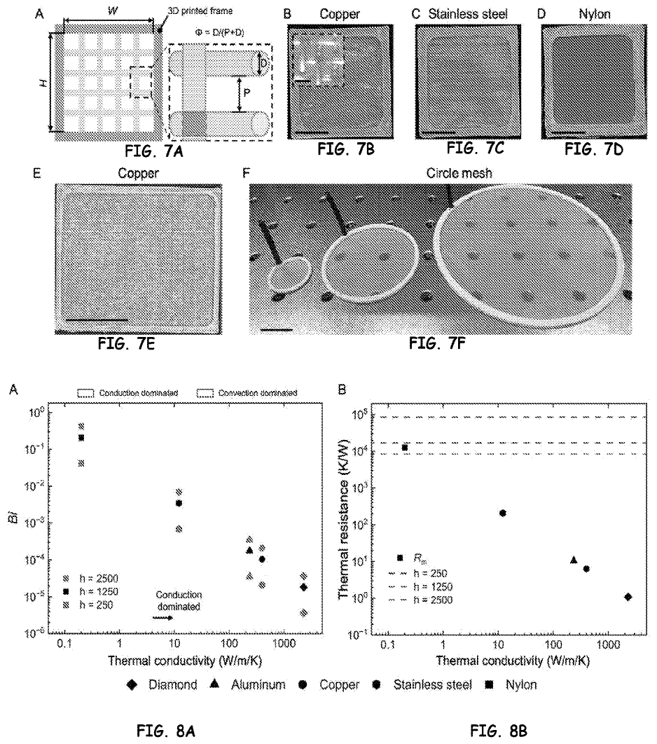

The contact area considers the half surface area of the entire mesh and excludes the intersection area between each wire (shadowed area, FIG. 7A). Next, we calculated tₘ as

$${t}_{m} = \frac{{Q}_{m} \cdot D}{{k}_{m} {A}_{c m}} \qquad ( 13 )$$

where kₘ is the thermal conductivity of the mesh and the cross-section area of mesh

$${A}_{c m} = ∅ \cdot {L}_{u}^{2} \qquad ( 14 )$$

where Φ is the solid fraction. The t_{b} is then calculated as

$${t}_{b} = \frac{{Q}_{b} \cdot {L}_{s}}{{k}_{b} {A}_{b}} \qquad ( 15 )$$

where kₘ is the thermal conductivity of the mesh and A_{b} is the cross-section area as Lᵤ². Then the cooling rate is calculated as

$$C R = \frac{Δ T}{{t}_{total}} \cdot 60 ( ° C . / min ) \qquad ( 16 )$$

where ΔT is the temperature zone from −20° C. to −140° C., which is generally the most relevant zone for cooling and rewarming in vitrification [24]. To further simplify the mesh definition, we could use critical length (L_{C}) to compare different mesh geometries. Based on Equations 9 and 12, we calculated the critical length as:

$${L}_{C} = \frac{{V}_{m}}{{A}_{m}} \qquad ( 17 )$$

Table 4 shows the L_{C} of different mesh filament diameters and solid fractions used in this study.
To further consider the convection effect for the biosystem exposed directly to LN₂ (the side away from mesh), we assumed the h was the same as on the mesh side. Note the experimental h for the biosystem might be lower than the assumption due to the nitrogen vapor layer. Thus, we can assume the time for heat release time t_{b,c} of biosystem through convection is

$${t}_{b , c} = \frac{{Q}_{b , c} \cdot {L}_{s , c}}{{k}_{b} {A}_{b}} + \frac{{Q}_{b , c}}{h {A}_{b}} \qquad ( 18 )$$

where Q_{b,c} is the total heat of biosystem released by convection and L_{s,c} is the length of biosystem affected by convection heat transfer. By assuming tₜₒₜₐₗ=t_{b,c}, we calculated the total biosystem thickness, which is

$${L}_{t} = {L}_{s} + {L}_{s , c} \qquad ( 19 )$$

For the known biosystem thickness, e.g., the thickness of coral larvae was around 100 μm, we assigned Lt as the biosystem thickness of 100 μm. Then we combined Equations 5 and 18 to solve the cooling rate, where tₜₒₜₐₗ=t_{b,c}. Since both models considered heat transfer through the mesh, the model considering convection of biosystem will be used for the validation of different biosystem cooling rates but will not change the conclusion only based on Equations 5.

TABLE 4
Critical length (L_{C}) of different mesh
filament diameters and solid fractions.

| Mesh | Pore | | | |
|---|---|---|---|---|
| size | size | Solid | Critical | |
| (μm) | (μm) | fraction | length (μm) | Materials |
| 30 | 38 | 0.44 | 19 | Copper/Stainless steel |
| 50 | 50 | 0.5 | 33 | Copper/Stainless steel/Nylon |
| 50 | 100 | 0.33 | 30 | Copper/Stainless steel/Nylon |
| 100 | 200 | 0.33 | 67 | Nylon |

### Results

### Conduction-Dominated Cryomesh

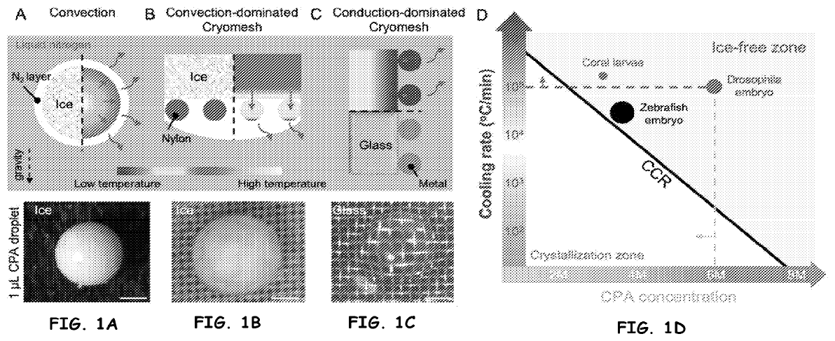

To compare the relative performance of several vitrification techniques used on submillimeter scale systems, we compared droplet cooling through direct immersion in liquid nitrogen (LN₂) [27], direct printing onto a LN₂ pre-chilled surface [24], prior work with a nylon cryomesh [4], and our new conduction-dominated cryomesh approach (FIG. 1A). It should also be noted that the cryotop is another method commonly used for submillimeter-scale vitrification. Rates achieved with the cryotop are typically on the order of 2.3×10⁴° C./min for a 0.1 μL droplet [33], which is much lower than evaluated here. This is due to the added thermal mass of the cryotop itself (a relatively large plastic substrate), so it was not included in this comparison.

For the case of direct droplet immersion in liquid nitrogen, due to the Leidenfrost effect, a vapor layer is present between the droplet and the LN₂. This vapor layer reduces the heat transfer coefficient due to the high thermal resistance of vapor. As a result, the convection droplet case has a lower cooling rate and demonstrates ice formation in the droplet test case (bottom, FIG. 1A). The cryomesh can reach a higher cooling rate by removing excess CPA around the biosystem (i.e., thermal mass reduction) through the mesh pores. This approach has been previously established for use with a nylon mesh, but as we show here, the design of the cryomesh and cooling step is critical for achieving the most rapid rates of cooling and enabling the ability to scale to larger mesh sizes. To demonstrate this, we first pipetted a 1 μL CPA droplet on the nylon mesh to simulate an isolated biosystem (FIG. 1B) and as a base of comparison to the droplet methods. Note, the CPA used to show the difference between those methods has a concentration of 14 wt % EG+14 wt % DMSO+RPMI (Roswell Park Memorial Institute 1640 Medium), which has been used previously in convective cryomesh experiments [5]. The mesh and droplet are plunged into the LN₂ horizontally (FIG. 6). During plunging, the biosystem can be cooled through two mechanisms. Direct convective cooling from the LN₂, which is again limited due to the Leidenfrost effect and through conduction cooling from the cryomesh. Heat from the biosystem will be transferred through the mesh when the mesh has a lower temperature than the biosystem. However, due to the low thermal conductivity of the nylon mesh and vapor barrier caused by nitrogen bubbles, the mesh cannot reach LN₂ temperature any faster than direct convective cooling of the biosystem. Thus, the mesh has a substantial temperature gradient, which limits the cooling rate of the biosystem. The entire system is dominated by the convection heat transfer condition (“convection-dominated cryomesh”~ConvD-C).

Thus, ice still forms due to the lower cooling rate on the convection-dominated cryomesh (bottom, FIG. 1B). To prevent ice formation and achieve vitrification, a higher cooling rate is desired. By modifying the method of plunge cooling to allow the release of the vapor barrier from the mesh and optimizing the heat transfer within the cryomesh, cooling of the biosystem is dominated by the conduction of heat through the cryomesh (FIG. 1C). When plunging the mesh loaded with a CPA droplet into LN₂, the conductive mesh rapidly reaches LN₂ temperature at −196° C. (<0.01 s) and maintains this throughout the cooling process. Then, the heat of the biosystem can be released from the mesh to LN₂ where the mesh essentially acts as a pre-cooled substrate as in droplet printing methods [24, 31]. Thus, the cryomesh can reach a high cooling rate showing vitrified droplets (bottom, FIG. 1C). By using modified plunging methods and enhancing heat transfer in the mesh design, the cryomesh shows conduction-dominated heat transfer performance (CondD-C).

The cryomesh tested in this work is fabricated with a 3D-printed PLA frame to support the mesh material (FIG. 1D, 1E, and FIG. 7). We used width (W) and length (L) to define the geometry of the frame. If not specified, the frame to hold the mesh used in this study is W=2 cm and L=2 cm. We defined the mesh with the solid fraction (Φ) and wire diameter (D) with the unit of μm, where Φ=D/(P+D) and P is the pore size of the mesh. One of the main conduction-dominated cryomeshes used in this study is the copper mesh (Φ=0.5, D=50 μm) with a frame size of 2×2 cm (FIG. 7B). In this study, we also tested different materials of the mesh such as stainless steel and nylon (FIG. 7). If not specified, the solid fraction is fixed as 0.5. To further simplify the mesh definition, we also used critical length (L_{c}) to compare different mesh geometries (Table 4), which is a fundamental parameter often used for analysis in heat transfer (see detailed calculation in methods). Note that we chose to study wire diameter here due to the round mesh filaments chosen. However, these results can also be thought of in terms of a representative characteristic length (e.g., volume divided by area), which can be more generally applied across different mesh filaments.

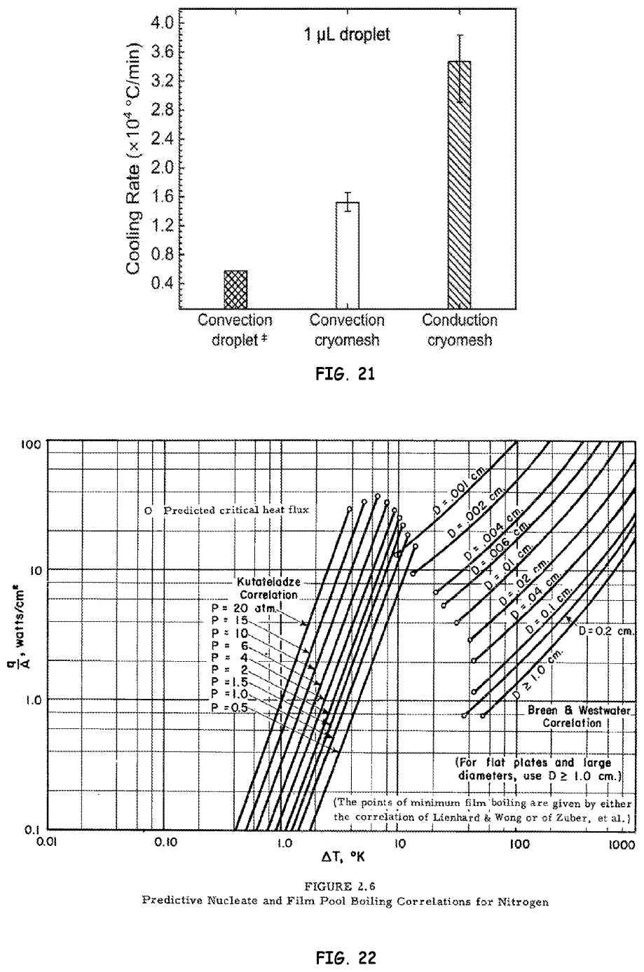

We quantified the cooling rate for the direct-immersion droplet in LN₂, convection-dominated cryomesh (ConvD-C), and conduction-dominated cryomesh (CondD-C) compared with direct-printing droplets on a pre-cooled plate (FIG. 21). A 1 μL CPA droplet is pipetted on the mesh and then plunged into LN₂. The CPA concentration used was 14 wt % EG+14 wt % DMSO+RPMI (Roswell Park Memorial Institute 1640 Medium). CondD-C shows the highest cooling rate at 2.4×10⁴° C./min, which is 144% higher than the convection-dominated cryomesh. The convection droplet shows the lowest cooling rate, which is 13% of the conduction-dominated cryomesh. Note, the cooling rate of the convection droplet is calculated based on the levitation time (time the vapor barrier kept the droplet suspended in LN₂) of the CPA droplet as the cooling rate cannot be directly measured by thermocouples for this case. Meanwhile, the direct printing droplet shows a similar cooling rate as the conduction-dominated cryomesh, which shows the conductive mesh contributing to the cooling and heat release of the biosystem. With the conductive mesh and vertical plunge, the heat transfer behavior of the biosystem on the cryomesh is similar to the pure conduction heat transfer of a droplet printed directly on a pre-cooled plate.

With a high cooling rate achieved by the conduction-dominated cryomesh, there are opportunities to apply the cryomesh to different biosystems. A higher cooling rate is required to achieve ice-free glass (i.e., vitrification) during cryopreservation for a lower concentration of CPA (blue zone, FIG. 1G). To achieve this, we optimized the cryomesh with mesh wire diameter D and mesh thermal diffusivity a (mm/s) based on the critical cooling rate (CCR), which will be elaborated in the following sections. The cooling rate is increased by reducing D and increasing a (i.e., copper mesh). Thus, the CPA concentration can be reduced such that the cooling rate provided by the conduction dominated cryomesh remains above the CCR (black line, FIG. 1G). Note, the CCR is the smallest cooling rate required to vitrify any volume of the CPA (or CPA loaded biosystem) at the CPA concentration chosen. Based on the design of CondD-C, we successfully cryopreserved several model biosystems with different CPA concentrations down to 3.5 M. Increased cooling rates enable the use of lower CPA concentrations, lowering the associated toxicity and potentially increasing viability of cryopreserved biosystems and facilitating the cryopreservation of biosystems which have not yet been preserved due to susceptibility to CPA.

### Establishing Conditions to Achieve Conduction-Dominated Cryomesh

During cooling, there are two processes of heat release. 1) Conduction heat transfer inside the mesh and biosystem and 2) convective heat transfer, which releases heat from the mesh to LN₂. Since we are attempting to describe the conditions in which heat release from the biosystem is dominated by conduction to the mesh, for the purposes of this exercise, heat release directly from the biosystem to LN₂ is neglected. To describe the relative contributions to heat transfer, we analyzed a simplified thermal resistance model, which can be used to describe transient heat transfer in a model system. This model describes the heat flux (q″) during cooling, which will have a linear relation with the heat loss rate and thus cooling rate. We described these conditions through a simple 1D thermal resistance model (FIG. 2A), which is

$${q}^{′′} = \frac{Δ T}{{R}_{h} + {R}_{m} + {R}_{b}} = \frac{{T}_{i} - {T}_{∞}}{{R}_{h} + {R}_{m} + {R}_{b}} \qquad ( 20 )$$

where ΔT is the temperature difference between the initial temperature of biosystem and cryogen (e.g. LN₂), Rₕ is the external resistance of convection between mesh LN₂, Rₘ is the internal conduction thermal resistance of mesh and R_{b} is the conduction thermal resistance of biosystem. Then, we simplified those three thermal resistances as:

$${R}_{h} = \frac{1}{h {A}_{m}} \qquad ( 21 )$$

$${R}_{m} = \frac{D}{{k}_{m} {A}_{c m}} \qquad ( 22 )$$

$${R}_{b} = \frac{{t}_{b}}{{k}_{b} {A}_{b}} \qquad ( 23 )$$

where h is the convection heat transfer coefficient between the LN₂ and cryomesh, Aₘ is the contact area between LN₂ and cryomesh, A_{cm} is the cross-section area of mesh, D is the wire diameter of the mesh, kₘ is the thermal conductivity of the mesh, k_{b} is the thermal conductivity of the biosystem, t_{d} is the thickness of the biosystem, and A_{b} is the cross-section area of biosystem. Based on the equations (eq 20-23), a small thermal resistance contributes to a high heat flux, which then equates to a higher cooling rate. Thus, there are three key parameters to achieve a higher heat loss by reducing the thermal resistances: 1) increasing the thermal conductivity of the mesh, 2) increasing the convection heat transfer coefficient with the cryomesh, and 3) reducing the mesh wire diameter. The thermal resistance of mesh Rₘ decreases with an increase in kₘ (FIG. 2B). Assuming the convective coefficient and biosystem thickness to are fixed (determined by LN₂ plunge and biosystem), increasing the thermal conductivity of the cryomesh is the first step to achieving a high cooling rate. To achieve conduction-dominated heat transfer, Rₘ should be smaller than Rn to ensure an effectively uniform temperature distribution throughout the mesh. Thus, the mesh has effectively the same temperature as liquid nitrogen throughout and can conductively cool the biosystem. Meanwhile, Rₘ should also be smaller than R_{b}, otherwise, the mesh cannot transfer the heat of the biosystem and release it into the LN₂. To simplify this analysis, we used the Biot number (Bi) to identify conditions for determining CondD-C behavior. In heat transfer, the Bi is a traditional metric used to describe the relative relationship between convection and conduction heat transfer, which is calculated as

$$B i = \frac{h {L}_{c}}{{k}_{m}} \qquad ( 24 )$$

where Lc=V/Aₘ, which is the characteristic length scale of the conducting body with V equal to the volume of the mesh. The Bi number decreases with an increase of kₘ, following the same trend of Rₘ (FIG. 2B). The Bi number also increases with h, which subsequently produces a nonuniform temperature (FIG. 8) across the conducting body if its thermal conductivity is not high enough. However, a high h is also required to achieve high cooling rates, thus, a high thermal conductivity is required to maintain a uniform temperature of the mesh and conduction dominated heat transfer (FIG. 8A). Otherwise, the large thermal resistance of mesh conduction slows down the heat release (i.e., nylon mesh with high Rₘ). In contrast, a smaller Bi number (<1) implies that conductive effects are greater than convective effects. Note, when decreasing the h, Bi is decreased with the Rₕ increase (FIG. 8). Thus, a higher h, such as 2500 W/m²/K is desired (e.g., cooling in liquid nitrogen without a vapor barrier due to bubble removal) [41]. Therefore, to achieve conduction-dominated cryomesh behavior during cooling (Blue area, FIG. 2B), we have defined that thermal conductivity of greater than ~10 W/m/K is the minimum requirement, to achieve Bi<0.01 (conduction heat transfer dominates convection), assuming highly convective bath (i.e. challenge) conditions of 2500 W/m²/K and mesh filament diameter of D=50 μm (see further discussion on filament diameter below). Thus, for better performance with varied h from 250-2500 W/m²/K, the mesh thermal conductivity is recommended to be greater than 10 W/m/K with D<50 μm achieving Bi<0.01.

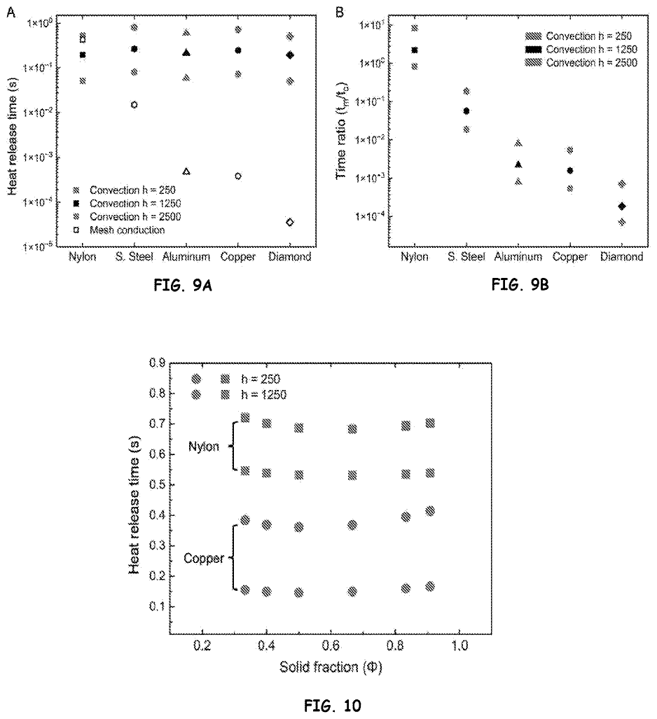

To further emphasize the advantages of conduction-dominated cryomesh we calculated the heat release time based on several representative materials with a range of thermal conductivities such as diamond, aluminum, copper, stainless steel, and nylon (FIG. 9). The heat release time t has an inverse correlation with the cooling rate (CR), i.e., t~ΔT/CR. The increased thermal conductivity reduces the heat release time of the mesh as expected. Diamond has the highest thermal conductivity at 2300 W/m/k with the lowest Bi number of 1.8×10⁻⁵ and a heat release time of 3.5×10⁵ s, which is 0.008% of the nylon mesh. Meanwhile, more practically accessible materials such as copper and stainless steel have heat release times at 0.089% and 3.5% of nylon mesh, respectively. To emphasize practical use, we focus on copper and stainless steel in further cryomesh demonstrations. Aluminum is another promising candidate material which is expected to offer better thermal performance than copper. Diamond may be used when the most rapid cooling rates are required. The convection heat release time is mainly determined by the biosystem (FIG. 9A). As the conductivity of the biosystem is much smaller than the mesh (assumed to be 1.6 W/m/K, representative of typical vitrified materials [24]), we assumed the heat of the biosystem has no effect on tₘ. The mesh can essentially transfer the heat immediately into liquid nitrogen from the biosystem through the mesh. Thus, the faster the mesh reaches the LN₂ temperature (e.g., tₘ of copper<1×10⁻³ s), the sooner the biosystem is cooled, which is achieved by a higher thermal conductivity (e.g., kₘ=400 W/m/K for copper). Meanwhile, the ratio between mesh conduction (tₘ) and convection (t_{c}) follows the trend of the Bi number with thermal conductivity, which enables us to use Bi to guide the mesh design (FIG. 9B). By increasing the thermal conductivity, the cooling rates are fast enough to achieve a “conduction-dominated” cryomesh (i.e., Bi<0.01).

### Model Prediction of Optimized Mesh Design for Increased Cooling Rates

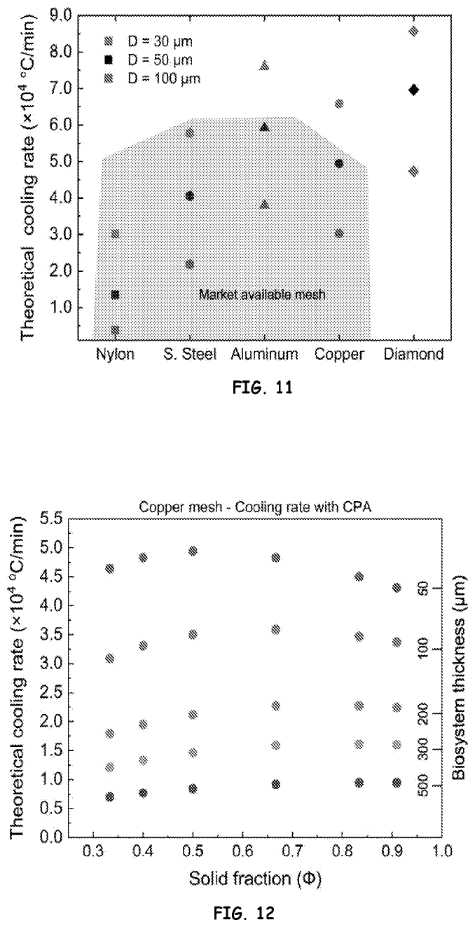

Besides increasing the convection heat transfer coefficient, the cooling rate can be further enhanced by (1) reducing the thermal resistance of the mesh, Rₘ, and (2) reducing the thermal resistance of the biosystem, R_{b}, based on the mesh geometry. Based on the optimization of mesh material and geometry, the mesh heat release time (and thus cooling rate) can be further improved through optimization of the solid fraction Φ and wire diameter D (i.e., mesh characteristic length). We first studied the effect of solid fraction (FIG. 10). The heat release time shows the lowest values occurs in the range of Φ=0.5-0.66 (FIG. 10). While there is an optimal point in this range, the difference within the range is less than 10% and so values within this range can be used for practical optimization. Further, solids fractions in the range from 0.3 to 0.9 can be considered for many applications, where the impact of filament size, pore size, contact area, etc. may have dominant effects over solid fraction. The exact optimum depends on biosystem size and could be optimized for specific applications, if desired. We further investigated the effect of mesh wire diameter on heat release time and cooling rate (FIGS. 2C and 9), understanding that this is a simple way to investigate the effects of the mesh surface area relative to mesh volume (i.e., thermal mass). This analysis can also be thought of analogous to a representative thermal length scale of the mesh (i.e., Lc=V/Aₘ). For this case, the biosystem thickness is assumed to be 100 μm with h of 1250 W/m²/K [42]. Here we show that the heat release time decreases with the decrease in the wire diameter. We experimentally studied this for several commercially available mesh geometries. We found mesh available with a wire diameter of 50 μm for both copper and stainless steel. The copper mesh has a lower heat release time than the stainless-steel mesh due to the higher thermal diffusivity of copper. Additionally, we found a stainless-steel mesh with wire diameter of 30 μm (the finest commercially available mesh initially identified) which had a smaller heat release time (0.18 s) than the 50 μm copper mesh (0.21 s) (FIG. 2C). A smaller wire diameter contributes to a smaller thermal mass of the mesh itself. Meanwhile, the surface contact area of D=30 μm mesh is 2.8× times as large as a mesh with D=50 μm (assuming solid fraction is held constant (0.5)). The increased contact area contributes to greater heat transfer from the biosystem by increasing the area of heat release. Thus, to further enhance the cooling rate, a smaller wire diameter is desired with an increased contact area between the mesh and biosystem. However, note that the nylon mesh is still in a convection-dominated cooling process even at small filament diameters (i.e., will experience a substantial temperature difference across the mesh thickness). Even though a small wire diameter can decrease the heat release time, the slower rate of heat transfer through mesh mitigates the benefits of reduced wire diameter on thermal mass for mesh with low thermal conductivity (e.g., nylon). Thus, the reduction of mesh wire diameter and increased contact area leads to greater enhancement to cooling for the conduction-dominated cryomesh. This trend will continue until reaching a small pore size (<5 μm) and small wire diameter (<20 μm). The pinning force of CPA transferring through pores increases with the decrease of mesh pore size and increase of liquid surface tension, which reduces proper wicking of the CPA [43, 44]. Thus, small pore size nullifies the ability to wick away liquid thermal mass from the biosystem, which reduces the cooling and rewarming rate [4]. Meanwhile, the wire tensile strength reduces with the reduction of wire diameter leading to easy breakage of the wire [45]. Out of the commercially available meshes, we chose to evaluate a stainless-steel mesh with D=30 μm for further testing on the ability to vitrify a variety of biosystems (FIG. 11). With the same dimension of mesh (i.e., same wire diameter), high thermal conductivity contributes to a high cooling rate. Biosystem thickness also affects the heat release time it experiences during the cooling (FIG. 2D, and FIG. 12). The increased thickness increases the total thermal mass and time required to conduct the heat across the biosystem and so shows a larger heat release time for the system. The nylon mesh shows a larger heat release time with a 50 μm thickness biosystem, which is 2.6× and 2.0× higher than copper and stainless-steel mesh, respectively. The heat release time of a thicker biosystem shows less variation with mesh size than a smaller biosystem (i.e., 50 μm), where the heat transfer inside the larger biosystem has a greater impact on the heat release time. Thus, CondD-C is desired to achieve a high cooling rate for a wide range of thicknesses of biosystems. As predicted by the model, diamond, with the highest thermal conductivity and lowest Bi number, provides the fastest heat release times. For a biosystem with a thickness of 50 μm, diamond has the smallest heat release time of 0.1 s, which is 70% of that of copper. Compare this to stainless steel, which has a 21% longer heat release time than the copper mesh. However, with increased biosystem thickness, the difference of heat release time between copper and stainless steel is reduced to only 3% for a biosystem of 500 μm thickness. The low thermal conductivity and high thermal mass of the biosystem lead to high heat transfer time inside the biosystem. The diamond mesh still has a 50% shorter heat release time than copper mesh (FIG. 2D). Thus, the higher kₘ will be most important for the thick biosystem. For biosystem thickness less than 100 μm, a kₘ=12 W/m/K>10 W/m/K (i.e., stainless steel) is enough to achieve the CondD-C. This is the most stringent requirement and so is equally applied to larger biosystems (thickness>300 μm). As a general design range to push forward the cooling rate, CondD-C should have a Bi<0.01, which has detailed parameters of kₘ≥10 W/m/K, D≤50 μm, and 0.65>Φ>0.5. Thus, with the consideration of easy access and costs, copper and stainless steel (with appropriate choices in mesh design) are practical means to achieve conduction-dominated cryomesh behavior, but materials such as aluminum or diamond could be used to achieve theoretically optimal cooling behavior. The combination of more than one type of metal, such as copper with gold coating or CVD diamond coating, could allow for achieving higher rates than copper or stainless steel alone due to the increased contact area and reduced thermal resistance [46].

### Experimental Validation of Cooling Rate on Conduction-Dominated Cryomesh

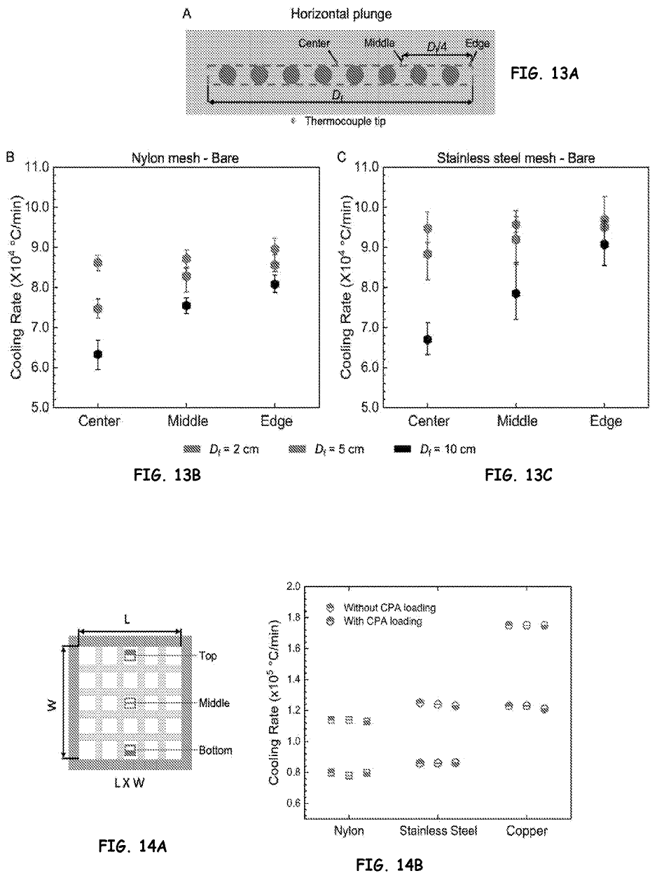

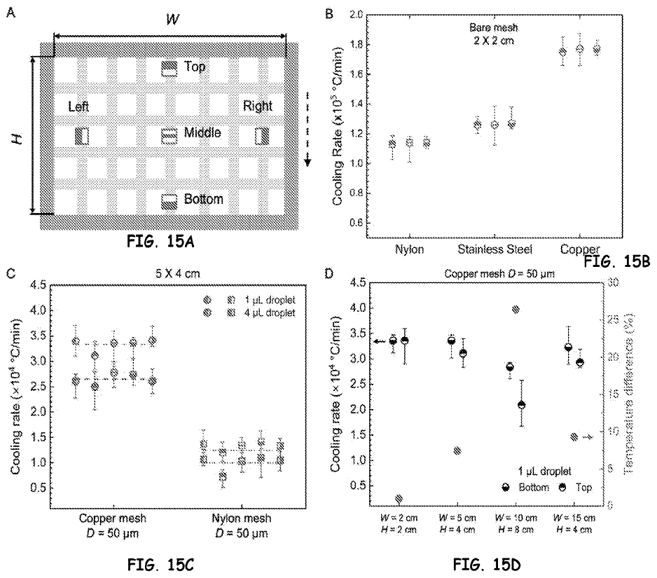

We next directly measured the cooling rate of conduction-dominated cryomesh based on varying the materials and wire diameters. We identified that this first required an evaluation of the impact of the plunge methods (FIG. 3A-D). When a warm substrate is submersed into LN₂, a rapid phase change in the LN₂ occurs and creates a vapor layer around the substrate, which is the “Leidenfrost effect”. If the substrate is plunged into LN₂ with a horizontal orientation, the nitrogen vapor is easily trapped underneath the mesh forming a thick insulating layer (FIGS. 3A and 3B). This vapor layer has lower thermal conductivity and higher temperature than the LN₂. This effectively reduces the convection heat transfer coefficient between the mesh and liquid nitrogen. Thus, the cooling rate is reduced. A larger mesh generates more gaseous nitrogen bubbles due to high thermal mass and a larger area for the gases to be trapped, showing a thicker gas layer than smaller meshes, especially at the center of the mesh (FIG. 13). Therefore, methods are required to reduce or eliminate this vapor barrier to achieve the fastest possible cooling rates, especially in the case of cryomesh scale-up.

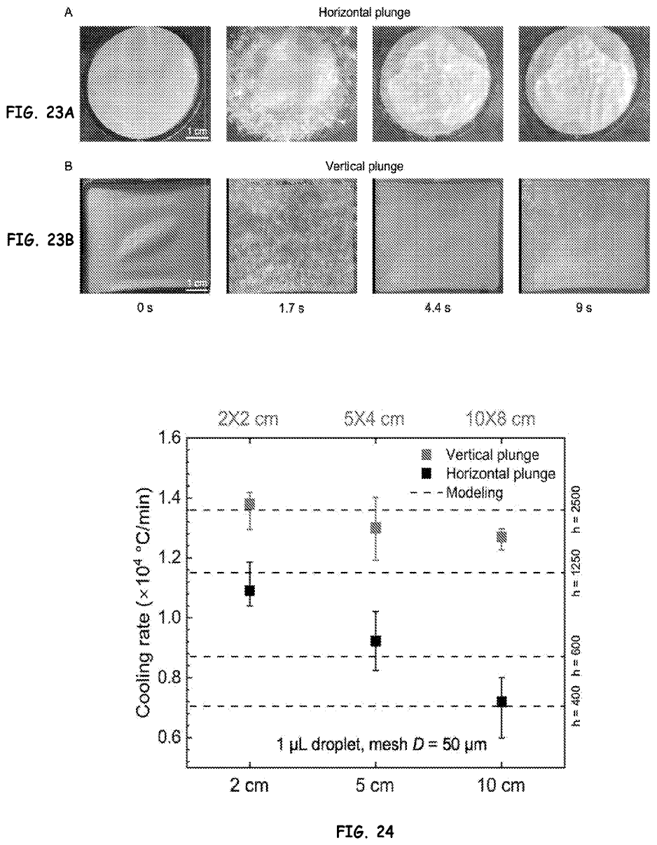

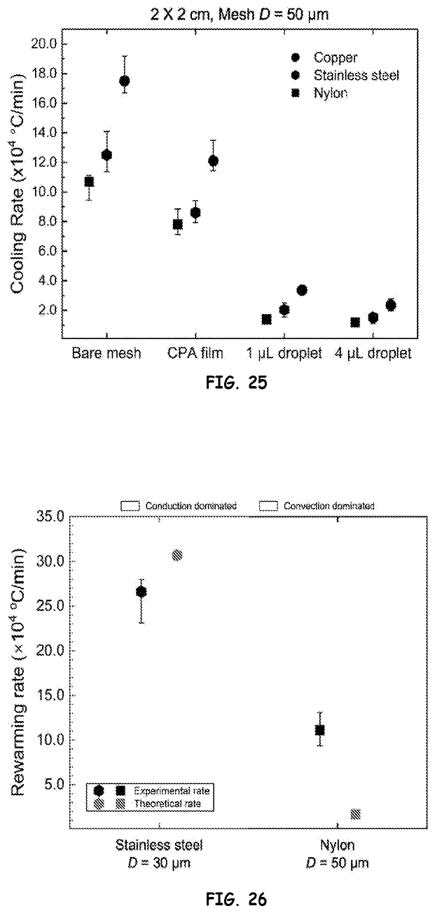

One simple and effective method for reducing Leidenfrost on the cryomesh is to increase h by a vertical plunge. Vertical plunging allows nitrogen bubbles to rapidly form and release from the mesh, greatly reducing the vapor barrier around the mesh (FIGS. 3C and 3D). In theory this can also be similarly accomplished by agitating flow of the LN₂ or mechanical motion of the cryomesh and modifying the mesh surface that facilitate boiling LN₂ vapor release. It will also give opportunities to turning the LN₂ boiling curve for reaching a higher heat transfer and for other cryogens [48]. To quantitatively study the effect of different plunge methods, we compared the cooling rate between the vertical and horizontal plunge methods on a nylon mesh loaded with a thin CPA film (FIG. 3E, FIG. 13, and FIG. 14), and 1 μL droplet-loaded mesh (FIG. 24). If not specified, the cooling rate was measured at the geometric center of the mesh. The thin CPA film (with a thickness around 2 μm) simulates a small biosystem thermal load distributed continuously across the cryomesh area, while a 1 μL CPA droplet (Lc~500 μm) simulates the largest biosystem tested later in this study. The cooling rates of the different biosystem sizes show a similar trend (FIG. 25). The cooling rate showed significant variation for the horizontal plunge case from the center to the edge (2.8× higher at the edge than the center) versus the rate observed for the vertical plunge method (FIGS. 13 and 24). The horizontal plunge shows a sharp decrease in cooling rate from 6.4×10⁴° C./min at 2×2 cm to 1.7×10⁴° C./min at 10×8 cm. The vertical plunge presents a marginal decrease (18%) in the average cooling rate as the mesh size increases (i.e., 10×8 cm), which is significantly smaller than the decrease in the average cooling rate of the horizontal plunge (73%). Meanwhile, the vertical plunge achieves an average cooling rate across the mesh of 7.8×10⁴° C./min versus 6.4×10⁴° C./min with the increase of the mesh size from 2×2 cm to 10×8 cm, showing a much more uniform cooling than horizontal plunge (FIGS. 15 and 24).

We also studied the uniformity of cooling across small to larger mesh areas for further scale-up designs (FIG. 15). A small-size mesh (i.e., H=2 cm) has uniform cooling along the plunge direction, showing a difference of less than 6% (FIG. 15B). For the vertical plunge of 5 cm×4 cm mesh, we measured 5 points to test the uniformity of the cooling rate on copper and nylon mesh (FIG. 15C). The CondD-C demonstrated uniformity across the area within 6% (difference between highest and lowest value), while the ConvD-C demonstrated nonuniformity with variation up to 34% (nylon mesh 4-μL droplet, FIG. 15C). Interestingly, the cooling uniformity is only related to the height (H) of the cryomesh during the vertical plunge (FIG. 15D). With an increase of H from 2 to 8 cm, the temperature differences between the top and bottom of the cryomesh increase from 1% to 26%. When the width (W) of the cryomesh changes from 5 to 15 cm with a fixed height (H), the cooling rate of the bottom slightly decreases by 1%, and the temperature differences between the top and bottom of the cryomesh increase from 7% to 9%, respectively. The width (W) of the cryomesh has a limited effect on cooling uniformity (FIG. 15D). During the vertical plunge, bubbles (vapor nitrogen) still are generated due to heat release from the cryomesh and the biosystem. The bubble rises from the bottom of the cryomesh towards the top due to buoyancy force and coalesces with other bubbles, potentially forming a thick vapor layer around the cryomesh similar to flow boiling [49]. Thus, with the increased height of cryomesh, the cooling rate is reduced due to the reduced convection heat transfer of the bubble layer. For scaling to a larger mesh area, the width can be increased with minimal impact on the rate or uniformity of cooling, while height needs to be more carefully designed within the requirements of a specific cooling application. The key factors enabling scale-up to larger cryomesh area while maintaining uniformity in cooling are the thermal conductivity of the mesh and vertical plunging distance. The practical design requires a thermal conductivity of k≥10 W/m/K and e.g. vertical plunging (i.e. CondD-C), while we demonstrated uniformity in cooling rates up to a plunging height of at least 5 cm. In this case, the difference of cooling rates across the cryomesh are expected to be less than 10% (difference between the top and bottom of the mesh). Uniformity across greater cryomesh heights are expected with improved bubble release, improved convective heat transfer with the cryogenic coolant, and faster/controlled plunge speed.

Using the heat transfer model, we varied the heat transfer coefficient to fit the experimental cooling rate (FIG. 3E) and determine the effective heat transfer coefficients for our plunge cases. For a 10 cm mesh with the horizontal plunge, the simulated heat transfer coefficient is around 100 W/m²/K, which is due to the thick gas nitrogen layer underneath the mesh. By removing the vapor layer, the heat transfer coefficient increases leading to an increased cooling rate. Thus, the vertical plunge increases the effective heat transfer coefficient by removing air nitrogen bubbles, which is one key factor in achieving optimal cooling rates with the conduction-dominated cryomesh. Here we simulated an effective heat transfer coefficient from 500 to 1250 W/m²/K for the vertical plunge case. Meanwhile, the vertical plunge achieves uniform cooling across the surface, which is essential for mesh scale-up. To further enhance the bubble release, a general design principle is to apply a hydrophilic coating on the mesh [50]. The hydrophilic coating (e.g., PEGylated coating [51]) will allow the liquid nitrogen to wet the mesh more easily than a hydrophobic coating due to its high surface energy [52]). Thus, the bubble has less contact area with the mesh and a reduced pinning force, which leads to a rapid release from the substrate [53, 54]. Enhancing the bubble release during cooling in liquid nitrogen will lead to enhanced convection cooling. Similar to enhancing the critical heat flux (CHF) of boiling, this may be achieved by using hydrophilic coating [52], nanostructures [55], or 3D geometries [56]. Further, anti-adhesion coating can facilitate biosystem release from the mesh surface reducing potential damage to the biosystem during handling.

Once we had determined the optimal plunging conditions, we compared the cooling rate of the commercially available cryomesh designs with different wire diameters (FIGS. 3F, 3G, and 11). The cooling rates of nylon, stainless steel (s. steel), and copper mesh with D=50 μm and Φ=0.5 were measured with a 1-μL droplet with a concentration of 14 wt % EG+14 wt % DMSO+RPMI (FIG. 3F). The copper mesh showed the highest cooling rate of 3.4×10⁴° C./min, which is 1.4× and 2.6× that of stainless steel and nylon mesh with the same dimensions, respectively. For comparison, we also included the theoretical cooling rates, which show a trend similar to the experimental cooling rate, which increases with the thermal conductivity (FIG. 3F and FIG. 15B). For this modeling, the heat transfer coefficient is a simple experimental fitting, 1250 W/m²/K to match the experimental cooling rate (1-μL droplet case). When the filament diameter decreases from 50 to 30 μm, for stainless steel, the cooling rate increases by 2.5 to 3.6×10⁴° C./min for the 1-μL droplet. As a result of lower thermal mass and higher contact area, a 30 μm diameter mesh shows a cooling rate similar to a copper mesh with a 50 μm wire diameter, as predicted in the modeling (FIG. 11). Note that the model predicts a slightly higher cooling rate, as the simplified fitting did not consider the dynamic change of the heat transfer coefficient during the cooling process, especially for large thermal mass heat releases. In this case, a large thermal mass continually releases more heat into the LN₂, which generates bubbles more rapidly around the mesh and slightly lowers the convection heat transfer coefficient. The measured nylon mesh cooling rates are also slightly lower than the predicted values. When the diameter of nylon mesh increases to 100 μm, the low thermal conductivity of nylon severely limits heat transfer through the mesh. Thus, the nylon with D=50 μm has a similar experimental cooling rate to nylon with D=100 μm (FIG. 3G). In this case, the major heat release from the biosystem is from direct convection between the biosystem and LN₂, which was neglected in this model, as discussed above. Therefore, regardless of a diameter of 50 or 100 μm for nylon, the mesh serves mainly as a carrier holding biosystems during plunging into LN₂ but does not participate significantly in heat transfer during cooling.

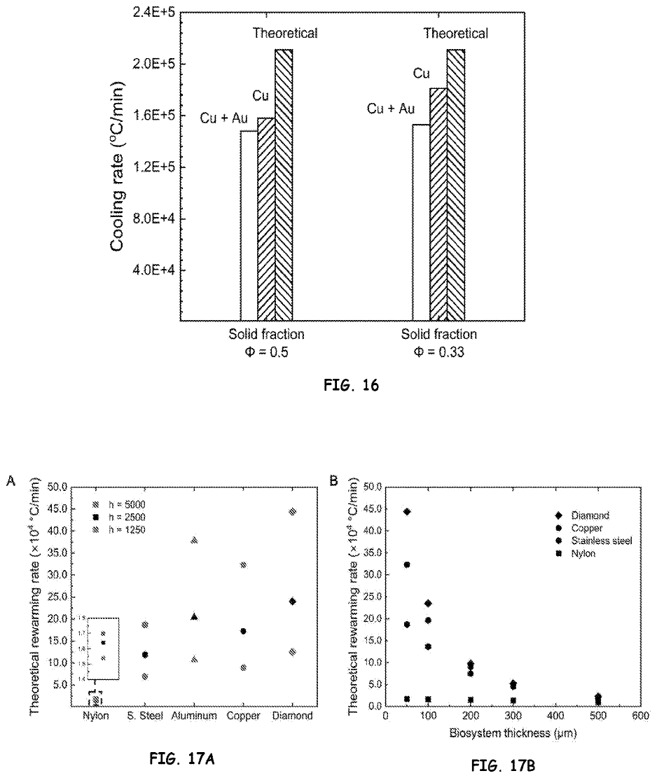

While the copper mesh demonstrated some of the fastest cooling rates, one potential concern with copper is toxicity with direct exposure to the biosystems. Copper is considered toxic to many biological systems at high exposure rates, as the copper damages the cell membrane and allows copper to enter the cells if released as ions [57, 58]. By electroplating gold on copper mesh, the toxicity can be reduced and does not lead to a significant decrease in the cooling rates observed (FIG. 16). However, to eliminate any concerns of related to toxicity, we chose to conduct testing in biological systems mainly with stainless steel, which is well-established as a biocompatible material, or in some cases to coat copper mesh with gold. If not otherwise specified, for further application on model organismal biosystems, we chose stainless steel mesh with D=30 μm and Φ=0.5 as CondD-C.

### Considerations for Cryomesh Design for Rewarming

One of the benefits of the cryomesh approach is that rewarming can be achieved through plunging techniques similar to those used in cooling. In this case, rather than LN₂, the vitrified cryomesh can be plunged into a rewarming bath set to the desired temperature. The mechanisms of rewarming are still convection and conduction as noted for cooling (see FIG. 2A). Therefore, the same principles of cryomesh design optimization apply, with the important caveat that Leidenfrost will not be present and therefore the heat transfer coefficient will be larger especially if agitation or flow is induced (expected range of 1250 to 5000 W/m²/K) [41]. Using a 50 μm thick biosystem as a model and increasing the h accordingly, conductive mesh rewarming rates can increase up to 3.5 times, reaching a rewarming rate of 4.4×10⁵° C./min compared with h from 1250 to 5000 W/m²/K. The nylon ConvD-C has a lower conductivity, so its rewarming rate only increases by 10%, reaching 0.17×10⁵° C./min from h=1250 to 5000 W/m²/K. (FIG. 17A). This conduction-dominated rewarming rate can also be enhanced in thicker biosystems and, as before, improved by mesh conductivity (FIG. 17). Meanwhile, the experimental rewarming rate of CondD-C (stainless steel) is 2.6×10⁵° C./min, which is 15% lower than the model prediction but is 2.4 times that of ConvD-C (nylon) (FIG. 26). Therefore, optimizing the CondD-C design for improved vitrification will inherently improve cases of plunge-based rewarming.

We validated the rewarming rate on stainless steel D=30 μm and nylon mesh D=50 μm as representative of CondD-C and ConvD-C, respectively (FIG. 26). For CondD-C (stainless steel), the theoretical rewarming rate shows good agreement with the experimental rewarming rate. The experimental rewarming rate of ConvD-C (nylon) is higher than the predicted rewarming rate. Since the direct convective transfer between the biosystem and rewarming fluid was neglected, as discussed earlier, the predicted rewarming is lower than observed for this case.

### Zebrafish Embryo Cryopreservation

To investigate the upper size limit of biosystems to which the conduction-dominated cryomesh could be applied we tested CondD-C with zebrafish embryos (diameter=800 μm). Previous work employed a cryo-top made of a polypropylene strip for zebrafish embryo vitrification [35, 37]. However, this approach can only process one cryo-top at a time, considerably limiting the throughput of cryopreservation. Further, as noted earlier, cooling rates on the cryotop are considerably lower than those achievable with the CondD-C (Table 3). Faster cooling rates can also enable lower CPA concentrations to be used, which could further increase viability [35]. With the previous protocol, a well-trained operator can only vitrify 10-15 embryos in an hour. Thus, a substrate with a high cooling rate, which can vitrify large quantities of zebrafish embryos, is desirable. Here, we demonstrate the ability of the conduction-dominated cryomesh approach for scalable, high-throughput vitrification of zebrafish embryo vitrification.

The steps involved in the cryopreservation of zebrafish embryos utilizing conduction-dominated cryomesh are presented in FIG. 4A. First, high-concentration CPA (10 nL of 80 wt % of PG+20 wt % MeOH) is microinjected into the yolk of a zebrafish embryo at the high cell stage (0 min, FIG. 6B) using an automated microinjection and allowed to distribute throughout the yolk. In the original protocol, this micro-injection step included gold nanorods for laser rewarming of the embryos. Since the focus of this demonstration is on vitrification, the gold nanorods were not included. The high cell stage of the embryo is at 4 hours after postfertilization. The custom-built robotic microinjection system was a computer vision-guided robot that used off-the-shelf components to fully automate the microinjection procedure [60-62]. The CPA-injected embryos (1 min, FIG. 4B) are transferred into an incubator at 28° C. to allow for CPA diffusion inside the yolk. After a three-hour recovery period, the embryos are placed on a cryomesh and immersed in a precooling bath (2.7 M PG+1.2 M MeOH+0.5 M Trehalose) for 5 minutes. The embryo shows a dehydrated state (FIG. 4B), effectively increasing the internal CPA concentration in the embryo. Then, the zebrafish embryos and mesh are placed on tissue paper to wick off excess CPA and vertically immersed in liquid nitrogen for vitrification (FIG. 4A).

We tested embryo vitrification on both the stainless steel mesh and nylon mesh with a vertical plunge (see method section for more details) (FIGS. 4C and 4D). We used a microscope with a camera to visualize the vitrified embryos [8, 36]. The embryos in which ice-formed appeared white in color, while the vitrified embryos are transparent (blue arrowed, FIGS. 4C and 4D). The number of zebrafish embryos used for each individual test is n=20±2 with a total number around 500. We calculated the vitrification rate based on the microscope images. The stainless steel mesh achieves the highest vitrification rate at 64±7%, which is significantly higher than nylon mesh (29±7%) (FIG. 4E). The high vitrification rate achieved by stainless steel is due to the high cooling rate of conduction-dominated heat transfer. The experimental cooling rate of stainless steel is 2.9±0.1×10⁴° C./min, which is 1.2× times higher than nylon mesh (1.3±0.2×10⁴° C./min).

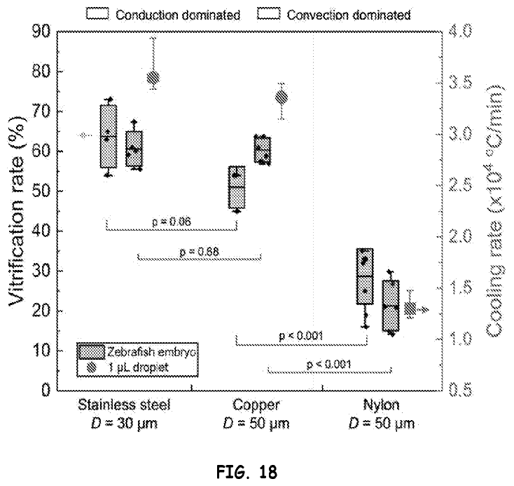

The increased cooling rate contributed to a higher vitrification rate. The variation in embryo size led to a few embryos not being vitrified on the CondD-C due to differences in CPA diffusion and dehydration state. Two strikingly clear embryos on stainless steel (before vitrification) turned out to be entirely ice-formed embryos (after vitrification, FIG. 4C), possibly due to unsuccessful CPA diffusion in the yolk or CPA loading into the embryos. The copper mesh was used here to further check the importance of higher-density mesh and thermal conductivity. Copper mesh with D=50 μm, which produced a cooling rate of 2.9±0.1×10⁴° C./min, was similar to stainless steel, but we observed a 20% lower vitrification rate (FIG. 18). This is due to the decreased contact area introduced by the larger pore size, shown as increased Rh (increased Aₘ in Equation 21), compared with mesh with a smaller wire diameter. This further highlights the importance of mesh geometry and supports that a higher-density mesh (i.e., smaller pore size) is preferred to a reduced Rh. Although the measured cooling rates were similar, we believe the difference in vitrification rates was due to the temperature uniformity within the biosystem, influenced by the contact area relative to each mesh pore. The higher Aₘ of the stainless steel mesh (increase with area ratio in FIG. 2C) reduced the Rₕ and Rₘ compared with the copper mesh D=50 μm, and so the temperature of biosystem during cooling was more uniform on stainless steel in this case. Note that the nonuniform temperature cannot be directly measured because the diameter of the thermocouple tip (~200 μm) is larger than the mesh pore size. The vitrification rate of zebrafish embryos validated that the denser mesh can increase the cooling rate and vitrification rate of the biosystem, which is in line with our model predictions (FIG. 2C). For the cryomesh design, pore size needs to be less than 50 μm based on the experiments, which can enhance the contact area and reduce Rₘ (Equation 22). However, the pore size should also be larger than 5 μm to ensure wicking of excess CPA, especially for a smaller wire diameter mesh. The pinning force generated by the mesh wire of a fixed area increases with the decrease in pore size, which reduces proper wicking of the CPA [43, 44]. Moreover, the experimental cooling rate of the zebrafish embryo had a similar value as the cooling rate of the 1-μL CPA droplet (FIG. 18). These measurements validated the use of a 1-μL CPA droplet as a representative model system used in our physical characterization (FIG. 18). Meanwhile, based on the 20-30% vitrification rate achieved, a cooling rate of 1.3×10⁴° C./min was estimated as the threshold cooling rate for zebrafish embryos loaded by this protocol (dashed line, FIG. 4E), which was higher than the CCR of the CPA for zebrafish embryos (Table 2).

As the thickness of the zebrafish embryo was more than 300 μm, plunge rewarming with CondD-C could not rewarm the embryos with these CPA loading conditions [35]. For the loaded CPA, rewarming rates greater than 9.3×10⁵° C./min are expected to be needed to avoid devitrification upon rewarming. Therefore, rewarming of the vitrified embryos was not attempted in this study. Nevertheless, the successful vitrification achieved by CondD-C allows us to further investigate complementary rewarming technologies, such as cryomesh Joule heating [8,9] or laser rewarming in a higher throughput configuration [63].

### Drosophila Embryo Cryopreservation

To further investigate biosystem vitrification using the CondD-C, we attempted to cryopreserve Drosophila embryos as another model system. Previous work has cryopreserved Drosophila embryos on cryomesh with a CPA concentration of 27 wt % followed by convection rewarming, demonstrating average hatching and survival-to-adulthood rates of around 10-12% [4,8]. Joule heating has been applied to rewarm vitrified Drosophila embryos and improved average hatching and adult rates to 60.8% and 41.3%, respectively [8, 9]. Therefore, to further improve hatching and adult rates during cryopreservation, higher vitrification rates or lower CPA concentrations are desired. Here, we demonstrated the ability of the CondD-C approach to improve the vitrification of Drosophila embryos with low CPA concentrations.

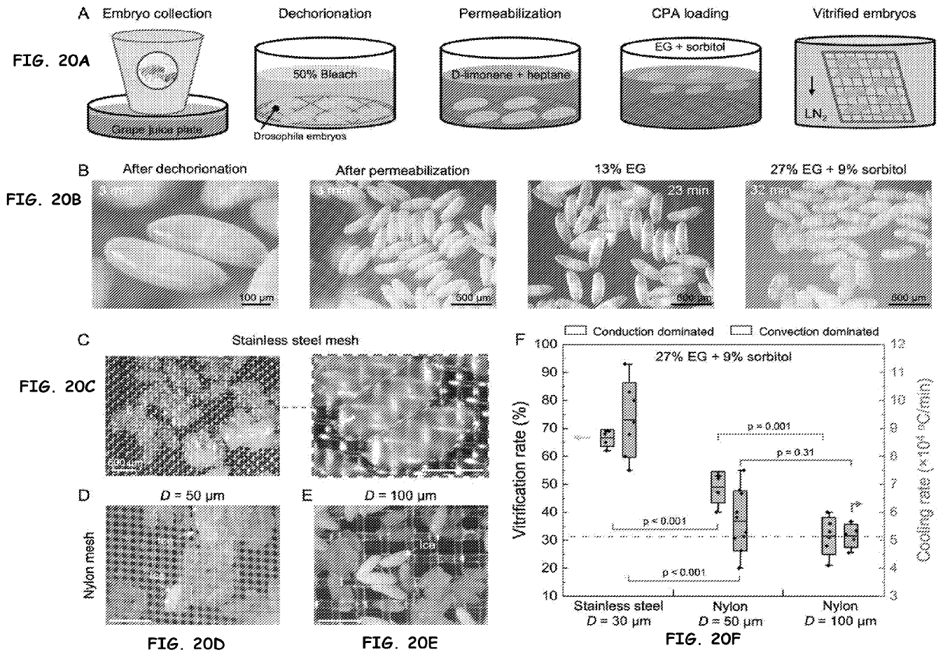

The steps involved in the cryopreservation of Drosophila embryos utilizing CondD-C are presented in FIG. 20A (further details in Methods). We used a derivative of the wildtype stock w1118 called M2 [4]. The Drosophila embryos were collected on a grape juice plate and allowed to develop for 22 hours at 20° C. The embryos were dechorionated with 50% bleach and permeabilized with D-limonene and heptane (FIGS. 20A and 20B). Cryoprotective agent step loading was followed with concentrations of 13% EG and 27% EG+9% sorbitol, successively, used by the previous study as the standard protocol [8]. The embryos' shrinkage and crenation (wrinkling) showed successful dehydration of the embryos (32 min, FIG. 20B). Drosophila embryos were placed in a nylon mesh basket for all loading and dehydration steps. The embryos were then transferred to ConvD-C or CondD-C, excess CPA was wicked away, and they were plunged vertically into LN₂.

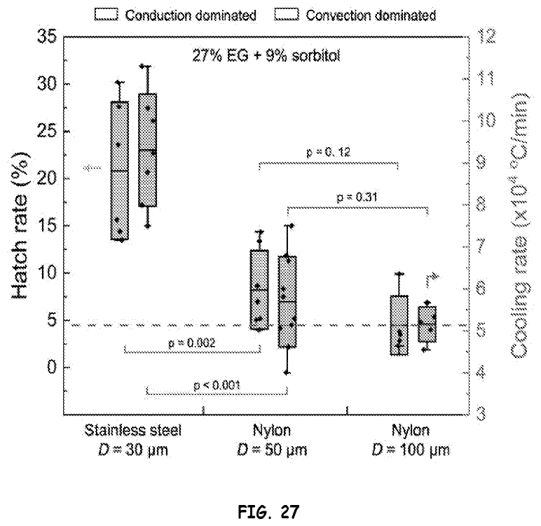

We tested embryo vitrification on the stainless steel mesh and two nylon meshes with different filament diameters (FIG. 20C-20E). The 100 mm diameter nylon was used to provide a direct comparison to previous studies [4], and the 50 μm diameter nylon mesh was used to provide a closer comparison to the 30 μm stainless steel mesh. We used a microscope (Amscope) with a camera (MU1000) to visualize the vitrified Drosophila embryos [8]. The number of Drosophila embryos used for each individual test loaded on a cryomesh was n=200-400 with a total number of around 10,000. The vitrified embryos were transparent, with the mesh visible underneath the embryos (right, FIG. 20C), while embryos with internal ice showed opaque white color (FIGS. 20D and 20E). We calculated the vitrification rate based on representative microscope images from each run (FIG. 20C-20E). On the stainless steel mesh (D=30 μm, Φ=0.5), the majority of the embryos were vitrified, achieving a high vitrification rate of 66±3%, which was higher than the nylon mesh with D=50 μm (48±5%) and D=100 μm (30±7%) (FIGS. 20C and 20F). Stainless steel mesh achieved the highest average cooling rate of 8.8±1.4×10⁴° C./min, which was 1.6× and 1.8× that of the D=50 μm and D=100 μm nylon cryomesh, respectively. Based on the experimental results of vitrification rate, a cooling rate of 5.1×10⁴° C./min was estimated as the threshold cooling rate for Drosophila embryos loaded with 27% EG and 9% sorbitol to be vitrified (dashed line, FIG. 20F), which is higher than the required CCR for Drosophila embryos (Table 1 and 2). We believe the clustered embryos on the CondD-C led to variability in cooling rates and a vitrification rate lower than 100%. The clustered embryos effectively increased the biosystem thermal resistance with increased effective thickness (R_{b}, Equation 23), thereby decreasing the cooling rate. Interestingly, it was observed that a monolayer of Drosophila embryos on the cryomesh showed better vitrification than clustered embryos (right bottom, FIG. 20C), close to a 100% vitrification rate. Meanwhile, a high vitrification rate was achieved on CondD-C due to its high cooling rate, which also had a direct relationship with the hatch rate (FIG. 27). The previous study achieved a high average hatch rate (up to 52.9%) on a nylon mesh using a higher CPA concentration (39% EG+9% sorbitol) which permitted lower CCR and CWR requirements [4]. However, when decreasing the CPA concentration to 27% EG+9% sorbitol, there was low hatching (4.4±3%) of Drosophila embryos on ConvD-C (nylon, D=100 μm) due to a low cooling rate (FIG. 27). Meanwhile, hatching rates using the lower CPA concentration on the improved CondD-C demonstrated here were up to 24±6.6%, which was 3.3× times that of an improved nylon mesh (with D=50 μm) and 5.4× times the hatching rate with prior use of the stainless steel mesh with the same CPA concentration [8]. With a high cooling rate achieved on CondD-C, we demonstrated a means to lower the required CPA concentration while maintaining vitrification, rewarming without crystallization, and high hatch rates. This will be critical for expanding use to biosystems that are more susceptible to CPA toxicity. Although the enhanced vitrification rates, rewarming rates, and hatch rates were achieved by CondD-C optimization, it is possible that even better hatch rates may be achievable with faster rates of rewarming.

### Coral Larvae Cryopreservation

Previous attempts at coral larvae cryopreservation have produced limited success due to their high sensitivity to CPA toxicity. This has required the use of lower concentrations of CPA cocktails than are typically used in the cryopreservation of aquatic species [23]. This necessitates rapid rates of cooling and rewarming to cryopreserve without ice formation and has limited prior attempts at cryopreservation to the microliter scale. Adult mushroom coral larvae (Lobactis scutaria) have been previously vitrified and rewarmed with recovery of 43% in 1 μL droplets containing 8-20 larvae per droplet on a cryotop using 3.5M CPA with laser rewarming [23]. However, droplet-based vitrification approaches are not amenable to large-scale coral restoration efforts because of their complexity, the need for extensive training, and the small number of larvae produced (100-300 each day). For a reliable reef rebuild, at least 1500 larvae are needed for a single settlement tile [64], which requires higher throughput methods of coral larvae vitrification. This is critically important, as the annual reproductive cycle of most wild corals offers a limited window to collect and cryopreserve the larvae, typically 1-2 weeks per year. Thus, a simple technology that focuses on efficient cryoprotectant loading and produces rapid cooling and rewarming is critically needed to support coral conservation efforts. Here, we demonstrate that the conduction-dominated cryomesh approach enables rapid vitrification and rewarming of coral larvae with a high survival rate and can readily be scaled to larger numbers through the use of larger or multiple cryomesh.

The steps involved in the cryopreservation of coral larvae utilizing CondD-C are presented in FIG. 5A. Briefly, the coral larvae were hatched after fertilization from collected sperm and eggs, which developed as previously described [23]. Then the day-3 coral larvae were transferred to the CondD-C and immersed in CPA solution (10% v/v PG+5% v/v DMSO+1 M trehalose) for 2 minutes, followed immediately by wicking of excess CPA and vertical plunging into LN₂. At this point, the coral larvae could be placed in storage; however, for the purposes of this demonstration, the CondD-C with larvae was immediately rewarmed by vertically plunging into rewarming solution (RW) and filtered seawater, successively (see details in Methods).

In the process of conducting experiments, we found that copper mesh exposure was toxic to coral larvae and therefore we did not use it in any of the following experiments except to compare its achievable cooling rate (FIG. 5B). Thus, we vitrified the coral larvae on nylon mesh (D=50 μm, Φ=0.5) and stainless steel mesh (D=30 μm, Φ=0.5 and D=50 μm, Φ=0.33). Vitrification proceeded as described earlier and in FIG. 5A. We used a stereomicroscope to assess the vitrification of the coral larvae. Ice can be visualized as white clouding, while vitrified larvae remained transparent. The stainless steel cryomesh showed good vitrification (FIG. 5C), but larvae on the nylon mesh appeared to be entirely crystallized (FIG. 5D). Based on the experimental data, stainless steel with D=30 μm and Φ=0.5 can achieve the best outcomes with larvae cooling rates in excess of 1.2×10⁵° C./min. This compares to cooling rates for the nylon mesh which are expected to be only 0.78×10⁵° C./min (FIG. 25).

After establishing successful vitrification, we further quantified the survival rate of coral larvae rewarmed on the stainless steel and nylon mesh (FIG. 5E). Here survival is defined as the resumption of swimming by 2 h post-thaw (see Methods for further details). The stainless steel cryomesh with D=30 μm and Φ=0.33 achieved the highest survival rate at 85% (n=200), while the nylon-based cryomesh produced a 0% survival rate. The high survival rate achieved by stainless steel cryomesh with smaller filament was attributed to the high cooling rate. Due to practical constraints, we were not able to directly measure the cooling rates of the coral larvae. To estimate these rates, we used PE (polyethylene) particles with a diameter of 125 μm (Cospheric LLC) loaded with CPA to simulate the coral larvae vitrification and measured the cooling rate. The SS mesh with a smaller filament achieved the highest average cooling rate of 9.4×10⁴ C/min, which is 1.2× and 1.6× times higher than thicker stainless steel D=50 μm, Φ=0.33 and nylon cryomesh, respectively. The smaller wire diameter contributed to a higher cooling rate and a higher survival rate than a thicker wire diameter (i.e., D=50 μm). The calculated CCR of CPA for coral larvae was 1.3×10³° C./min, which was at least one order smaller than the achievable cooling rate on cryomesh (FIG. 5E and Table 2) [10]. However, even though nylon mesh achieved a cooling rate higher than CCR, no coral larvae were vitrified (FIG. 5D). The CPA concentration inside coral larvae might not be able to reach the concentration of the exposed CPA [65]. Thus, the CCR required for coral larvae is higher than the cooling rate of nylon mesh showing unvitrified larvae. Instead of using CCR, the threshold cooling rate for coral cryopreservation was estimated as 7.5×10⁴° C./min based on the experimental result of survival rate (dashed line, FIG. 5E), which was one order higher than the CCR of coral larvae CPA. The range of cooling rates achieved for each of the mesh cases directly correlated to the observed survival (FIG. 5E). As discussed earlier, the principles leading to increased cooling rates will also imply an increased rewarming rate, so some of the differences in survival on the same CondD-C may also be attributed to the CPA concentration differences between coral larvae. The survival rate difference between different CondD-C may be attributed to the ability of CondD-C to achieve the CWR of the CPA or the uniformity of cooling within larvae.

The cryopreservation efficiency is improved by using CondD-C to achieve high viability and uniform cooling and rewarming with a large number of individual biosystems (i.e., larvae or embryo) loaded (number≥100). As one example, to achieve 100,000 viable coral larvae after cryopreservation, the total time of the laser-associated method [23] is 456× longer than the cryomesh method (Table 5).

TABLE 5
Cryopreservation efficiency of coral larvae.

| | | Cooling | Rewarming | | | Sophisticated |
|---|---|---|---|---|---|---|
| | Larvae per | processing | processing | Target | Total time | equipment and |
| Method | loading | time (mins) | time (mins) | number^{†} | (h) | training |
| Manual laser | 13* | >3 | >3 | 100,000 | >17,888.9 | Yes |
| rewarming process | | | | | | |
| Idealized automated | 13* | >0.5 | >0.5 | 100,000 | >94.3 | Yes |
| laser rewarming | | | | | | |
| process[60] | | | | | | |
| Cryomesh | 200** | <2 | <2 | 100,000 | <39.2 | No |

^{†}Target number refers to the number of viable coral larvae desired after cryopreservation.
*Number to achieve the highest direct post rewarming viability is around 43% . [23].
**Number is based on a 2 × 2 cm CondD-C (larger mesh sizes are possible and will increase the number accordingly). The cooling and rewarming processing time is based on a single well-trained user of a single Cryotop or cryomesh at one time. The idealized laser rewarming system is based on the laser-associated rewarming method with an automatic handling system (e.g., automated laser alignment and rewarming). This system does not currently exist but is an idealized comparison assuming fully CPA-loaded larvae on a Cryotop that is already cooled. Note that the automatic process assumes the laser is firing at the duty cycle, which is 1 pulse per second during rewarming and is likely an underestimate of the time needed. Finally, it should be noted that no sophisticated equipment is needed for the Cryomesh vs. the laser or automatic process thus making it easily accessible to anyone practicing cryobiology in the field. As coral larvae are chilling sensitive, there are no other reports we are aware of that show success after slow freezing or direct freezing. Laser rewarming is the only other method that has shown success and therefore is used as “conventional” for comparison here.

### Scaling Vitrification and Rewarming of Pancreatic Islets

Human stem cell (SC-)derived beta cell islets were used as a model system and demonstration of clinically relevant use of CondD-C in regenerative and transplant medicine applications. Islet transplantation is a promising and potentially curative treatment for diabetes. However, islet infusions frequently require total infusions of 700,000 to greater than 1 million islet equivalents (IEQ). This requires islet numbers from two, three, or more donors or a large number of batches of SC-derived islets for successful treatment, creating a practical barrier to being able to provide effective treatment. Successful cryopreservation of large IEQ batches of islets would address many barriers to translating this impactful procedure in the clinic.

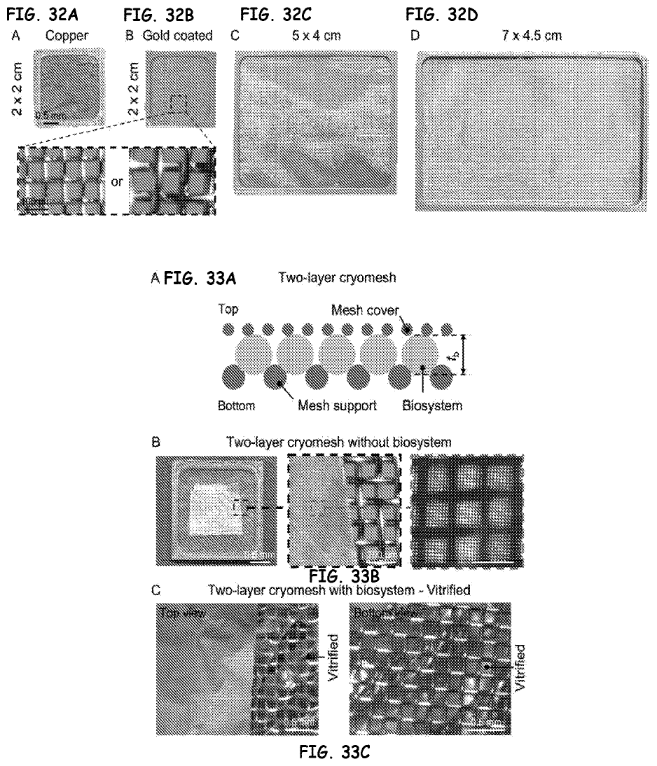

CondD-C vitrification and rewarming of SC-derived islets ranging from approximately 100-250 μm was performed on a gold-coated copper mesh with 50 μm filament diameter and 50 μm pore size (FIG. 32). Scaled numbers of islets were vitrified and rewarmed on varying sizes of the CondD-C, including 2500 IEQ (2 cm×2 cm cryomesh), 5000 IEQ (2 cm×2 cm cryomesh), 10,000 IEQ (2 cm×2 cm cryomesh), 25,000 IEQ (5 cm×4 cm cryomesh), 50,000 IEQ (5 cm×4 cm cryomesh), and 100,000 IEQ (7 cm×4.5 cm cryomesh). As previously described [6, 66], the islets were loaded with 22 wt % EG+22 wt % DMSO in three steps (4.4 wt % EG+4.4 wt % DMSO for 10 min at 21° C., followed by 11 wt % EG+11 wt % DMSO for 10 min at 4° C., and then in 22 wt % EG+22 wt % DMSO for 10 min at 4° C.). The islets were distributed onto the CondD-C, excess CPA was wicked away, and then the CondD-C with attached islets was vertically plunged into liquid nitrogen. The islets remained in cryogenic storage at least overnight and up to several days. Rewarming and CPA removal was conducted by rapidly plunging in 11 wt % EG+11 wt % DMSO+5 wt % sucrose at 4° C. After 10 min, the rewarming solution was diluted twofold using ice-cold 10 wt % sucrose solution and incubated for another 10 min at 4° C. The islets were then transferred to 21° C., and the suspension was diluted twofold using 10 wt % sucrose solution. After 5 min, the islets were placed back in RPMI medium for 15 min as the last CPA removal step and then prepared for assessment.

Qualitative measurement of islet viability was performed using acridine organ (AO) and propidium iodide (PI). Intact islets were stained with 8 ng/ml AO and 20 ng/ml PI (Millipore Sigma) for 2 min at room temperature, coverslipped and imaged using an Olympus Fluoview 3000 inverted confocal microscope (Olympus) with 502/525-nm filters for AO and 493/636-nm filters for PI. The images were captured at 4,020×4,020-pixel resolution using a 10× magnification objective. The islet diameters in all of the confocal images are increased due to coverslip compression used to increase effective imaging depth. For further assessments, islets were incubated after treatment in a dynamic culture flask at 70 rpm, 37° C., and 5% CO₂ for 3 h in islet culture media. Quantitative viability was measured on dissociated islet cells. The islets were dissociated into single-cell suspensions in TrypLE Express (Thermo Fisher Scientific, 12605010), quenched with S3 containing fetal bovine serum and stained with 8 ng/ml AO plus 20 ng/ml PI. After 15 s of incubation, 10 μl of the suspension was pipetted onto the Countess Cell Counting Chamber Slides (Thermo Fischer Scientific, C10228), and viability was quantified using a Countess II FL cell counter (Invitrogen by Thermo Fisher Scientific, AMQAF1000). Cellular respiration (oxygen consumption rate, OCR), which is predictive of the islet's mitochondrial function in vivo, was measured using the Agilent Seahorse XF Mito Stress Test and Agilent SeaHorse xFe24 Islet Capture FluxPak (Agilent, 103418-100) plates and grids. Islets were handpicked into wells containing 500 μl culture media in sufficient numbers to cover 50% of the inner circle of each sample well. The islet capture screen was carefully and securely fit onto the plate. Islets were washed twice with SeaHorse media (SeaHorse XF DMEM) (Agilent, 103575-100) supplemented with 1 mM pyruvate, 2 mM glutamine and 5.6 mM glucose and equilibrated for 1 h at 37° C. Assay reagents were loaded in a previously hydrated sensor cartridge. The assay plate was inserted into a calibrated Agilent SeaHorse xFe24 analyzer, and the Mito Stress test was performed according to the manufacturer's protocol with the following optimized reagent concentration: 10 μM oligomycin A, 2 μM FCCP and 10 μM each rotenone and antimycin A. Glucose stimulated insulin secretion (GSIS) assays were conducted to assess islet specific in vitro function. Islets were washed twice in low-glucose (3.3 mM glucose) Krebs Ringer buffer (KRB) (128 mM NaCl, 5 mM KCl, 2.7 mM CaCl2, 1.2 mM MgSO4, 1 mM Na2HPO4, 1.2 mM KH2PO4, 5 mM NaHCO₃, 10 mM HEPES and 0.1% FAF-BSA in deionized water). The islets were then loaded into 24-well transwell inserts (Millicell, cell culture insert, PIXP01250) and fasted in low-glucose KRB for 1 h at 37° C. Islets were washed once in low-glucose KRB and then incubated in low-glucose KRB for 1 h at 37° C. The volume of the KRB with low glucose, high glucose and KCl was 1 ml per well. After incubation, the supernatant was collected and stored at −20° C. until analysis. The islets were then transferred to high-glucose KRB (16.7 mM) for 1 h at 37° C., and the supernatant was collected and stored. The islets were then transferred to low-glucose KRB with 30 mM KCl to observe depolarization conditions and incubated in this buffer for 1 h, and the supernatant was collected. Finally, the islets were dispersed via incubation with TrypLE and counted using a Countess automated cell counter (Thermo Fisher Scientific). Collected supernatants were analyzed by enzyme-linked immunosorbent assay for human insulin concentrations (ALPCO, 80-INSHUU-E01.1) and normalized for cell number.

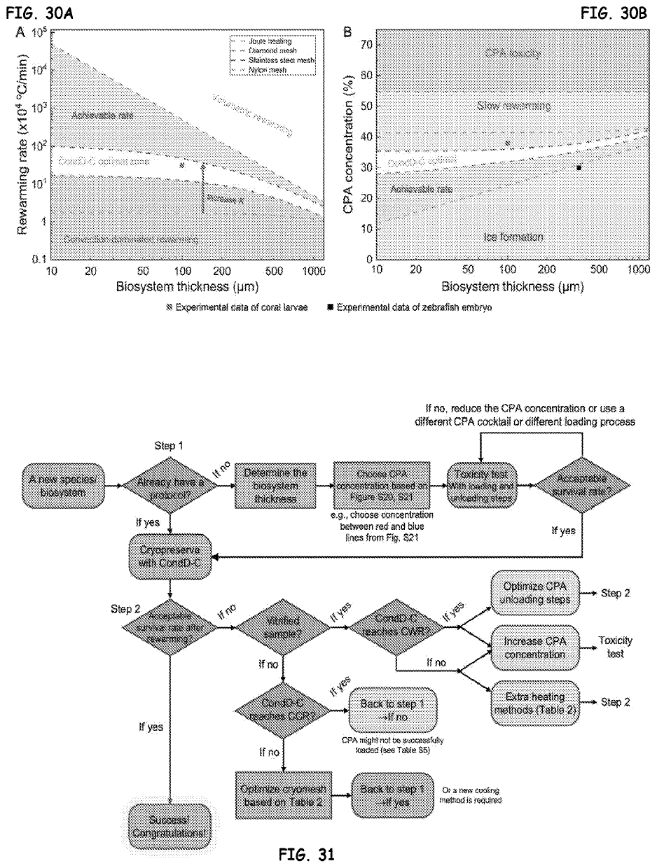

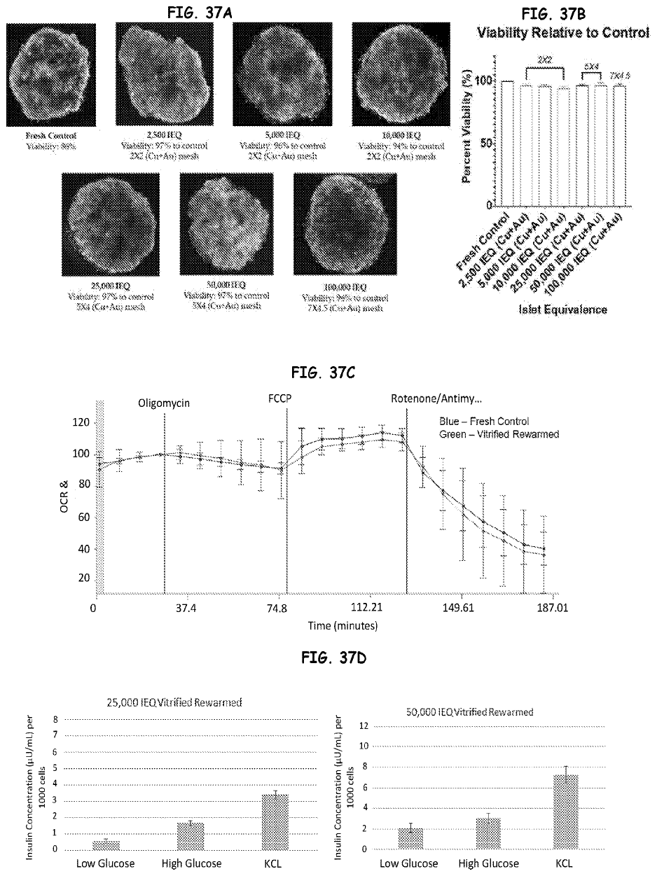

Islet morphology and viability was maintained and comparable across the IEQ batch sizes tested (FIG. 37). Example data also shows that the vitrified and rewarmed islets maintained function after vitrification and rewarming (FIG. 37). Recovery of the islets for the 50,000 and 100,000 IEQ cases was roughly estimated to be >95% based on quantification of the islets remaining adhered to the mesh and captured in filtering the loading and unloading solutions. This demonstrates that CondD-C can be used for high viability vitrification and rewarming of pancreatic islets up to at least 100,000 IEQ, with higher quantities possible based on further increases to the CondD-C area and/or islet density on the cryomesh. While the cryomesh area can be scaled to cryopreserve larger than 100,000 IEQ batches of islets, practical use will dictate the optimal batch size for cryopreservation. Typical islet transplant procedures may require total infusions of 700,000 to greater than 1 million, but it is likely that individual patient therapeutic dosing may depend on e.g. patient weight or quality of the islets used. In this case, it may be advantageous to limit cryopreservation batch sizes to e.g. about 100,000 IEQ to allow variable quantities to be rewarmed, as needed, while still not introducing impractical requirements for handling and processing. It is expected that comparable scalable cryopreservation results can be attained for similar sized biosystems (e.g. cell clusters, organoids, spheroids), and that CondD-C can be designed for cryopreserving scalable quantities of biosystems ranging from thousands, to tens of thousands, to hundreds of thousands, to millions or more, based on the biosystem size and CPA loading (FIG. 29 and FIG. 30), density (FIG. 35), and the CondD-C area.

### Design and Physical Limits of the Cryomesh Platform Technique

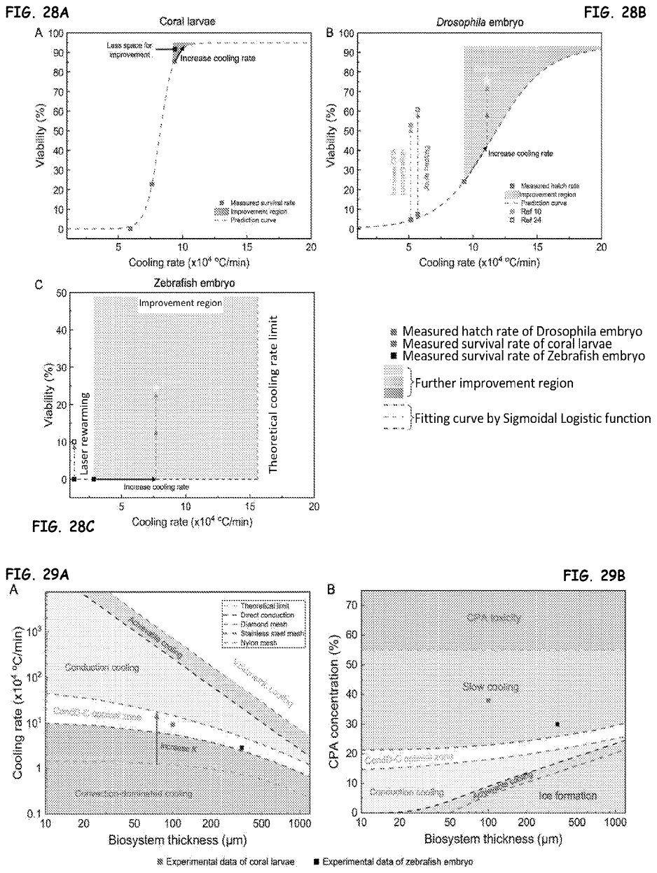

We summarized the key results and design principles that describe the physical limits of the conduction-dominated cryomesh and enabled the successful cryopreservation of different biosystems (Table 6, more details below). To determine how to improve the cryopreservation protocol, we analyzed the achieved and potential viability of biosystems tested in this study. The high cooling rate of CondD-C demonstrated the highest viability improvements in small biosystems (i.e., coral larvae, FIG. 28A), but also demonstrated advantages for the vitrification of a variety of model systems including Drosophila embryos (FIG. 28B), zebrafish embryos (FIG. 28C), and pancreatic islets (FIG. 37). With the increase of biosystem size (above ~200 μm), the CondD-C provides good vitrification rates during cooling, but more rapid heating approaches [8, 63] can also be considered to further increase the viability during rewarming especially with low CPA concentrations (e.g. below ~20%).

In FIG. 29A, the dashed lines show the theoretical maximum cooling rate of different cooling methods based on biosystem thickness. Between the conduction cooling and convection cooling regions is the CondD-C cooling method reported here, which has a higher cooling rate than convection-dominated cooling and fills the gap between the convection and conduction cooling methods (FIG. 29A). Increasing the thermal conductivity of cryomesh increases the cooling rate from the convection cooling region moving towards the conduction cooling region. With knowledge of the achievable cooling rate for different biosystems of different thicknesses, the CPA concentration can be further optimized (based on CCR and CWR), as shown in Table 3 and further illustrated in FIG. 29B. Note that a high CPA concentration increases the potential for toxicity in the biosystem while a low CPA concentration leads to the increased likelihood of devitrification with ice formation (FIG. 29B). By increasing the cooling rate of the cryomesh (i.e., CondD-C), the lowest CPA concentration required for vitrification can be reduced, especially, for a smaller biosystem with a thickness<200 μm (blue dashed line, FIG. 29B). Thus, the yellow-colored region between the red and blue dashed lines is defined as the cryomesh optimal zone, but CondD-C additional provides effective cryopreservation performance outside of this zone. With cryomesh designed for general cryopreservation, the CPA concentration could be increased to facilitate successful vitrification based on the cryomesh optimal zone from FIG. 30B, which reduces the CWR required. The concentration of the CPA loading determines the biosystem's limiting CCR and CWR (see Table 3). Knowledge of the limiting CCR and CWR can allow the selection of mesh designs to achieve these rates based on the characteristic size of the biosystem (FIG. 29 and FIG. 30). Also note that in discussion of CPA concentration, the lowest CPA concentration achieved in the biosystem should be taken into account. I.e. a thicker biosystem may not be fully equilibrated with the exposed CPA depending on loading times, and so the effective CPA concentration achieved in the biosystem should be used in this analysis.

As CWR is usually at least an order of magnitude higher than CCR, it is expected that cooling with the cryomesh will be achieved for some cases where warming cannot be achieved (e.g., zebrafish embryos for the specific cryomesh case shown in the example). Therefore, the limit of biosystem thickness can be determined based on a given CPA concentration, which is proportional to the CWR (FIG. 30). As one example, assuming a CPA concentration equilibrated to 36 wt % (Drosophila final step CPA), the largest thickness of the biosystem (Lt) that can be rewarmed without ice formation is around 400 μm based on theoretical calculation. As a general example range of biosystem thickness, the thickness can be less than about 500 μm with a CPA concentration of 40 wt %. It also should be noted that different CPA cocktails will have different CWR, which can change the limit of the biosystem thickness. These examples provide a first-order analysis that can be used to generally estimate cryomesh and cryopreservation method parameters. Under some conditions, ancillary techniques such as Joule heating or laser rewarming can be used to increase the achievable rewarming rates (FIG. 30) after achieving vitrification with the CondD-C. The flowchart in FIG. 31 demonstrates steps to modify the cryopreservation protocol for cryomesh to improve the viability of cryopreservation. The summary of the key results and design principles in Table 2 provides validation for these design considerations.

TABLE 6
Summary of key results related to
cryomesh design and performance.

| Design | | |
|---|---|---|
| factors | Considerations and tests | Location |
| Thermal | Materials choice - Thermal conductivity | FIG. 2, 3 |
| properties | k ≥ 10 W/m/K (e.g., stainless steel, | |
| of | aluminum, diamond, or copper) | |
| cryomesh | Commercially available cryomesh | FIG. 11 |
| | material | |
| Physical | Wire diameter: D ≤ 50 μm | FIG. 2 |
| dimensions | Solid fraction of mesh: 0.66 ≥ Φ ≥ 0.5 | FIG. 10 |
| | Critical length scales | Table 2 |
| | Commercially available cryomesh sizes | FIG. 11 |
| Achievable | Mesh alone | FIG. 25 |
| cooling | Horizontal vs. vertical plunge | FIGS. 13, 24, 25 |
| rates | Biosystem thickness | FIGS. 12, 25, 29 |
| Achievable | Estimated rate (different materials and | FIGS. 17, 30 |
| rewarming | thicknesses) | |
| rates | Validation of estimated rate (s. steel and | FIG. 26 |
| | nylon) | |
| Scalability | Impact of frame size | FIG. 15 |
| to larger | | |
| cryomesh | | |
| area | | |
| Validation | Coral larvae (survival rate with | FIG. 5 |
| with | threshold cooling rate) | |
| model | Drosophila embryo (hatch rate, | FIG. 20s, 27 |
| biosystems | vitrification rate with threshold cooling | |
| | rate) | |
| | Zebrafish embryo (vitrification rate with | FIG. 4, 18 |
| | threshold cooling rate) | |
| | Pancreatic islets (large scale vitrification | FIG. 37 |
| | and rewarming) | |
| Further | Expected impact of improvements on | FIG. 28 |
| optimization | biosystems | |
| | Physical limits of design | FIGS. 29, 30 |

### Some Additional Design Parameters for Cryomesh Performance

To improve the performance of the cryomesh, we considered additional parameters for design and modification (Table 7). Hydrophilic (contact angle<90°) cryomesh is preferred because it facilitates rapid nitrogen bubble release and enhanced wicking of excess CPA. Hydrophilic mesh has a high surface energy, which allows the LN₂ to wet the cryomesh easily [52]. Thus, the bubbles generated by boiling have a small contact area on and can easily be released during plunge cooling. The reduced bubble wrapping increases the effective heat transfer between cryomesh and LN₂. When the cryomesh is wetted with CPA (after loading the biosystem with CPA on mesh), a meniscus will form in between wires due to the surface tension force [43]. Hydrophilic wires will lead to a smaller contact angle between the meniscus and the wires, which generates a concave shape due to capillary pressure [67]. Thus, the CPA has the potential to wet through the mesh pore and more easily wick off. Finally, surface hydrophobicity will also impact the adhesion rate and wash-off rate of different meshes, which is an important performance factor. We defined the adhesion rate of the number of biosystems (e.g., embryos or larvae) attached to the mesh after the LN₂ plunging process/the total number of the biosystems initially loaded onto the mesh. Wash-off rate shows the number of biosystems released from the mesh after rewarming and unloading/the total number of biosystems attached to the mesh prior to rewarming. A gentle pipetting can also be applied to help the biosystem release during unloading. A high adhesion rate (>90%) is desired to reduce the loss of the biosystem during vitrification. Hydrophilicity will enhance the adhesion rate by generating a high surface tension force. Meanwhile, a high wash-off rate (>90%) ensures all the cryopreserved biosystems can be collected after vitrification and rewarming. Adhesion and wash-off rates were measured for coral larvae, Drosophila embryos, and Zebrafish embryos, using counts from images taken before and after the relevant processing steps. For all the cases analyzed, adhesion and wash-off rates were >99%.

Besides the consideration of the heat transfer performance of the cryomesh, the consideration of mechanical properties can further enhance performance. As a practical consideration, we also included information on the materials' relative strength. A high Young's modulus may not be required for larger mesh wire diameters (e.g., ≥50 μm) but is required for smaller wires to avoid breaking the mesh due to loading, handling, and surface tension of CPA. A high fracture toughness (K_{IC}) is also beneficial to withstand potential thermal stresses that can accumulate during rapid cooling and rewarming of the mesh [68, 69]. Similarly, materials with a fracture toughness≤1 are not recommended as a practical design, such as glass, due to concerns over fracture during handling and storage.

TABLE 7
Table of mesh physical properties.

| | Hydrophobicity | Young's | Fracture | | Wash-off |
|---|---|---|---|---|---|
| | (contact | modulus | toughness | Adhesion | rate*** |
| Material | angle °)* | (GPa) | (MPa.m^{1/2}) | rate** (%) | (%) |
| Nylon | Hydrophilic (73°) | 2-4 | 5-10 | >99 | >99 |
| Stainless | Hydrophilic (71°) | 180 | 112-278 | >99 | >99 |
| steel | | | | | |
| Copper | Hydrophilic (86°) | 117 | 80-100 | >99 | >99 |

*Hydrophobicity is determined on the plain surface without any structure or treatment, which determines the wicking performance. Hydrophobicity of the bulk material is reflective of the relative performance of potential mesh materials. The contact angle has a standard deviation of ± 5°.
**Adhesion rate is defined as the ratio of the number of biosystems (e.g., Drosophila embryos) attached to the mesh after the LN₂ plunging process/the total number of the biosystems initially loaded onto the mesh.
***Wash-off rate is defined as the ratio of the number of biosystems released from mesh after rewarming/unloading/the total number of biosystems attached to the mesh prior to rewarming. Adhesion and wash-off rates were measured for coral larvae, Drosophila embryos, and Zebrafish embryos, using counts from images taken before and after the relevant processing steps. Rates for coral larvae on the copper mesh were not analyzed due to toxicity.

### Design and Physical Limits of the Cryomesh Platform Technique-Extended Discussion

We summarized the design principles for the successful cryopreservation of different biosystems, as well as the physical limits of the conduction-dominated cryomesh (FIG. 28). To determine how to further improve the cryomesh, we analyzed the achieved and potential viability of biosystems tested in this study (FIG. 28). There are three ways to reduce ice crystallization (leading to potential increases in viability): 1) increase the cooling rate, 2) increase CPA concentration, and 3) increase the rewarming rate. The coral larvae have the highest viability, up to 85% on CondD-C, with a limit of 100% survival under the best conditions [23]. Thus, the potential for further improvement region based on cooling rate and CPA optimization is limited for coral larvae (shown in the colored area of FIG. 28A, with a corresponding increase in survival of approximately 15.2%). Increasing the cooling rate is the only method considered in this study to improve the survival rate of coral larvae (black arrow, FIG. 28A). Meanwhile, the region on the graph that shows potential improvement for the Drosophila embryo (highest value of 96% [4]) and zebrafish embryo (highest value of 59% [35]) is 25× and 21× larger, respectively, than for coral larvae, showing the necessity to further improve the cooling rate and CPA in these biosystems. While maintaining the same cooling rate for Drosophila embryos, the viability can be improved with a higher CPA concentration to avoid potential ice formation during rewarming (orange dashed line, FIG. 28B) [4,8]. Alternatively, viability can be improved by maintaining the same CPA concentration but applying more rapid heating (blue dashed line, FIG. 28B). For example, improving the cryopreservation protocol to reach the desired viability (yellow star, FIG. 28B) requires increasing the cooling rate (along the fitting curve), using a more rapid heating source (blue line), and modifying CPA concentration (orange dashed line). Note, the yellow star is used as an example and does not represent any suggested viability.

The same method to improve viability can be used to design a further improved cryopreservation protocol for zebrafish embryos (FIG. 28C). Due to the large size of zebrafish embryos, the theoretical maximum cooling rate is limited to 15.6×10⁴° C./min in the pure conduction case (i.e., assume the surface temperature instantly reaches −196° C.). The potential for cooling improvement is shown as a gray-colored area in FIG. 28C, demonstrating a large potential for viability improvement. Increasing the cooling rate minimally improves the viability of zebrafish embryos. More rapid heating, can improve the viability of zebrafish embryos.

The achievable cooling rate decreases with the increase of biosystem thickness for all different cooling methods (FIG. 29A). The dashed lines in FIG. 29A show the theoretically maximum cooling rate of different cooling methods. The theoretical cooling rates of cryomesh (blue, orange, and red dashed lines) are calculated based on Equations 5 and 18 with h=1250 W/m²/K. The purple dashed line is the theoretical limit of the cooling rate by assuming the surface temperature of the biosystem to be −269° C. (temperature of liquid helium). The black dashed line shows the maximum cooling rate that can be achieved with pure conduction heat transfer, assuming the surface temperature of the biosystem to be −196° C. (temperature of LN₂).

We defined three regions among those theoretical cooling rates. The top right corner is the region to be explored with volumetric cooling methods (cooling the entire volume at the same time). The achievable cooling region is for using different cryogens of lower temperature (e.g., liquid helium, −269° C.). The light-blue-colored area is the theoretical cooling rate achieved with conduction heat transfer of biosystem and cryomesh or any other substrates (e.g., cryotop) without consideration of convection heat transfer. In this case, we assumed there was no vapor layer during cooling, which is different from directly printing droplets into LN₂ [24]. The gray-colored area shows the cooling rate achieved by convection-dominated cooling methods. Between the conduction cooling and convection cooling regions is the CondD-C cooling method reported in this study, which has a higher cooling rate than convection-dominated cooling and fills the gap between the convection and conduction cooling methods (FIG. 29A). The theoretical highest cooling rate of ConvD-C (i.e., nylon cryomesh, orange dashed line, FIG. 29A) is still within the convection-dominated region (gray-colored area). By increasing the thermal conductivity of cryomesh, the cooling rate increases and reaches the conduction cooling region. The achievable cooling rate, then, can be determined based on the biosystem thickness for further studies such as CPA optimization. For example, the zebrafish embryo has a thickness of around 350 μm after dehydration. By using CondD-C mesh, the zebrafish embryo can achieve a cooling rate higher than 2.6×10⁴° C./min, which is validated by experimental data (black square, FIG. 29A).

Besides cooling rate, CPA concentration is another critical parameter to design the cryopreservation system. A high CPA concentration can be toxic to the biosystem while a low CPA concentration leads to devitrification with ice formation. As a general design principle, a CPA concentration higher than 63.2 wt % is considered toxic to the biosystem (FIG. 29B). However, CPA toxicity is dependent on the biosystem and CPA formulation, so this is not a uniform limitation. Then, the lowest CPA concentration required for different biosystem thicknesses is defined with the theoretically maximum cooling rates of different cooling methods (FIG. 29B). The CPA concentration (wt %) is calculated based on a well-developed model of PG (propylene glycol). The orange dashed lines present the lowest CPA concentration required to vitrify the biosystem on ConvD-C made of nylon mesh. By increasing the cooling rate of cryomesh (i.e., CondD-C) and avoiding convection heat transfer, the lowest CPA concentration is reduced for a smaller biosystem with a thickness<200 μm (blue dashed line, FIG. 29B). This cryomesh optimal zone is shown by the yellow-colored region between the red and blue dashed lines. The light blue area shows pure conduction cooling by directly printing droplets on cooled plates, which can achieve no CPA (pure water) vitrification in some cases. The area below the purple dashed line will lead to ice formation, even using pure conduction methods, due to low CPA concentration. For a general cryopreservation design on cryomesh, the initial CPA concentration tests can be chosen from the yellow-colored region using CondD-C. Then, the optimal CPA concentration can be increased to facilitate successful vitrification based on the cryomesh optimal zone.

Like the cooling rate, for all different warming methods, the achievable rewarming rate also decreases with the increase of biosystem thickness for all different rewarming methods (FIG. 30A). The dashed lines show the theoretical maximum rewarming rate of different cooling or rewarming methods. The theoretical rewarming rates of cryomesh (blue, orange, and red dashed lines) are calculated based on Equation 5 with h=5000 W/m²/K. The purple dashed line is the theoretical limit of the rewarming rate by using the Joule heating [8]. We defined three regions among those theoretical limits of rewarming rates. The top right corner is the region to be explored with volumetric rewarming methods such as laser rewarming [63]. The light magenta area shows the achievable rewarming rate, which can be further improved based on CondD-C. The gray-colored area shows the rewarming rate achieved by convection-dominated methods. The theoretical highest rewarming rate of ConvD-C (i.e., nylon cryomesh, orange dashed line, FIG. 30A) is still within the convection-dominated region (gray area). Similar to the cooling rate, by increasing the thermal conductivity of cryomesh, the maximum rewarming rate increases. Because of the correlation between the cryomesh's conductivity and the rewarming rate, the achievable rewarming rate can be defined based on the biosystem thickness. For example, these coral larvae have a thickness of around 100 μm. By using CondD-C mesh, coral larvae can achieve a rewarming rate higher than 1×10⁵° C./min (higher than the red dashed line), which is validated by experimental data (blue square, FIG. 30A).

The lowest CPA concentration required for different biosystem thicknesses is determined using the theoretical maximum rewarming rates of different cooling methods (FIG. 30B). The CPA concentration (weight percent, wt %) is calculated based on a well-developed model [10] of PG (propylene glycol). The orange dashed lines show the lowest CPA concentration required to vitrify the biosystem on ConvD-C of nylon mesh. By increasing the thermal conductivity of cryomesh (i.e., CondD-C), the lowest CPA concentration is reduced for a smaller biosystem with a thickness<200 μm (blue dashed line, FIG. 30B). Thus, the yellow-colored region between the red and blue dashed lines is defined as the CondD-C optimal zone, however, the CondD-C may still be effective outside of this zone. The area below the purple dashed line will lead to ice formation due to low CPA concentration even using rapid heating methods. For general cryopreservation design on cryomesh, the initial CPA concentration tests can be chosen from the yellow-colored region with CondD-C. Then, the optimal CPA concentration can be increased to facilitate successful vitrification based on the cryomesh optimal zone. A higher CPA concentration can help avoid ice formation but should be optimized to avoid toxicity to the biosystem.

Cryomesh design parameters, including filament diameter, pore size, and material, can be optimized based on biosystem size. This can include, the biosystem size (e.g., the diameter of the biosystem or the minor axis) should be larger than the mesh pore size. The recommended ratio is (biosystem size/pore size)≥2 with the largest recommend pore size of 200 μm. The filament (wire) diameter should be smaller than the biosystem thickness, which has a ratio (diameter/thickness)≤1 with the largest diameter of 50 μm. The mesh material should have a thermal conductivity of k≥10 W/m/K. For example, coral larvae have a diameter of approximately 100 μm. Thus, we choose stainless steel mesh with a wire diameter of around 30 μm and a pore size of 35 μm. To improve the performance of the cryomesh, we considered additional parameters for design and modification, including hydrophobicity of the mesh, mechanical properties, adhesion rate, and wash-off rate. In this study, we mainly focused on investigating how to use the fundamental understanding of heat transfer to improve the viability of cryopreservation.

### Gold-Coated Cryomesh

Gold coating has the potential to reduce copper toxicity (or any potential mesh material toxicity) to the biosystem, increase biosystem adhesion and release, and maintain high thermal conductivity (FIG. 16). Additional coatings can be applied to enhance biosystem adhesion and release. In one embodiment, an anti-adhesion solution (Anti-Adherence Rinsing Solution, STEMCELL Technologies) can be used to further enhance the release. Other solutions can also be used to reduce the surface energy to modify biosystem attachment. Several examples of gold-coated-copper cryomesh are included in FIG. 32. We tested different cryomesh frame sizes to cryopreserve pancreatic islets (FIG. 32 and FIG. 37). The 7×4.5 cm cryomesh can hold around 100,000 islets with a density of 3175 islets/cm². Higher densities are possible with a theoretical density limit of around 4000 islets/cm² for a monolayer, and higher densities using multiple layers.

### Two-Layer Cryomesh for Organism Vitrification

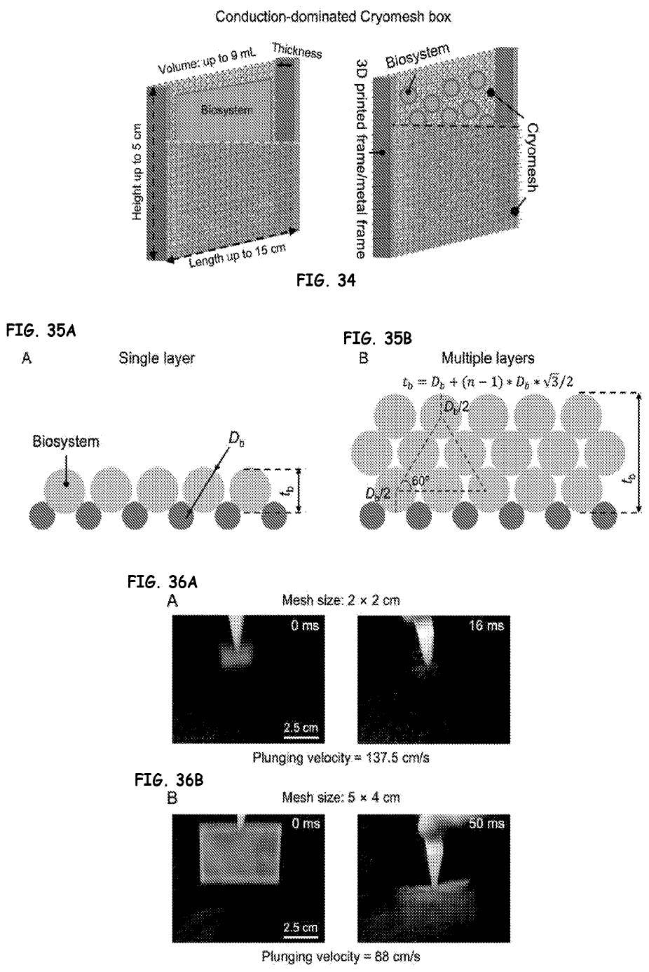

A two-layer mesh can be used to enhance heat transfer performance (CondD-C heat transfer from both sides of the biosystem) (FIG. 33). In one embodiment, the top layer (mesh cover) can be a thinner mesh (smaller wire diameter and pore size) than the bottom mesh (mesh support). The mesh cover can enhance heat transfer due to increased area acting as an extra conduction-dominated mesh. The thermal resistance model can also predict the enhancement of mesh cover. In an idealized case, this would roughly half the effective thickness of the biosystem reflected in the one-dimensional analysis. Also, by using a thinner diameter filament in the mesh cover, the cooling and rewarming rate can be further improved. FIG. 33B shows one example of the a two-layer cryomesh. The mesh cover is an electroplated nickel mesh with a thickness of 1 μm and a pore size of 5 μm. The mesh support is a gold-coated copper mesh with a wire diameter of 50 μm and a pore size of 50 μm. As a practical design, the mesh cover is not limited to the electroplated mesh of gold, copper, aluminum, and nickel. The mesh cover thickness is less than 5 μm but thicker than 500 nm to ensure good mechanical properties. The meshes are adhered by the capillary force of CPA. We tested a model biosystem (alginate cylinders) loaded with the CPA of 22% EG+22% DMSO+RPMI. Alginate cylinders were vitrified without any ice formation, which showed the mesh cover could maintain high heat transfer performance. Layers of fine cryomesh (e.g. pore size<2 μm) or thin conductive films could also be placed on both sides of the cryomesh after wicking to prevent contamination and maintain sterility during storage. Furthering the concept of a two-layer cryomesh design, a cryomesh box can be made by bonding two conduction-dominated cryomesh on both sides of the mesh frame (FIG. 34). The frame thickness could have a range from 200 μm up to 600 μm based on different biosystem thicknesses or CPA concentrations, or up to a millimeter or more. This cryomesh box would allow CondD-C heat transfer from two sides of the biosystem, high density packing of the biosystem in large cryomesh formats, facilitate wicking of excess CPA, and facilitate handling and storage.

### Multiple Layers of Biosystem Loading

Based on theoretical calculation and experimental data, an effective biosystem thickness can be applied to a small biosystem (e.g., diameter=50 μm) with multiple layers stacking on the cryomesh (FIG. 35). We calculated the effective layer thickness to as: t_{b}=D_{b}+(n−1)*D_{b}*\sqrt{3}/2≤500 μm, where D; is the diameter of the biosystem, and n is the number of biosystem layers. This effective thickness can be applied in the analysis described throughout this application. For example, a biosystem with a diameter of 50 μm can be stacked in 11 layers with a total thickness of around 483 μm. A single layer of biosystem (e.g., spheroids) with a diameter of 50 μm has a density number of 1.6×10⁵ on a 2×2 cm cryomesh, while increasing to 11-layers increases the biosystem number to 1.8×10⁶. The increased quantity is achieved by uniform cooling and rewarming along the conduction-dominated cryomesh. This would be effectively achieved by increasing the CPA concentration required relative to the expected cooling/rewarming rates based on the effective multilayer thickness.

### Plunging Velocity

Plunging velocity is another parameter that can impact cryomesh cooling and warming. A high plunging velocity leads to uniform cooling or rewarming when plunging cryomesh into LN2 or rewarming solution, respectively. Meanwhile, the high velocity can enhance bubble removal during the cooling process, which increases the cooling rate. A larger cryomesh (5×4 cm) has a higher drag force relative to a smaller cryomesh (2×2 cm), which might lead to a less uniform cooling rate (FIG. 15). We analyzed the manual (i.e. by hand) plunging velocity used in this study (FIG. 36). The 2×2 cm cryomesh achieved a plunging velocity of 137.5 cm/s, while the 5×4 cm cryomesh is 88 cm/s. As a design principle, plunging velocity should exceed at least 25 cm/s and higher plunging velocities are desirable. Faster plunging velocities may also enable more uniform cooling and rewarming for larger cryomesh heights (e.g. greater than 5 cm).

### Principles for Choice of Cryomesh Area and Storage

Using a CondD-C based design, the cryomesh area can theoretically be scaled to any size. It is expected the width of the cryomesh area will only be limited by constraints to handling and size of the cryogen bath. While it was observed that there can be some reduction in uniformity of cooling as the cryomesh height increases, this can be addressed by eliminating (e.g. through choice of cryogen) or further enhancing cryogen vapor bubble release and through increasing and controlling the plunge speed. Practical limitations and application needs then become the primary determinant in the choice of optimal cryomesh area. This can include considerations for batch sizes amendable to CPA loading/unloading, handling during plunge cooling and/or rewarming, desired cryopreservation batch sizes required for different applications, and desired form factors for storage.

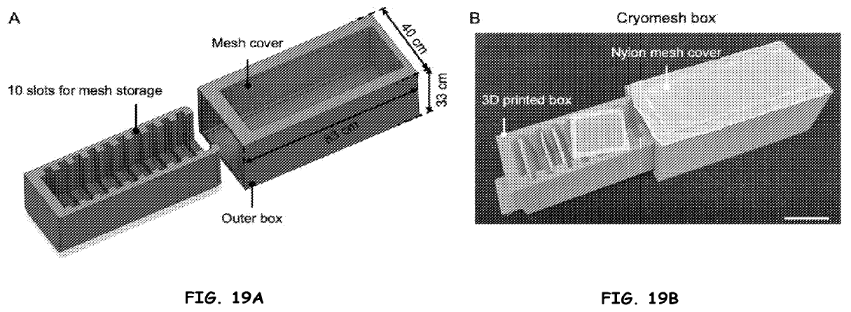

After plunge cooling, the cryomesh may also be placed in pre-cooled secondary containment to prevent contamination, maintain sterility, provide thermal and mechanical protection during subsequent handling, and allow for sorting and tracking in storage. One such potential concept is shown in FIG. 19. The containment box is precooled in LN2 and a series of CondD-C can be plunge cooled and then slotted in the box prior to storage. Size and number of CondD-C can be determined based on the constraints described in the paragraph above. This type of box can be sized appropriately based on the size requirements of the mesh, form factors required for the cryogenic storage, and required batch handling for cooling and/or rewarming. In the concept shown, a mesh cover is used to allow any residual LN2 to boil off during storage. This mesh cover may be fine enough to prevent contamination and maintain sterility during storage, but still allow release of nitrogen vapors. Other pressure release mechanisms could also be used or the container could be sealed only after all residual LN2 has evaporated. The storage box could be sealed and remain sealed until the cryomesh are prepared for rewarming. Or if the application did not require sealed-storage conditions, the cryomesh could be filed in the storage box and retrieved when required.

### DISCUSSION

A conduction-dominated cryomesh technology and approach which achieves vitrification-based cryopreservation has been demonstrated for different model biosystems including coral larvae, Drosophila, zebrafish embryos, and pancreatic islets. The cooling rate is enhanced by the high thermal conductivity of the cryomesh and the modified plunge technique which mitigates the effects of the LN₂ vapor barrier during cooling. The design principles to achieve a conduction-dominated cryomesh, include: 1) high thermal conductivity cryomesh material (k≥10 W/m/K) to achieve conduction-dominated behavior; 2) small wire diameter (D≤50 μm) and optimized solid fraction (Φ=0.5-0.66) to increase the heat transfer area, ensure adequate contact with the biosystem, and reduce the thermal resistance of the cryomesh; and 3) vertical plunging method with enhanced bubble release to achieve higher convective heat transfer rates, which enhance the heat release of the biosystem into LN₂. Thus, stainless steel with a wire diameter of 30 μm and solid fraction of 0.5 achieves a cooling rate of 3.5×10⁴° C./min for a 1-μL CPA droplet, which is 3.2× the cooling rate of the convection-dominated cryomesh with the horizontal plunge. With the enhanced cooling rate and vertical plunge, we achieved uniform cooling for scaled-up meshes (e.g., 15×4 cm). Based on the experimental data of vertical plunge of nylon mesh, the scaled-up mesh size could be up to 15×5 cm or greater. Meanwhile, these design principles were also applied to study rewarming rates, showing the potential for comparable increases over the convection-dominated cryomesh rewarming. By applying these concepts, the successful vitrification of coral larvae, Drosophila embryos, zebrafish embryos, and pancreatic islets at higher rates and scales than previous protocols were demonstrated. For instance, for coral larvae post-warming viability was increased from 43% to 85%, with the added benefit of a scalable platform to potentially cryopreserve large quantities in a single loading. The scale-up achieved by conduction-dominated cryomesh paves the way to cryopreserve a wide range of biosystems in greater quantities. This work not only demonstrates the effectiveness of a conduction-dominated cryomesh to enhance the cooling and rewarming rates but also provides a paradigm for cryopreservation designs from a thermal perspective.

All ranges given are intended to further include “any range there between” whether or not this is affirmatively stated.

All publications, patents and patent documents are incorporated by reference herein, as though individually incorporated by reference, each in their entirety, as though individually incorporated by reference. In the case of any inconsistencies, the present disclosure, including any definitions therein, will prevail.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.
1. Nakashima A, Ino N, Kusumi M, Ohgi S, Ito M, Horikawa T, et al. Optimization of a novel nylon mesh container for human embryo ultrarapid vitrification. Fertil Steril. 2010; 93 (7): 2405-10.
2. García-Domínguez X, Marco-Jiménez F, Puigcerver-Barber M, Más-Pellicer A, Vicente J S. The harmful effect of removing the extracellular vitrification medium during embryo cryopreservation using a nylon mesh device in rabbit. Cryobiology. 2020; 93:44-8.
3. Chinen S, Yamanaka T, Nakayama K, Watanabe H, Akiyama Y, Hirabayashi M, et al. Nylon mesh cryodevice for bovine mature oocytes, easily removable excess vitrification solution. Cryobiology. 2019; 90:96-9.
4. Zhan L, Li M-g, Hays T, Bischof J. Cryopreservation method for Drosophila melanogaster embryos. Nat Commun. 2021; 12 (1): 1-10.
5. Zhan L, Rao J S, Sethia N, Slama M Q, Han Z, Tobolt D, et al. Pancreatic islet cryopreservation by vitrification achieves high viability, function, recovery and clinical scalability for transplantation. Nat Med. 2022; 28 (4): 798-808.
6. Zhan L, Sushil, J S, Han, Z, Sethia, N, Etheridge, M L, Dutcher, C S, Finger, E B, Bischof, J C, inventorMethods for high throughput cryopreservation of cell clusters. US2022.
7. Funnekotter B, Bunn E, Mancera R L. Cryo-mesh: a simple alternative cryopreservation protocol. CryoLetters. 2017; 38 (2): 155-9.
8. Zhan L, Han Z, Shao Q, Etheridge M L, Hays T, Bischof J C. Rapid joule heating improves vitrification based cryopreservation. Nat Commun. 2022; 13 (1): 1-15.
9. Zhan L, Han, Z, Shao, Q, Etheridge, M L, Bischof, J C, inventorRapid, uniform and scalable rewarming for cryopreservation using joule heating. US2022.
10. Kangas J, Zhan L, Liu Y, Natesan H, Khosla K, Bischof J. Ultra-Rapid Laser calorimetry for the Assessment of Crystallization in Low-Concentration Cryoprotectants. J Heat Transf. 2022; 144 (3): 031207.
11. Brentari E, Giarratano P J. Boiling heat transfer for oxygen, nitrogen, hydrogen, and helium: US National Bureau of Standards; 1965.
12. Pegg D E. Principles of cryopreservation. In: Wolkers W F, Oldenhof H, editors. Cryopreservation and freeze-drying protocols. Methods in Molecular Biology. 1257. New York, NY: Springer; 2015. p. 3-19.
13. Amann R P, Pickett B. Principles of cryopreservation and a review of cryopreservation of stallion spermatozoa. J Equine Vet Sci. 1987; 7 (3): 145-73.
14. Rienzi L, Gracia C, Maggiulli R, LaBarbera A R, Kaser D J, Ubaldi F M, et al. Oocyte, embryo and blastocyst cryopreservation in ART: systematic review and meta-analysis comparing slow-freezing versus vitrification to produce evidence for the development of global guidance. Hum Reprod Update. 2017; 23 (2): 139-55.
15. Weinberg A, Song L-Y, Wilkening C, Sevin A, Blais B, Louzao R, et al. Optimization and limitations of use of cryopreserved peripheral blood mononuclear cells for functional and phenotypic T-cell characterization. Clin Vaccine Immunol. 2009; 16 (8): 1176-86.
16. Liu Y, Xu X, Ma X, Martin-Rendon E, Watt S, Cui Z. Cryopreservation of human bone marrow-derived mesenchymal stem cells with reduced dimethylsulfoxide and well-defined freezing solutions. Biotechnol Prog. 2010; 26 (6): 1635-43.
17. Baboo J, Kilbride P, Delahaye M, Milne S, Fonseca F, Blanco M, et al. The impact of varying cooling and thawing rates on the quality of cryopreserved human peripheral blood T cells. Sci Rep. 2019; 9 (1): 1-13.
18. Cao Y, Zhao G, Panhwar F, Zhang X, Chen Z, Cheng L, et al. The Unusual Properties of Polytetrafluoroethylene Enable Massive-Volume Vitrification of Stem Cells with Low-Concentration Cryoprotectants. Adv Mater Technol. 2019; 4 (1): 1800289.
19. Fahy G M, MacFarlane D, Angell C A, Meryman H. Vitrification as an approach to cryopreservation. Cryobiology. 1984; 21 (4): 407-26.
20. Rall W F, Fahy G M. Ice-free cryopreservation of mouse embryos at −196 C by vitrification. Nature. 1985; 313 (6003): 573-5.
21. Kolibianakis E M, Venetis C A, Tarlatzis B C. Cryopreservation of human embryos by vitrification or slow freezing: which one is better? Curr Opin Obstet Gynecol. 2009; 21 (3): 270-4.
22. Loutradi K E, Kolibianakis E M, Venetis C A, Papanikolaou E G, Pados G, Bontis I, et al. Cryopreservation of human embryos by vitrification or slow freezing: a systematic review and meta-analysis. Fertil Steril. 2008; 90 (1): 186-93.
23. Daly J, Zuchowicz N, Nuñez Lendo C I, Khosla K, Lager C, Henley E M, et al. Successful cryopreservation of coral larvae using vitrification and laser warming. Sci Rep. 2018; 8 (1): 1-10.
24. Zhan L, Guo S Z, Kangas J, Shao Q, Shiao M, Khosla K, et al. Conduction cooling and plasmonic heating dramatically increase droplet vitrification volumes for cell cryopreservation. Adv Sci. 2021; 8 (11): 2004605.
25. Han Z, Bischof J C. Critical cooling and warming rates as a function of CPA concentration. CryoLetters. 2020; 41 (4): 185-93.
26. Han Z, Gangwar L, Magnuson E, Etheridge M, Pringle C O, Bischof J, et al. Supplemented phase diagrams for vitrification CPA cocktails: DP6, VS55 and M22. Cryobiology. 2022; 106:113-21.
27. Demirci U, Montesano G. Cell encapsulating droplet vitrification. Lab on a Chip. 2007; 7 (11): 1428-33.
28. Biance A-L, Clanet C, Quéré D. Leidenfrost drops. Phys Fluids. 2003; 15 (6): 1632-7.
29. Song Y S, Adler D, Xu F, Kayaalp E, Nureddin A, Anchan R M, et al. Vitrification and levitation of a liquid droplet on liquid nitrogen. Proc Natl Acad Sci USA. 2010; 107 (10): 4596-600.
30. de Vries R J, Banik P D, Nagpal S, Weng L, Ozer S, van Gulik T M, et al. Bulk droplet vitrification: an approach to improve large-scale hepatocyte cryopreservation outcome. Langmuir. 2018; 35 (23): 7354-63.
31. Akiyama Y, Shinose M, Watanabe H, Yamada S, Kanda Y. Cryoprotectant-free cryopreservation of mammalian cells by superflash freezing. Proc Natl Acad Sci USA. 2019; 116 (16): 7738-43.
32. Shi M, Ling K, Yong K W, Li Y, Feng S, Zhang X, et al. High-throughput non-contact vitrification of cell-laden droplets based on cell printing. Sci Rep. 2015; 5 (1): 1-10.
33. Cryotop cooling rate [Available from: https://www.kitazato-ivf.com/vitrification/cryotop/.
34. Matsumoto H, Jiang J, Tanaka T, Sasada H, Sato E. Vitrification of large quantities of immature bovine oocytes using nylon mesh. Cryobiology. 2001; 42 (2): 139-44.
35. Khosla K, Kangas J, Liu Y, Zhan L, Daly J, Hagedorn M, et al. Cryopreservation and laser nanowarming of zebrafish embryos followed by hatching and spawning. Adv Biosyst. 2020; 4 (11): 2000138.
36. Khosla K, Zhan L, Bhati A, Carley-Clopton A, Hagedorn M, Bischof J. Characterization of laser gold nanowarming: a platform for millimeter-scale cryopreservation. Langmuir. 2018; 35 (23): 7364-75.
37. Khosla K, Wang Y, Hagedorn M, Qin Z, Bischof J. Gold nanorod induced warming of embryos from the cryogenic state enhances viability. ACS nano. 2017; 11 (8): 7869-78.
38. Leal P P, Hurd C L, Sander S G, Armstrong E, Fernández P A, Suhrhoff T J, et al. Copper pollution exacerbates the effects of ocean acidification and warming on kelp microscopic early life stages. Sci Rep. 2018; 8 (1): 1-13.
39. Mochida K, Hasegawa A, Shikata D, Itami N, Hada M, Watanabe N, et al. Easy and quick (EQ) sperm freezing method for urgent preservation of mouse strains. Sci Rep. 2021; 11 (1): 1-12.
40. Incropera F P, DeWitt D P, Bergman T L, Lavine A S. Fundamentals of heat and mass transfer: Wiley New York; 1996.
41. Zhang Y, Zhao G, Hossain S C, He X. Modeling and experimental studies of enhanced cooling by medical gauze for cell cryopreservation by vitrification. Int J Heat Mass Transf. 2017; 114:1-7.
42. Santos M V, Sansinena M, Chirife J, Zaritzky N. Convective heat transfer coefficients of open and closed Cryotop® systems under different warming conditions. Cryobiology. 2018; 84:20-6.
43. Tuteja A, Choi W, Ma M, Mabry J M, Mazzella S A, Rutledge G C, et al. Designing superoleophobic surfaces. Science. 2007; 318 (5856): 1618-22.
44. Wilke K L, Preston D J, Lᵤ Z, Wang E N. Toward condensation-resistant omniphobic surfaces. ACS nano. 2018; 12 (11): 11013-21.
45. Boresi A P, Schmidt R J. Advanced mechanics of materials: John Wiley & Sons; 2002.
46. Bergman T L, Lavine A S, Incropera F P, DeWitt D P. Fundamentals of Heat and Mass Transfer. New York: Wiley; 2017.
47. Clark J A. Cryogenic heat transfer. In: Irvine T F, Hartnett J P, editors. Advances in heat transfer. 5: Elsevier; 1969. p. 325-517.
48. Robards A, Sleytr U. Low temperature methods in biological electron microscopy. In: Glauert A M, editor. Practical Methods in Electron Microscopy. 10: Elsevier; 1985. p. 1-551.
49. Ghiaasiaan S M. Two-phase flow, boiling, and condensation: in conventional and miniature systems: Cambridge University Press; 2007.
50. Wang C, Dhir V. Effect of surface wettability on active nucleation site density during pool boiling of water on a vertical surface. 1993.
51. Cha H, Vahabi H, Wu A, Chavan S, Kim M-K, Sett S, et al. Dropwise condensation on solid hydrophilic surfaces. Sci Adv. 2020; 6 (2): eaax0746.
52. Zhang L, Gong S, Lᵤ Z, Cheng P, Wang E N. Boiling crisis due to bubble interactions. Int J Heat Mass Transf. 2022; 182:121904.
53. Dhillon N S, Buongiorno J, Varanasi K K. Critical heat flux maxima during boiling crisis on textured surfaces. Nat Commun. 2015; 6 (1): 1-12.
54. Nikolayev V, Chatain D, Garrabos Y, Beysens D. Experimental evidence of the vapor recoil mechanism in the boiling crisis. Phys Rev Lett. 2006; 97 (18): 184503.
55. Song Y, Diaz-Marin C D, Zhang L, Cha H, Zhao Y, Wang E N. Three-Tier Hierarchical Structures for Extreme Pool Boiling Heat Transfer Performance. Adv Mater. 2022; 34 (32): 2200899.
56. Jiang M, Wang Y, Liu F, Du H, Li Y, Zhang H, et al. Inhibiting the Leidenfrost effect above 1,000° C. for sustained thermal cooling. Nature. 2022; 601 (7894): 568-72.
57. Van Doremalen N, Bushmaker T, Morris D H, Holbrook M G, Gamble A, Williamson B N, et al. Aerosol and surface stability of SARS-COV-2 as compared with SARS-COV-1. N Engl J Med. 2020; 382 (16): 1564-7.
58. Gracioso L H, Peña-Bahamonde J, Karolski B, Borrego B B, Perpetuo E A, do Nascimento C A O, et al. Copper mining bacteria: Converting toxic copper ions into a stable single-atom copper. Sci Adv. 2021; 7 (17): eabd9210.
59. Yang X, Yang M, Pang B, Vara M, Xia Y. Gold nanomaterials at work in biomedicine. Chem Rev. 2015; 115 (19): 10410-88.
60. Kodandaramaiah S B, Gohl D M, Alegria A, Joshi A S, Auch B, inventors; US Patent assignee. Multi-perspective microscopic imaging guided microinjection of microscopic objects across large field of views patent US20220309705A1. 2022.
61. Joshi A S, Alegria A D, Auch B, Khosla K, Mendana J B, Liu K, et al., editors. Multiscale, multi-perspective imaging assisted robotic microinjection of 3D biological structures. 2021 43rd Annual International Conference of the IEEE Engineering in Medicine & Biology Society (EMBC); 2021: IEEE.
62. Joshi A S, Alegria A D, Smith K, Gohl D M, Khosla K, Bischof J, et al. Robotic platform for automated microinjection of zebrafish embryos for cryopreservation application. Cryobiology. 2022; 109:44-5.
63. Khosla K, Smith K, Kangas J, Gangwar L, Joshi A, Liu Y, et al. Ultra Rapid Laser Warming For Preservation of Fish and Other Aquatic Species. Cryobiology. 2021; 103:174.
64. Cameron K A, Harrison P L. Density of coral larvae can influence settlement, post-settlement colony abundance and coral cover in larval restoration. Sci Rep. 2020; 10 (1): 1-11.
65. Peyridieu J, Baudot A, Boutron P, Mazuer J, Odin J, Ray A, et al. Critical cooling and warming rates to avoid ice crystallization in small pieces of mammalian organs permeated with cryoprotective agents. Cryobiology. 1996; 33 (4): 436-46.
66. Zhan L, Rao J S, Sethia N, Slama M Q, Han Z, Tobolt D, et al. Pancreatic islet cryopreservation by vitrification achieves high viability, function, recovery and clinical scalability for transplantation. Nat Med. 2022 April; 28 (4): 798-808. PubMed PMID: 35288694. PMCID: PMC9018423. Epub 2022 Mar. 16.
67. Liu T L, Kim C-J C. Turning a surface superrepellent even to completely wetting liquids. Science. 2014; 346 (6213): 1096-100.
68. Huang Z, Zhang S, Yang R, Wu X, Li R, Zhang H, et al. A review of liquid nitrogen fracturing technology. Fuel. 2020; 266:117040.
69. Solanki P K, Bischof J C, Rabin Y. Thermo-mechanical stress analysis of cryopreservation in cryobags and the potential benefit of nanowarming. Cryobiology. 2017; 76:129-39.
70. (2003) TET. The Engineering ToolBox (2003). Young's Modulus, Tensile Strength and Yield Strength Values for some Materials. [online] Available at: [Available from: https://www.engineeringtoolbox.com/young-modulus-d 417.html 71. Dieter G E. ASM Handbook, Volume 20-Materials Selection and Design: ASM international; 1997.
72. Lula R A. Toughness of Ferritic Stainless Steels: American Society for Testing and Materials; 1980.
73. Ashby M F, CEBON D. Materials selection in mechanical design. Le Journal de Physique IV. 1993; 3 (C7): C7-1-C7-9.

1-23. (canceled)

24. A system for cryopreservation of a biological sample comprising: a thermally conductive porous surface comprising filaments, wherein the filament diameter, pore size of the porous surface, thermal conductivity and thermal diffusivity of the porous surface enable the system to reach a temperature within about 10% of the temperature difference with the cryogenic coolant within 1 second or less when submerged in the cryogenic coolant and wherein the thermally conductive surface is configured for submersion of the biological sample into the cryogenic coolant after removing excess CPA solution surrounding the biological sample.

25. (canceled)

26. (canceled)

27. The system of claim 24, wherein the submersion rapidly releases vapor bubbles formed due to evaporation of the cryogenic coolant by vertical plunging and/or agitation.

28. The system of claim 24, wherein the porous surface has a thermal conductivity of at least about 10 W/m/K.

29. The system of claim 24, wherein the porous, thermally conductive surface is selected from the group consisting of copper, stainless steel, aluminum, gold, diamond and combinations thereof.

30. The system of claim 24, further comprising a biological sample, wherein the biological sample is loaded with a CPA solution and the CPA loaded biological sample adheres to the porous surface after removal of excess CPA solution after placement of the biological sample on the porous surface and during submersion of the biological sample into a cryogenic coolant.

31. The system of claim 24, wherein the temperature of the porous surface with the biological sample reaches within about 10% of the temperature difference with the cryogenic coolant in 0.2 seconds or less during the cooling step.

32. The system of claim 24, wherein the porous surface comprises filaments and wherein the diameter of the filaments is selected to allow the porous surface to reach a temperature within about 10% of the temperature difference with the cryogenic coolant in 0.2 seconds or less during the cooling step.

33. The system of claim 24, wherein the porous surface comprises a solid fraction, wherein the solid fraction is between about 0.3 and about 0.9.

34. The system of claim 24, wherein the porous surface comprises a solid fraction, wherein the solid fraction is between about 0.5 and about 0.66.

35. The system of claim 24, wherein the porous surface comprises a pore size and the pore size prevents passage of the CPA loaded biological material through the porous surface during removal of excess CPA solution and ensures sufficient surface contact with the biological sample to allow rapid cooling of the biological material.

36. The system of claim 24, wherein the CPA loaded biological sample comprises an effective thickness of up to about 500 microns and the system cools at the biological sample at a minimum cooling rate of greater than 0.74×10⁴° C./min.

37-48. (canceled)

49. The system of claim 24, wherein cooling of the CPA loaded biological sample comprises an effective thickness of up to about 200 microns and the cooling occurs at a minimum cooling rate of greater than 1.8×10⁴° C./min.

50. The system of claim 24, wherein cooling of the CPA loaded biological material occurs sufficiently uniformly across the porous surface.

51. The system of claim 24, wherein the cooling across the porous surface has a variation of about +/−10%.

52. The system of claim 24, wherein the CPA loaded biological material is distributed on the porous surface as a monolayer or as multiple layers.

53. The system of claim 24, wherein contacting the CPA loaded biological material from multiple directions allows for more rapid heat transfer and effectively reduces the thickness of the biological sample relative expected cooling and rewarming behavior.

54. The system of claim 24, wherein the porous thermally conductive surface is at least about 5 cm×4 cm.

55. The system of claim 24, wherein the surface holds at least about 100,000 biological samples.

56. The system of claim 24, wherein the surface holds at least about 500,000 biological samples.

57. The system of claim 24, wherein the porous surface allows rapid and uniform rewarming of the CPA loaded biological material after cooling across the porous surface.
